(19) United States
(12) Patent Application Publication
(10) Pub. No.: US 2005/0086179 A1
(43) Pub. Date: Apr. 21, 2005

(54) System and method for managing cases

(76) Inventor: Badisse David Mehmet, New York, NY (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 10/857,981

(22) Filed: Jun. 2, 2004

Related U.S. Application Data
(60) Provisional application No. 60/475,466, filed on Jun. 4, 2003.

(51) Int. Cl. G06F 17/60

(52) U.S. Cl. 705/80

(57) ABSTRACT

A system for managing cases is provided. The system comprising: an attorney module comprising an attorney files management tool for managing client and opposing party files, a settlement tool for receiving and transmitting settlement offers and counteroffers, and a documents tool for drafting, receiving and transmitting documents and correspondence, a document submission tool for the electronic document filing of Court record, a payment tool for the receiving of electronic payments; and a central module communicating with the attorney module over at least one communications network, the central module comprising (1) a client module comprising a client files management tool for managing attorney and opposing party files, and a client payment tool for electronic payments, and (2) an opposing party module comprising an opposing party files management tool for the identification and consolidation of multiple attorneys and consolidating and managing attorney and client files, and an opposing party settlement tool for receiving and transmitting settlement offers and counter-offers, and an opposing party payment tool for electronic payments. Preferably the system also allows for the collection, processing and dissemination of file data generated from the file data entered into the system by the parties for use by Insurers for identifying fraudulent insurance claims and by Landlords in reviewing and evaluating the past rental history of potential Tenants.

### RELATED APPLICATIONS

This application claims priority to Provisional Application No. 60/475,466, filed on Jun. 4, 2003, which is hereby incorporated-by-reference in its entirety.

### FIELD OF THE INVENTION

The present invention relates generally to case management systems and systems, and more particularly to an automated case management system and system that enables parties to a dispute to present and receive settlement offers and counter-offers, send and receive electronic payments, electronic document filing of Court records and electronically file insurance claims with the Insurers, and to access documents and information regarding pending cases via at least one communications network. The invention also relates to a system for the collection, processing and dissemination of file data generated from the parties entry of file data into the system for use by Insurers to identify fraudulent insurance claims and by Landlords in reviewing and evaluating the past rental history of potential tenants.

### BACKGROUND OF THE INVENTION

Case management programs have been used by attorneys and law firms for many years. For example, the case management programs Abacus, Saga, Amacus, Real Legal, CLS and Needles. Typically, modern attorney case management programs have the ability to keep track of attorney caseloads and to properly docket upcoming deadlines, court dates and hearings. By effectively managing and communicating such information, case management programs can go a long way in helping attorneys manage and administer the convoluted web of a heavy litigation practice.

However, conventional case management programs suffer from various drawbacks. First, they require a great deal of user time to input case, client and file information, making maintenance of an up-to-date and current system highly labor-intensive. Second, they do not effectively incorporate the various communication systems and networks to set up files and settle disputes, electronically send and receive payments, electronic document filing of Court records, nor allowing opposing parties access to files and thus do not adequately inform and service all parties to a dispute. Indeed, current case management programs do little for clients and opposing parties. For example, while many systems are available wherein clients can access documents over the Internet prepared by an attorney on their behalf, these systems do not give clients the ability to efficiently settle cases, or to print up reports personalized “24/7,” or to submit Tenant data for non-payment of rent or allow attorneys, clients and third-parties to enter/review/pull-up file documents outside their office without having to connect to the attorney's hard drive within their office or allow electronic document filing of Court records with the Courts or electronic submission of insurance claims with Insurers or allow opposing parties access to files or electronically send and receive payments. For example, payments against attorney invoices, insurance claims and Tenant rent.

A further problem with conventional case management programs is that they do not allow attorneys, clients or third parties to remotely create, update and manage new files and cases. For example, current products and technologies specifically do not provide the capability to automatically process a claim from initiation to the point of settlement, without the attorney ever having to enter data manually. They also lack the ability to consolidate multiple cases into one single Summons and Complaint, such as is usually required for class action lawsuits, for example.

Further, current programs do not submit automated settlement offers periodically, or settlement offers on one or more cases by using a simple four (4) step process. For example, they would not permit the filing of 10,000 plus settlement offers to 10,000 plus different insurance adjusters via fax or email in a matter of seconds, with the adjusters having the ability to electronically accept, refuse or counter such offers.

Present case management programs also lack the ability to automate document drafting, client notifications, settlement review, acceptance; the creation of counter-offers, and collections on settled cases. They further lack the ability of automated case status upgrades.

Additionally, present available case management programs lack the ability to provide settlement statistics on all settled cases, to perform automated index number tracking, to perform automated DMV searches, to utilize multiple means of communication, to forward bills and medical records to insurance companies, the ability to accept electronic payments from insurers on settled cases or pending client bills, allow insurers access to general information of attorney's pending cases and print up reports via the internet.

Conventional programs further lack the ability to submit bills and medical records to insurance companies via the internet other than from programs created specifically for insurance companies websites to accept such submissions of bills and medical records. Present day case management programs lack the ability to assist insurance companies in fighting insurance fraud. The inapt nature of present day case management programs prevents the creation of an on-line “attorney, client and opposing party market place” where multiple parties are connected together in a daily system of interacting with each other in the managing and resolution of pending cases.

While present day case management systems may be suitable for the particular purposes to which they address, they do not utilize the full potential of present day advances in technology, and have caused a burden on some attorneys who have had to hire additional employees to cover the shortcomings of these programs, for example, the consolidation of multiple files into one suit (particularly in Class action suits).

Recent advances in information technology have created the ability for attorneys, clients, and insurers to be connected via the Internet in a manner that would create an attorney, client and opposing party on-line market place that facilitates and speeds up the processing of claims, while allowing insurance companies to fight insurance fraud, not only on the legislative level but by the presentation of printable reports obtained from each attorney case management program accessible via the Internet. For example, the creation of reports showing the same claimant being involved in multiple accidents with multiple insurers, or a practitioner's duplicate billing practices, would be an important feature in reducing fraud. The collection, processing and dissemination of the insurance claim data could be utilized in a system that effectively assists Insurers in fighting fraud. Currently Insurers maintain a central database, which is accessible to all Insurers for reviewing and uncovering fraudulent claims. However, this system is dependant on a collaborated and coordinated effort by all Insurers to submit updated and timely insurance claim data, which tends to suffer from extended delay, missing data and any uncovering of a fraudulent claim through this present system tends to be retroactive. Causing insurers to attempt to recoup monies already lost to fraudulent claimants. For example, a claimant who purchased five (5) insurance policies and was involved in a single accident then obtained treatment at five (5) different medical facilities that billed each Insurer separately. Because the fraudulent claims where filed simultaneously, no updated insurance claim data involving this accident would be available to insurers on the centralized database. Thus, causing the Insurers to pay the fraudulent claims only to subsequently discover the fraud once all the Insurers enter the insurance claim data on the centralized database. Because of the current system employed by Insurers and the legislative intent for Insurers to pay medical claims timely, Insurers are incapable of effectively investigating fraudulent claims in a timely manner prior to the payment of such claims being over due. The recent advances in technology allows for the creation of a new system, which would create an attorney, client and opposing party daily on-line market place through the receiving, transmitting and storing of documents, data and communications through multiple interconnecting attorney, client and opposing party modules to improve an Insurer's ability to investigate fraudulent claims in a way that facilitates the payment of claims and effectively uncovers these fraudulent claims. For example, the creation of an attorney module for case management that incorporates a system, which allows the submission of new insurance claims to Insurers through a central module connected to the Internet, which system not only gives insurers an additional cost effective level of security through the attorneys' submission of such claims but the insurance claim data stored in the system can be immediately cross referenced in the investigation of fraudulent claims and which does not require Insurers to enter insurance claim data. Thus, eliminating the delay experienced in present systems. Such technologies can weed out fraudulent practitioners and claimants, thus assisting in the reduction of yearly payouts of fraudulent claims, properly paying honest attorneys and clients, while protecting the public from fraud. If the insurance industry with legislative amendments required all insurance claims to be electronically submitted to insurance carriers through the attorney and central modules, insurers would not only have more cost effective protection in fighting insurance fraud through an attorney level of review but would have access to updated and more accurate data to timely investigate insurance fraud prior to claims being over due. For example, the claimant who purchased five (5) insurance policies and filed five (5) simultaneous but separate claims on a single accident would immediately be uncovered as Insurers cross-reference the insurance claim data in the central module incorporating this new system.

A number of patents have issued in the area of claims and negotiation management systems. U.S. Pat. No. 6,330,551 discloses a computerized system for automated dispute resolution through an Intranet website via the Internet or other communications linkage for communicating and processing a series of demands to satisfy a claim made by or on behalf of a claimant or other person involved in a dispute with at least one other person, such as a defendant, his or her insurer, or other sponsor, and a series of offers to settle the claim through at least one central processing unit including operation system software for controlling the central processing unit is disclosed. Preferably the system also allows for the collection, processing and dissemination of settlement data generated from the settlement through the operation of the system for use by sponsors and claimants in establishing the settlement value of future cases.

U.S. Pat. No. 6,553,347 discloses a system for conducting “one to one” commercial negotiations through an electronic medium such as the Internet. The negotiation process consists of sending persuasive texts to the user by the system, including discounts given by the system and responses to the price offers of the user. The system offers the product for a specific price, a price that may be optionally decreased as negotiation continues. The system frequently asks how much the user is willing to pay for the product. Based on the user's input, the system may accept the offer or, after one or more unacceptably low inputs from the user, may alternatively end the process of negotiation. Preferably, the system negotiates on many more parameters than simply the price itself.

U.S. Pat. No. 6,502,113 discloses a system for managing negotiations between parties, comprising the steps of: storing a selected document having a plurality of negotiable clauses; creating a first retrievable display relating to the document; updating the document as the clauses are modified by the parties, so that each clause corresponds to the last of the modifications; creating a plurality of respective, retrievable clause displays for all modifications of the clauses as each clause is negotiated; creating a retrievable summary display for the clauses; and, visually coding the retrievable displays to distinguish between clauses which have not been negotiated and clauses which have been agreed to, and so that updated clauses which have not yet been agreed to are attributed to one of the parties, whereby the negotiations can be tracked by reviewing the visually coded displays. All of the steps can be implemented at an Internet web site.

U.S. Pat. No. 6,141,653 discloses a multivariate negotiations engine for iterative bargaining which: enables a sponsor to create and administer a community between participants such as buyers and sellers having similar interests; allows a buyer/participant to search and evaluate seller information, propose and negotiate orders and counteroffers that include all desired terms, request sample quantities, and track activity; allows a seller/participant to use remote authoring templates to create a complete Website for immediate integration and activation in the community, to evaluate proposed buyer orders and counteroffers, and to negotiate multiple variables such as prices, terms, conditions etc., iteratively with a buyer.

U.S. Pat. No. 6,112,189 discloses a system calculates the mutual satisfaction between negotiating parties and maximizes their mutual satisfaction over a range of decision variables and does so without requiring the parties to identify themselves and their positions to each other. For automatically negotiating agreements between multiple parties, a computer accepts a satisfaction function from an offering party who defines his degree of satisfaction to agree to a range of terms upon which the party is desirous of negotiating as a function of the relevant decision variables.

U.S. Published Patent Application No. 2003/0154172 discloses a computer program is provided for developing component-based software capable of facilitating insurance-related negotiation. The program includes a data component that stores, retrieves and manipulates data utilizing a plurality of functions. Also provided is a client component that includes an adapter component that transmits and receives data to/from the data component. The client component also includes a business component that serves as a data cache and includes logic for manipulating the data. A controller component is also included which is adapted to handle events generated by a user utilizing the business component to cache data and the adapter component to ultimately persist data to a data repository. In use, the client component provides a plurality of data fields relating to an insurance-related negotiation. In addition, a plurality of rules is provided which dictate events to be raised based on data in the data fields. The user is then able to input data into the data fields. Finally, events are raised based on the data entered into the data fields.

U.S. Patent No. 20020120588 discloses a computer system for allowing negotiation between a plurality of entities, the computer system comprising a computer network having a plurality of computer nodes; a computer node being arranged to define the negotiation between the entities with a set of negotiation activities; wherein the computer node is operable to implement a plurality of negotiation rule sets, each rule set constraining the negotiation activities to a specific negotiation type, thereby allowing a plurality of negotiation types to be selected by an entity.

U.S. Patent No. 20020069182 discloses a system and system for alternative dispute resolution involving multiple offers and flexible setting of settlement parameters. Individuals determine whether settlement offers overlap with one another without deciding the settlement terms. Terms may be monetary, non-monetary, or time-limited. Participants access the system on a web site. Participants submit a series of confidential settlement demands beginning with non-monetary demands. Unique identifying devices match respective settlement demands against one another. When a participant signs on to the web site, a “click-wrap” agreement binds him to the terms of any settlement reached. Participants pay a fee for each round of negotiations. Where settlement figures overlap, an algorithm resident on the server of the present invention chooses the midpoint between the figures. Participants may restrict the analysis to knowing whether their demands overlap. If a settlement is reached, email messages are sent to the parties.

Client bulleting board systems also exist that provide secure online workspace for clients and attorneys. These systems connect clients and attorneys over the Internet and provide documents and transaction information in customizable virtual private workspaces. These systems enable documents and other case information to be instantly available to attorneys, clients, and team members while on the road or from a remote location. These systems allow attorneys and clients to conduct a wide-variety of operations in a secure environment: publish documents through the secure network; review transcripts, depositions, filings and the like, in progress; share comments and edits; check agendas and scheduling; distribute late-breaking news and valuable research; and participate in discovery document review. Additional features such as event calendar and automated content notification help to keep projects on track and all members of the team informed.

None of these patents and known systems adequately fulfill the needs of attorneys, clients and opposing parties, for example, by providing a comprehensive case management system as claimed by the present invention.

These and other problems exist.

### SUMMARY OF THE INVENTION

An object of the present invention is to overcome the aforementioned and other drawbacks existing in prior art systems and systems, and to create an attorney, client and opposing party daily on-line market place through the receiving, transmitting and storing of documents, data and communications through multiple interconnecting attorney, client and opposing party modules.

In view of the foregoing disadvantages inherent in the known types of case management programs now present in the prior art, the present invention provides a new attorney case management system and system that interconnects multi-parties on-line through attorney, client and opposing party modules that enables settlement, provides parties to a dispute immediate access to status reports, and allows attorneys, clients and opposing parties to review and manage pending cases in a secure and reliable manner, and allows the electronic document filing of Court records, allows the submission of Tenant data for non-payment of rent, the electronic sending and receive of payments. For example, payments against attorney invoices, insurance claims and Tenant rent.

The various embodiments disclosed herein comprise systems and systems that enable efficient case management by parties to a dispute. In some embodiments, the invention enables attorneys, clients, and opposing parties, for example, to more immediately and accurately obtain information relating to a particular dispute, case or suit, for example. In various other embodiments, the present invention enables parties to a dispute to reach settlement in an efficient and time-effective manner.

The features and functions of the invention may be described in the context of no-fault litigation. No-fault litigation typically arises when an insurance carrier refuses to pay a claim submitted on a patient's behalf by the medical provider. As a condition to treatment, most medical providers require that the patient assign its benefits to collect under a policy. When an insurer subsequently refuses to pay a particular claim, the medical provider can bring an action under state no-fault statutes seeking payment of benefits. The litigation process typically involves the exchange of medical bills and information, photographs of facilities and equipment, providers licenses and certifications, as well as testimony of patients and doctors. Given the high-volume of no-fault litigation that exists today, parties (attorneys, clients (e.g., medical providers), and opposing parties (e.g., insurance company)) find themselves overwhelmed by the administration of voluminous documents and information, and the drawn out and laborious settlement process. Overwhelmed insurance companies are hindered in the effective and timely investigation of fraudulent insurance claims and are repeatedly paying fraudulent claims only to attempt to recoup such losses retroactively. Although the invention is described primarily in the context of no-fault litigation practice, its features and functionality are applicable to many different types practices, legal and non-legal, including landlord-tenant disputes.

The system and system of the present invention enables parties to a dispute to collaborate and interact efficiently and reliably on a single platform. In some embodiments, the present invention may comprise an attorney module, accessible by an attorney, that provides various modules, tools and interfaces that enable the attorney to: (1) set-up and/or access client and opposing party files, (2) manually or automatically submit and receive single and bulk settlement offers, (3) review relevant documents and information uploaded by clients and/or opposing parties; (4) keep clients and opposing parties informed of current case status and upcoming deadlines, for example, (5) manually or automatically draft documents, such as notifications, pleadings, summons and complaints, discovery, and other relevant documents, (6) submit medical bills to insurance companies on behalf of clients and receive electronic payment from insurance companies, for example, (7) process denied claims, (8) consolidate multiple client or opposing party files into a single document, such as a summons and complaint, for example, (9) outsource to third-parties, (10) automatically draft documents, (11) submit invoices to and receive electronic payment from clients, and (12) receive new clients, (13) receive data on non-paying Tenants, (14) receive electronic payment of Tenant rent, and (15) electronic document filing of court records. Other features and functionality are of course provided, as will be explained below. According to various embodiments, the attorney module can be saved on an attorney's hard drive, for example, which may receive and transfer information back and forth from the Internet and telecommunication networks, for example. Disk containing computer language which can be stored on the attorney's hard drive, database on a server that receives and transfers data to and from the attorney's hard drive. In a further embodiment, the invention comprises an on-line ASP-type system. The invention envisions numerous attorneys having individualized attorney modules as described herein.

According to various embodiments, the attorney module may connect (such as over a communications network, for example) to a central module which may be accessed by clients and opposing parties, for example. In some embodiments the central module may comprise a client module and an opposing party module. The client module may provide various modules, tools and interfaces that enable a client, for example, to: (1) set-up attorney and opposing party files, (2) upload documents, such as medical bills, photographs of facilities and equipment, for example, (3) transmit uploaded documents to attorneys or opposing parties, (4) set and submit files on denied claims for immediate processing by an attorney, (5) securely submit new no-fault bills and records, for example, to an insurer through the attorney, (6) choose and manage multiple attorneys for particular claims and disputes, (7) coordinate directly with insurance companies and help fight fraud by giving insurers an additional level of security through which they access and review current facilities and equipment, (8) be notified of single and bulk settlement offers, (9) review relevant documents and information uploaded by attorneys and/or opposing parties; (10) access information and documents inputted by attorneys via attorney modules or opposing parties via opposing party modules, and (11) be informed of current case status and upcoming deadlines, and (12) electronically send payments on attorney invoices, (13) submit data on non-paying Tenants, for example. Other features and functionality are of course provided, as will be explained below.

In still other embodiments, the central module may comprise an opposing party module. The opposing party module may provide various modules, tools and interfaces that enable an opposing party, for example, to: (1) set-up client and attorney files, (2) review pending suits from multiple attorneys, (3) submit and manage one or multiple settlement offers, (4) receive settlement agreements and stipulations of discontinuance, (5) review and securely submit records to peer/IME/EUO, (6) review doctor/provider licenses and photographs of equipment and facilities to help fight fraud, (7) review relevant documents and information uploaded by attorneys and/or clients inputted via attorney modules or client modules, and (8) be informed of current case status and upcoming deadlines, (9) electronically send payment on insurance claims, and (10) electronically send payment on Tenant rent, for example. Other features and functionality are of course provided, as will be explained below.

A primary object of the present invention is to provide an attorney case management program that will overcome the shortcomings of the prior art systems and systems, and create an attorney, client and opposing party on-line market place through the receiving, transmitting and storing of documents, data and communications through multiple interconnecting attorney, client and opposing party modules in the daily management and resolution of pending cases.

Further objects of the present invention are to provide an attorney case management program for attorneys that permits settlements with insurance companies, provides clients with status reports on their cases 24/7, and allows insurance companies to review pending cases with the attorneys utilizing an account number via the internet.

An additional object of the invention is to provide an attorney case management program that will allow attorneys, clients and third parties to set-up their own files via the internet or telephone communications with an automated file number assignment.

A still further object of the invention is to provide an attorney case management program that will enable attorneys, clients and third parties to access file information without ever having to connect with the attorney's hard drive.

Another object of the invention is to provide an attorney case management program that will allow attorneys to send and receive settlement offers via the internet or telephone communications, including the ability to view statistics of all accepted/declined/pending settlement offers sent and received.

A still further object is to provide an attorney case management program that will allow attorneys, clients, insurers and third parties to obtain case status information “24/7” and in which access is provided by the internet or telephone.

A further object of the present invention is to provide an attorney case management program that will provide automated case status notifications to be sent to attorneys, clients and third parties via the internet or telephone.

Another object of the invention is to provide an attorney case management program that will provide automated case status upgrades.

Another object of the invention is to provide a central module connected to the Internet that will receive and consolidate multiple file data from multiple attorney modules then display the file data to opposing parties.

Another object of the invention is to provide an attorney case management program that will allow the consolidation of multiple and separate file data into a single drafted document.

Another object of the invention is to provide an attorney case management program that will allow the electronic submission of medical records and bills to insurers for electronic payment.

Another object of the invention is to provide an attorney case management program that will allow the electronic document filing of Court records.

Another object of the invention is to provide an attorney case management program that will allow the submission of Tenant data for non-payment of rent.

Another object of the invention is to provide an attorney case management program that will allow the electronic sending and receive of payments. For example, payments against attorney invoices, insurance claims and Tenant rent.

Another object of the invention is to provide an attorney case management program that will allow the collection, processing and dissemination of file data generated from the file data entered into the system by the parties for use by Insurers for identifying fraudulent insurance claims and by Landlords in reviewing and evaluating the past rental history of potential Tenants.

A yet additional object of the invention is to provide an attorney case management program that will be capable of automatically settling cases and drafting legal documents, as well as providing automated calendaring of settlements for check tracking.

Other objects and advantages of the present invention will become obvious to the reader and it is intended that these objects and advantages are within the scope of the present invention.

According to one embodiment of the invention, a system for managing cases is provided. The system comprising: an attorney module comprising an attorney files management tool for managing client and opposing party files, a settlement tool for receiving and transmitting settlement offers and counter-offers, and a documents tool for drafting, receiving and transmitting documents and correspondence, a document submission tool for the electronic document filing of Court records with the Courts, a payment tool for the receiving of electronic payments on attorney invoices, insurance claims and Tenant rent; and a central module communicating with the attorney module over at least one communications network, the central module comprising (1) a client module comprising a client files management tool for managing attorney and opposing party files, and a client payment tool for electronic payments of attorney invoices, and (2) an opposing party module comprising an opposing party files management tool for the identification and consolidation of multiple attorneys and consolidating and managing attorney and client files, and an opposing party settlement tool for receiving and transmitting settlement offers and counter-offers, and an opposing party payment tool for electronic payments of insurance claims and Tenant rent. Preferably the system also allows for the collection, processing and dissemination of file data generated from the file data entered into the system by the parties for use by Insurers for identifying fraudulent insurance claims and by Landlords in reviewing and evaluating the past rental history of potential Tenants.

In another embodiment of the invention, a system for settling at least one dispute is provided. The system comprises: receiving and viewing at least one settlement offer from at least one user over at least one communications network; comparing the at least one settlement offer to at least one corresponding floor settlement amount; proposing the at least one corresponding floor settlement amount as a counter offer to the at least one user over the at least one communications network if the at least one settlement offer is less than the at least one corresponding floor settlement amount; and populating and sending acceptance correspondence over the at least one communications network to the at least one user if the at least one settlement offer is equal to or greater than the at least one corresponding floor settlement amount.

In yet another embodiment of the invention, a system for settling a dispute is provided. The system comprising: a settlement reception module for receiving and viewing at least one settlement offer from at least one user over at least one communications network; a comparison module for comparing the at least one settlement offer to at least one corresponding floor settlement amount; a counter-offer module for proposing the at least one corresponding floor settlement amount as a counter offer to the at least one user over the at least one communications network if the at least one settlement offer is less than the at least one corresponding floor settlement amount; and a documents module for populating and sending acceptance correspondence over the at least one communications network to the at least one user if the at least one settlement offer is equal to or greater than the at least one corresponding floor settlement amount.

In still another embodiment of the invention, a system for making bulk settlement offers is provided. The system comprises: accessing information relating to a plurality of offerees; determining a particular offerees based on the information accessed; determining an overriding settlement percentage; simultaneously submitting a settlement offer over a communications network to each of the particular offerees, each of the settlement offers being based on the overriding settlement percentage.

In another embodiment of the invention, a system for settling a dispute is provided. The system comprising: receiving at least one settlement offer over at least one communications network; and submitting at least one settlement response over the at least one communications network corresponding to each of the at least one settlement offer, said at least one settlement response being submitted without entering information related to the case or dispute being settled. In some embodiments, the submission of the at least one settlement response comprises a single step. In other embodiments, the step of submitting at least one settlement response comprises initiating an acceptance or rejection. In still other embodiments, the initiation of an acceptance, rejection or counter-offer is accomplished by a single key-stroke or mouse-click, wherein the single key-stoke may comprise initiating an accept icon or reject icon displayed on a graphical user interface (or GUI).

In still another embodiment of the invention, a system for settling a dispute is provided. The system comprising: settlement reception means for receiving at least one settlement offer over at least one communications network; and settlement offer response means for submitting at least one settlement response over the at least one communications network corresponding to each of the at least one settlement offer, said at least one settlement offer being submitted without entering information related to the case or dispute being settled. In some embodiments, the settlement reception means may comprise a settlement tool associated with at least one of an attorney module, a client module, or an opposing party module. In other embodiments, the settlement tool may comprise a settlement reception module for receiving settlement offers, a comparison module for comparing the settlement offers to stored floor settlement amounts, and counter-offer module for proposing counter-offers to settlement offers. In still other embodiments, the at least one settlement offer is proposed in response to a single step.

In yet another embodiment of the invention, a system for making a settlement offer is provided. The system comprising: accessing information relating to at least one of a pending action or suit, an attorney, a plaintiff, a defendant, or any combination thereof; determining a particular settlement percentage; calculating an offer to settle for each of the at least one of a pending action or suit, an attorney, a plaintiff, defendant, or any combination thereof, each offer to settle being based on the particular settlement percentage; and proposing the offers to settle over a communications network. In some embodiments, the offers to settle are received by a corresponding attorney, plaintiff, defendant, or any combination thereof. In other embodiments, each proposed offer to settle results in a acceptance or counter-offer, while in other embodiments each offer to settle is proposed without providing case or dispute information. In still other embodiments, the recipient of each offer to settle is able to view or access the offer to settle.

In another embodiment of the invention, a system for managing a case is provided. The system comprising: determining the type of documented being prepared by a user; and upgrading the status of at least one case based on the type of document being drafted. In some embodiments, system further comprises the step of preparing a status report to a client. In some embodiments, the user is an attorney. In still other embodiments, the document being drafted is at least one of a settlement notification or a settlement agreement, while in other embodiments the document being drafted is related to a particular case or dispute. In some embodiments, the uploaded documents comprise at least one of medical records, medical bills, and licenses. In other embodiments, the user comprises an attorney, while the another user comprises an insurance company. In still other embodiments, the system further comprises the step of transferring the documents and information to an insurance company over a communications network.

In still another embodiment of the invention, a system for uploading and transmitting case documents and information is provided. The system comprising: uploading documents and information related to a particular case; transmitting the uploaded documents and information to a user for viewing; and receiving approval from the user to transmit or forward the documents and information to another user. In some embodiments, the uploaded documents comprise at least one of medical records, medical bills, and licenses. The user may comprise an attorney, while the another user comprises an insurance company. In other embodiments, the system further comprises the step of transferring the documents and information to an insurance company over a communications network.

In another embodiment of the invention, a system for simultaneously drafting a plurality of documents is provided. The system comprising: accessing information relating to a plurality of pending cases, suits or disputes; selecting at least one document to draft; populating various drafts of the selected at least one document, each version being populated with information relating to one of the plurality of pending cases, suits or disputes; and triggering transmission of the various populated drafts of the selected at least one document by initiating a single step. In some embodiments, the single step comprises a single key-stroke or mouse-click. In other embodiments, the at least one document comprises a complaint, answer, pleading or other document related to a particular case(s) or dispute(s). In other embodiments, accessing information occurs in response to a predetermined event. In some embodiments, the predetermined event comprises at least one of the passage of a predetermined period of time and denial of payment. In some embodiments, the select case or dispute information comprises information relating to claims against a particular insurance company. In other embodiments, the select case or dispute information comprises information relating to claims brought by a particular client. In other embodiments, the at least one document to prepare comprises at least one of a complaint, answer, and summons. In still other embodiments, the status of a case is updated upon drafting of the at least one document.

In still another embodiment of the invention, a system for consolidating case information into a document is provided. The system comprising: selecting at least one of a client and an opposing party; accessing select case or dispute information relating to the selected at least one of a client and an opposing party; selecting at least one document to prepare; populating the at least one document with accessed case or dispute information; and transmitting the populated document to at least one intended recipient over a communications network.

In yet another embodiment of the invention, a system of providing an attorney landlord and tenant management website is provided. The system comprising the steps of: entering the tenant's information by a client into a database connected to the Internet when the tenant has failed to pay rent; preparing a file for the tenant that can be accessed repeatedly whenever the client fails to pay rent; notifying the tenant by the client of the tenant's failure to pay rent; providing the tenant with the capability to pay the tenant's rent via the website; notifying the client of a bill from the attorney; providing the client with the ability to pay the attorney's bill via the website; and identifying the bill for review if no work is performed on the file for the tenant.

To the accomplishment of the above and related objects, this invention may be embodied in the form illustrated in the accompanying drawings, attention being called to the fact, however, that the drawings are illustrative only, and that changes may be made in the specific construction illustrated.

The accompanying drawings, which are incorporated in and constitute a part of this specification, illustrate various embodiments of the invention and, together with the description, serve to explain the principles of the invention.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a block diagram of the system of the present invention, according to one embodiment of the invention.

FIG. 2 is a block diagram of the web system in accordance with the present invention, according to one embodiment of the invention.

FIG. 3 is a block diagram of the database system in accordance with the present invention, according to one embodiment of the invention.

FIGS. 4-6 illustrate block diagrams of the operation of the invention from the standpoint of attorneys, clients and insurers, according to one embodiment of the invention.

FIG. 7 illustrates a block diagram of one embodiment of the system of the invention.

FIG. 8 illustrates a block diagram of an attorney module, according to one embodiment of the invention.

FIG. 9a illustrates a block diagram of a central module, according to one embodiment of the invention.

FIG. 9b illustrates a block diagram of a client module, according to one embodiment of the invention.

FIG. 9c illustrates a block diagram of an opposing party module, according to one embodiment of the invention.

FIGS. 10-18 illustrate various embodiments of systems performed by the invention.

FIGS. 19-70 illustrate various embodiments of interfaces to the features and functions of the invention.

### DETAILED DESCRIPTION OF THE INVENTION

According to some embodiments, the invention relates generally to a case management program, and more particularly to an attorney automated case management program that interconnects multiple attorneys, clients and opposing parties through attorney, client and opposing party modules creating an on-line market place and enables parties in dispute, for example, to communicate, present and coordinate settlements, automatically draft and consolidate multiple files into single documents, electronically file drafted documents with the Courts, electronically send and receive payments, and record the rental history of Tenants, for example. Taking no-fault litigation practice as an example, the various features and functionality of the invention can be described in the context of attorneys, clients (or medical facilities, for example), adjusters (or insurance companies) and court houses, for example.

The present invention is broadly directed to a system and system for managing client cases over a communication network using, for example, personal computers and similar devices. While the present invention is being described in the context of a system using a personal computer, the manner of the end user device is not critical to the present invention. The present invention may be used with any system that connects to the Internet or uses other IP transport systems. The end user device can comprise any end user device which can connect to a network such as a wireless device, palm pilot, PDA, end user workstation or hand-held device. As will be discussed herein, the present invention is described both in the context of a stand-alone system connected to a worldwide network (Internet) or a system and application fully accessible via an Internet website.

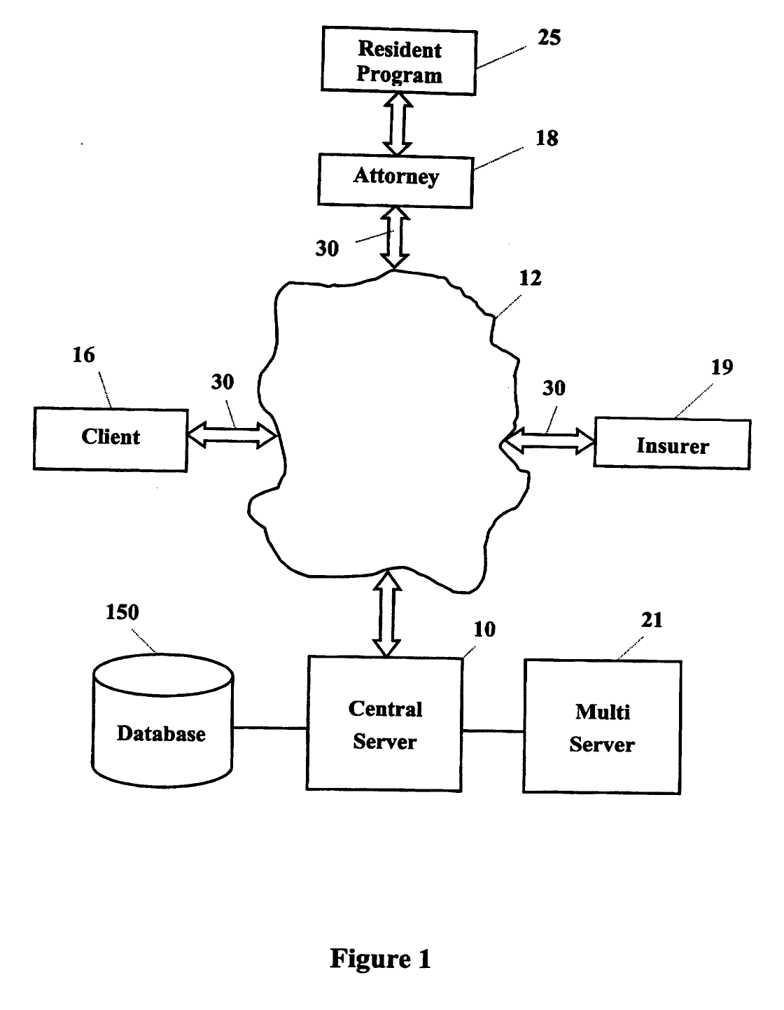

Referring now to the drawings wherein like reference numerals refer to the same components across the several views, and in particular to FIG. 1, the technical environment for one embodiment of the present invention is disclosed and shown. The most preferred embodiment comprises a central computer server 10 connected by a computer network 12 to remote end user stations. The central server connects to a database 150.

In a preferred embodiment, end user stations comprise a plurality of end users 16, 18, 19. The end users broadly comprise three types of users: clients 16, attorneys 18 and insurers 19. While the invention is described in the context of an insurer based program such as might be used for a personal injury law practice. It is to be appreciated that the invention can accommodate any third party payee or litigant.

End user attorneys 18 will have a comprehensive resident program 25 (or attorney module) in their hard drives. Users 16, 18, 19 are linked with the central computer server 10 via a transport medium 30, and will be linked via a global computer network 12 such as the Internet or Worldwide web, but other embodiments including LANs, WANs and Intranets, fulfill the spirit and scope of the present invention. In other embodiment, the resident program may be stored on a remote server accessible over a communications network.

As noted, the end user devices 16, 18 19 will typically comprise any device that connects to the system via the Internet or other IP transport systems and includes, but is not limited to, such devices as televisions, computers, hand-held devices, cellular phones, land based telephones, wireless electronic devices and any device which uses a transport medium 30. Non-limiting examples of a transport medium 30 applicable for use in the present invention comprise any backbone or link such as an ATM link, FDDI link, satellite link, cable, cellular, twisted pair, fiber optic, broadcast wireless network, the internet, the world wide web, local area network (LAN), wide area network (WAN), or any other kind of intranet environment such a standard Ethernet link. In such alternative cases, the clients will communicate with the system using protocols appropriate to the network to which that client is attached. All such embodiments and equivalents thereof are intended to be within the scope of the present invention.

Referring again to FIG. 1, the present invention may comprise a multi-server 21 environment which comprises a computer system in accordance with the present invention that allows the multiple end users 16, 18, 19 to communicate with the system and system clients. Through communication link and transport medium 30, end users 16, 18, 19 will receive data entries which must be correctly identified and confirmed and who are linked to the central server 12, preferably by a customizable interface to be described in greater detail below.

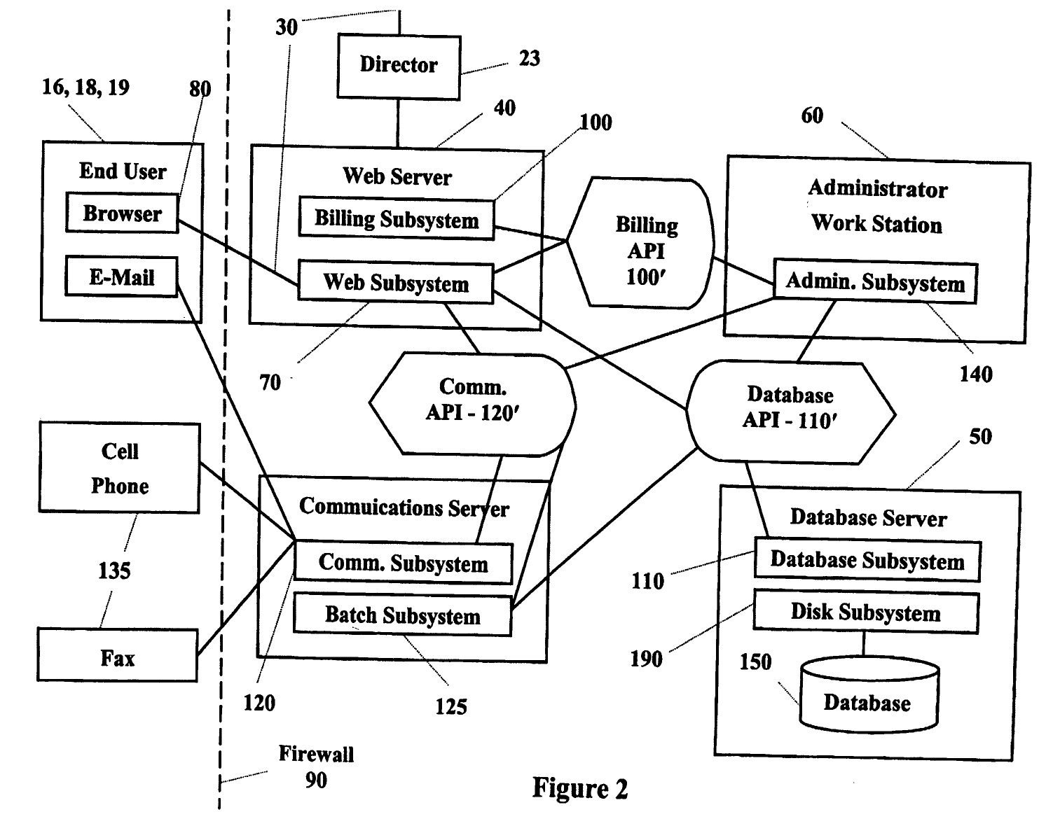

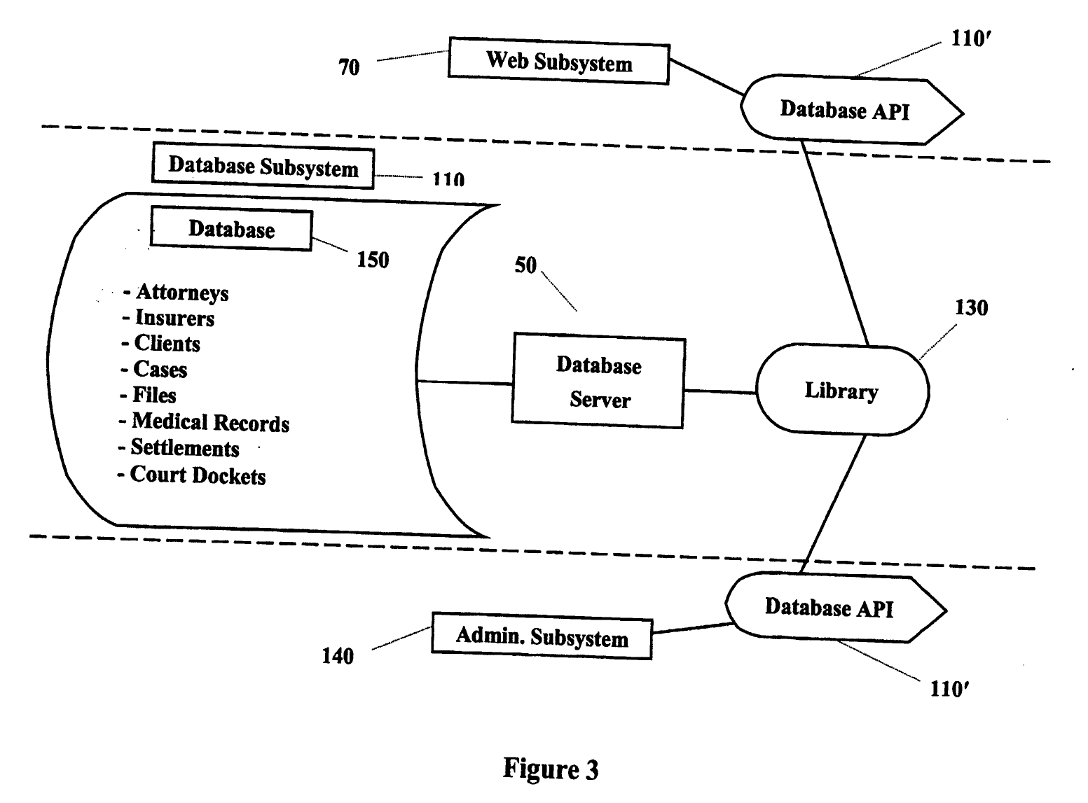

Referring to FIGS. 2 and 3, the central server and database systems of the present invention are now shown and described in greater detail. A local director 23 routes signals through the system to the various servers, to be described below, and to and through transport medium 30 to end users 16, 18, 19. The system preferably includes two primary servers, a web server 40 and a database server 50 which may operate using such database platforms as SQL server or Oracle. Hence, in one embodiment the SQL server may run SQL server database management software from Microsoft Corporation. Alternatively, the server can further comprise an Oracle database server.

The system further includes an administrative workstation 60 or system which provides the administrative capabilities and monitoring for the system under the control of an administrative subsystem 140. The administrative workstation 60 allows administrators or other operators to perform routine operations which affect the entire system. Such operations include, but are not limited to, administering the accounts of end users 16, 18, 19 monitoring the traffic through the system, performing a backup and maintaining the programs that comprise the overall system.

A web subsystem 70 is responsible for all interactions with a web browser 80 in the end user devices 16, 18, 19 and serves as the end user interface to the system. All interactions between the end user devices 16, 18, 19 and the database subsystem occur through the web subsystem 70. Internet Information Server 200 (by Microsoft Corporation is an exemplary web server software system 70 in accordance with the present invention, although the present invention is in no way limited to this system.

All systems listed above are preferably communicated via an Ethernet 100 base T network and a switching hub. In addition, a second isolated network segment will preferably exist between the web server 40 and the external communications hardware (e.g. internet router).

The web server 40 is the point of entry to the entire system. The system determines the identity of the users 16, 18, 19 and makes appropriate decisions while serving web pages to the end users 16, 18, 19. The web server 40 sends HTML or other high level computer language to the end user work stations 16, 18, 19 validates passwords, sends logging and transaction information to the database server 50, and performs logical operations, thus behaving as a transactional server.

As noted above, in one embodiment, the server operating system may be a Windows NT server, a multi-platform operating system provided by Microsoft Corporation. The Sun Microsystems Solaris is an alternative embodiment.

The operators of the system may create, delete and update account information by utilizing the administrative subsystem 140 in administration workstation 60. A billing subsystem 100 is used for crediting and debiting end user accounts. End user attorneys and insurers will typically pay an access fee for the use of the system.

Database 110, communication 120 and billing 100 subsystems thus execute essential services for the other parts of the system, and will therefore have well-defined application program interfaces (API) 110′, 120′, 100′, as is well recognized by those with skill in the art. The system will preferably be protected for the Internet by a “firewall” 90 which is a safety precaution, and important with respect to the present invention due to the sensitive and confidential nature of the information in the database.

In a preferred embodiment, the database subsystem 110 stores all pertinent information pertaining to user accounts, administrator accounts, payment, as well as general dynamic system information. All interactions with the database subsystem 110 are performed through a database API 110′ which may define the interface to a library of stored procedures 130.

The administration subsystem 140 provides an interface for operators and managers of the system to modify the database, print reports, view system data and log user comments and complaints. The administration subsystem 140 provides a collection of access forms, queries, reports and modules to implement the administration interface. Administrators typically will have the power within the system to force most actions. The administration subsystem 140 will interact with the communications, database and billing subsystems.

The communications subsystem 120 interfaced to a communications API 120′ will be used to email and contact end users 16, 18, 19. End users 16, 18, 19 may be notified by phone, fax, email or pager, or other communications devices which can be contacted by the system 135.

End users 16, 18, 19 will also have a password accessed section of a website where they can access information relevant to their activities and be provided with detailed reports. A batch subsystem 125 may periodically send out grouped notifications. It will access the database subsystem 110 to determine what notifications are required, and uses the communication subsystem 120 to make those notifications. A group notification may comprise a special premium offered to end users 16, 18. The billing subsystem 100 will be used to verify and bill credit cards and communicate through the billing API 100′ to the administration subsystem 140, and potentially to an outside billing and verification service which could be used to perform the billing functions.

Referring to FIG. 3, the database server 50 which implements the database subsystem 110 of the present invention comprises a server that maintains all associated logging and transaction information for the system. Through the database 150 (which is backed up by a backup database for safety purposes), the database server 50 logs planner and provider setup and account creation information, stores data and changes made to that information, maintains user account information, maintains account balances, produces and prints reports, hosts backup operations and performs statistical calculations for the entire system.

The database server 50 is preferably a dual processor computer microprocessor. Each connection to the database 150 and its associated work may be handled by a separate thread within the database server 50 process space. The disk subsystem 190 of the database server may comprise a vulnerable and crucial server element. Statistical calculations will be performed by the database server 50, along with other types of report generation.

In one embodiment, there will be one operator workstation 60 used for administering the system. As the need for additional workstations arises, additional operator workstations can be added by adding additional computer systems, installing the administration software and connecting them to the LAN. Operator workstation machines preferably utilize a Windows operating environment manufactured by Microsoft Corporation.

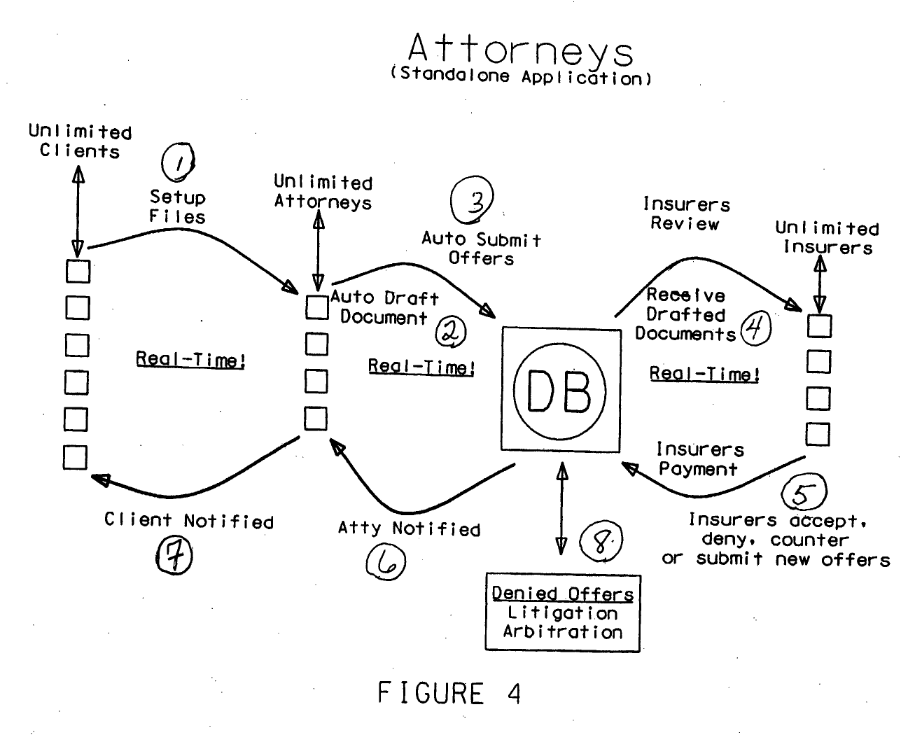

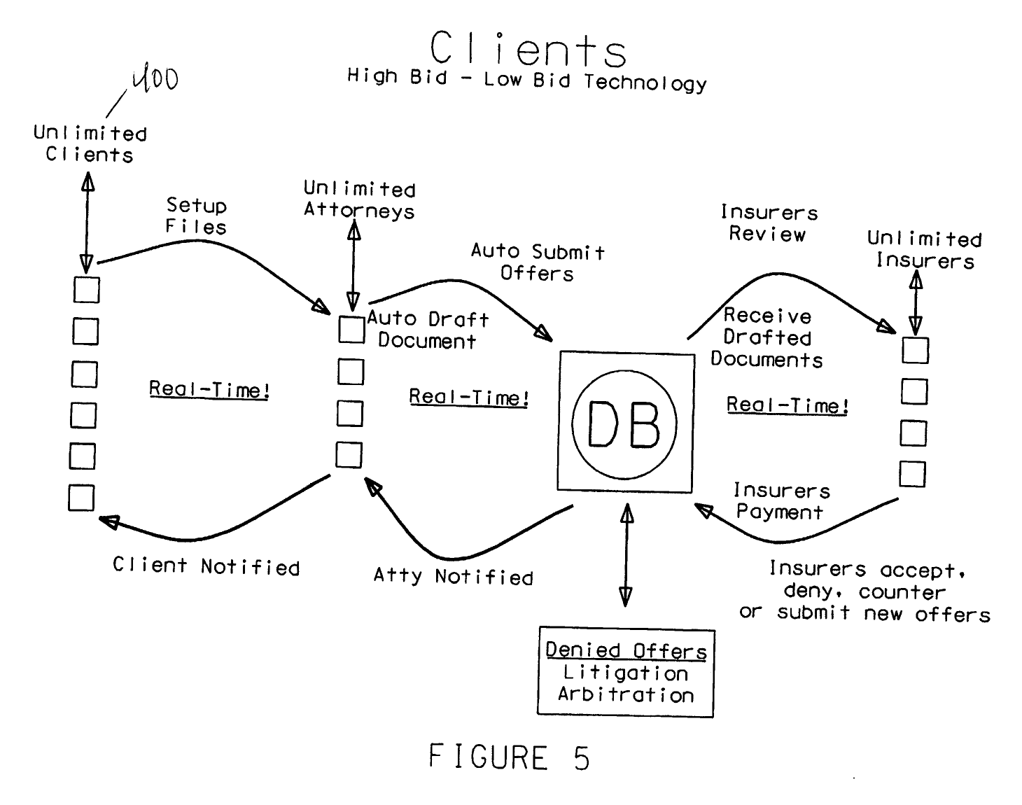

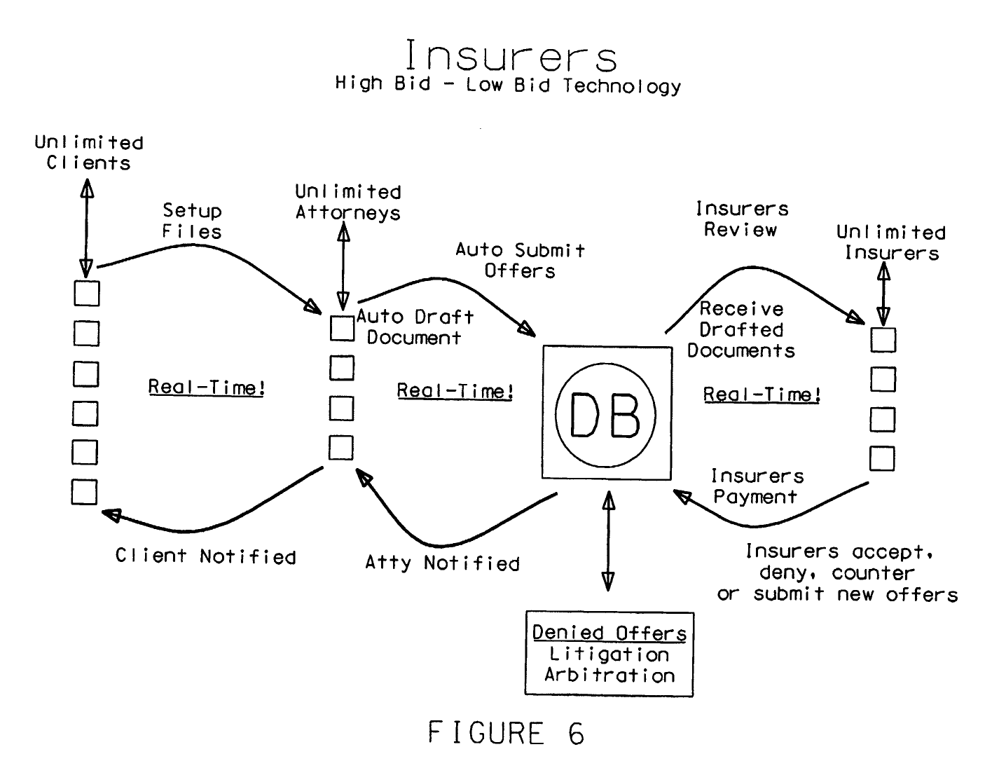

FIGS. 4-6 illustrate one embodiment of a process flow of the present invention. The process is set up to permit an unlimited number of attorneys to represent an unlimited number of clients and to interface with a plurality of insurer/payees. The system comprehensively handles all aspects of the transaction, including file set up; the drafting of documents, electronic document filing; offer, proffer and acceptance; and payment. At step 1 of the process, for example, an unlimited number of clients (e.g., medical providers) may set-up files associated with medical bills that need to be submitted to insurance companies for payment, for example. In one embodiment, each file may relate to a particular bill or set of bills associated with a particular attorney, patient or insurance company, for example. Using a client module, the client may upload all relevant bill information and document and forward to the appropriate attorney(s) for review. The corresponding attorney may then access and view the uploaded documents and information using an attorney module, for example. Upon receipt of the uploaded documents and information, the attorney or the attorney module may automatically draft related documents to forward to an insurance company along with the uploaded bills for payment, and electronically submit drafted documents to the Courts for litigation or arbitration as shown in step 2. In some embodiments, the document(s) drafted may comprise a cover sheet, for example, summarizing the bills presented, while in other embodiments the document drafted may comprise a settlement offer that comprises the total amount of the bills presented, or a predetermined percentage thereof. That is, the attorney and/or the client may decide to seek full payment or some percentage of the bills. Determination of a percentage may be done on a case-by-case basis, such as based on the particular insurance company, patient, medical provider, attorney, or treatment rendered, for example. For instance, it may be decided that all bills presented to a particular insurance company should be offered at a 10% discount, or that bills for a particular procedure, patient or client be offered at a 25% discount, for example. In some embodiments, the process of drafting documents and presented settlement offers is done automatically without any form of attorney invention.

At step 3, the bill documents and information, including any documents drafted by the attorney module are submitted for payment. In one embodiment, submission for payment involves storage in a particular database (DB) accessible by attorneys, clients and insurance companies, as shown. At step 4, the insurance company may receive the bill documents and information, such as by accessing the DB, for example. In some embodiments, the insurance company accesses the bills and documents using an opposing module. At step 5, the insurance company decides whether it accepts the bills (i.e. will pay), denies, present an offer for payment, or if an specific offer was proposed, whether to present a counter-offer. In some embodiments, the insurance companies disposition of the bills may be done via the opposition module which may be in communication with the attorney and client modules.

At step 6 and 7, the attorney and client may be notified that the insurance company has processed the bills, and that they may be accessed through DB. If payment is denied, the client and attorney may decide to litigate the denial, as shown in step 8, or make a settlement offer, which would involve going back to step 3. The decision to litigate/arbitrate or present a settlement offer may be done manually, such as by the attorney, or automatically, such as by attorney module 25. If litigation/arbitration is desired, the attorney module may automatically draft the appropriate summons and complaints associated with the denial of payment. Information relevant to the summons and complaint may be automatically populated onto the necessary forms by the attorney module, for example. Further, the attorney module may docket relevant dates and provide appropriate notifications, such as to the client and opposing party, for example. In other embodiments, electronic filing of the summons and complaint with the appropriate court(s) may also be accomplished.

If a settlement offer or counter-offer is proposed, the cycle between steps 3 and 7 may repeat until settlement is reached. In some embodiments, settlement offers and counteroffers, for example, may be presented without the need of inputting information relating to the claims. That is, the information relating to the client, attorney and insurance company has been previously stored and the various modules are able to automatically identify the relevant parties. In various embodiments, the appropriate attorney, client, and/or insurance company is immediately notified of an offer, such as through a pop-window, email, fax, telephone call, or any other form of communication. If the offer is rejected, counter-offers may be proposed. In some embodiments, settlement percentages may be predetermined. Such settlement percentages may be applied as designated, such as depending on insurance company, client, attorney, patient, treatments rendered, etc.

If a particular settlement is accepted by a client, attorney or insurance company, the attorney module, for example, may automatically draft the necessary documents, such as a settlement agreement or related documents, for example. In some embodiments, the settlement agreement and related documents may be automatically populated by the attorney module and transmitted to the appropriate recipients, such as the client and insurance company, for example. In some embodiments, settlement statistics, such as the ultimate settlement amount, and previous offers and counteroffers, for example, may be stored in DB for future reference.

According to various embodiments of the invention, the client and opposition modules are part of a central module or server, which in turn is connected to various attorney modules (each representing specific attorneys or firms) over at least one communications network, such as the Internet, for example.

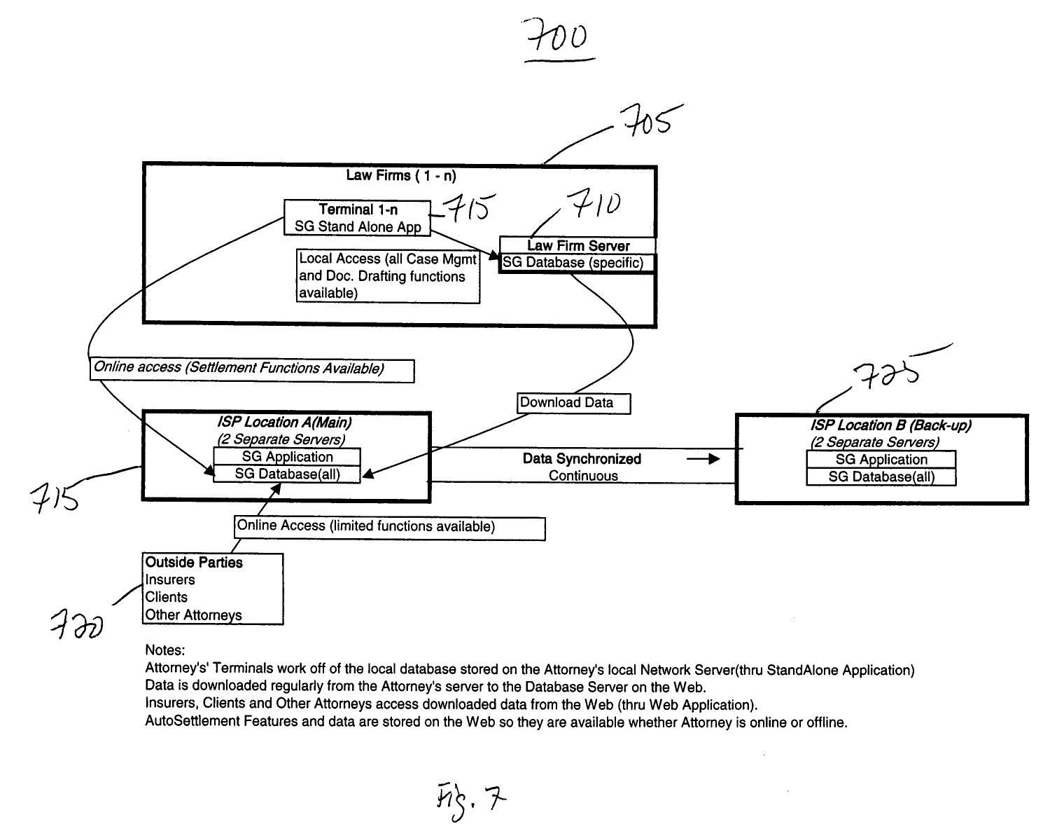

FIG. 7 illustrates a system 700 according to one embodiment of the invention. As shown, system 700 includes a law firm or attorney 705 which has access to a server 710 and a terminal 715. In some embodiments, server 710 may include the attorney module 25 discussed above. The attorney or law firm may interact and engage the attorney module 25 through terminal 715. In some embodiments, information or data inputted, received or processed by attorney module may be stored in a database specifically associated with server 710, as shown. In other embodiments, select data and information may also be stored in a remote database associated with a central server, as shown in 715 and 725, which is further accessible by clients and attorneys.

Central servers 715 and 725 may also include client and opposing party modules through which clients and opposing parties, for example, may respectively access the various features and functionality of the invention. In some embodiments, clients and opposing parties have more limited access than do attorneys. In various embodiments, central servers 715 and 725 may periodically (or as determined by attorneys, for example) receive select data and information (i.e. scrape) from all or any number of available attorney modules. This data and information may relate to particular cases and disputes and may provide clients and opposing parties with up-to-date and accurate status information, for example.

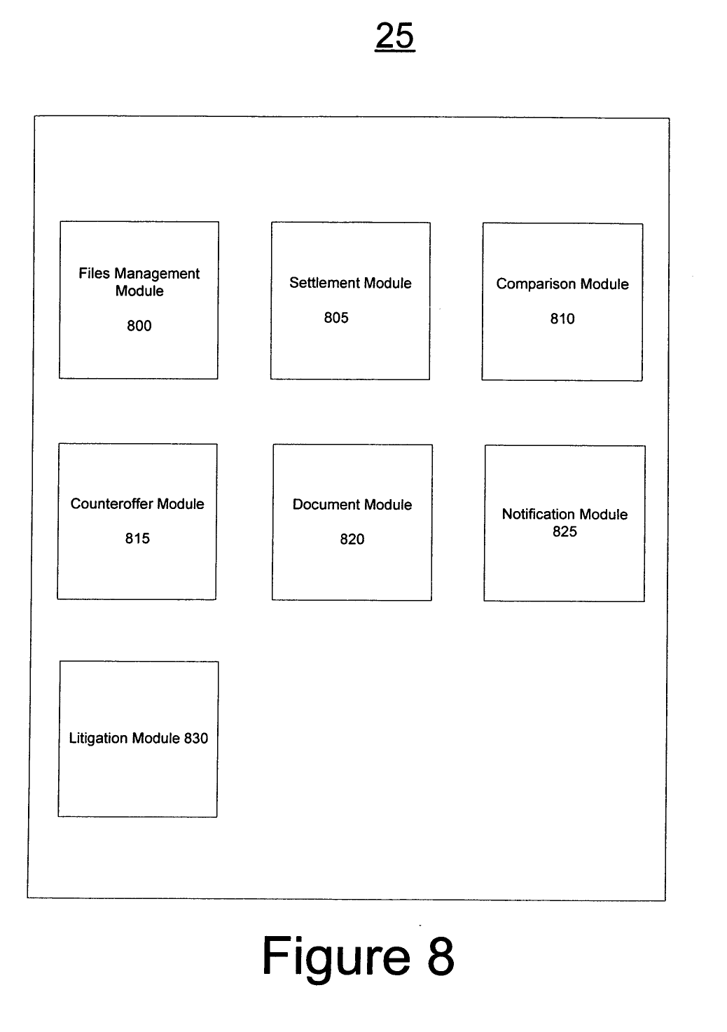

FIG. 8 illustrates one embodiment of an attorney module 25. In some embodiments the attorney module 25 includes files management module 800. Files management module 800 may enable an attorney to input information about itself during registration, such as name, contact information, etc. The information entered may be used by the various modules of the systems described herein to enable the various automated features and functionality discussed. Files management module 800 may enable the attorney to manage client files as well as insurance company files. For example, in some embodiments, file management module 800 may enable the attorney to view incoming bill documents and information from corresponding clients. Files Management module 800 may process the incoming bill documents and information and present them to the attorney in a viewable and efficient manner. In various other embodiments, the attorney module 25 may also include a settlement module 805. Settlement module 805 may be used by the attorney interacting with the attorney module to present and receive settlement offers. For example, the attorney may interact with the settlement module 805 to prepare or propose a particular settlement offer for a particular set of client bill(s). Settlement module 805 may also be used to receive particular settlement offers from insurance companies, for example. Settlement module 805 may also be used by an attorney to designate particular settlement percentages to be applied as determined, and to receive electronic payments on the settlements. For example, a particular settlement percentage may be determined for each particular insurance company, for each client, for each patient, or for particular treatments rendered. Thus, all bills from a particular client may be presented at a particular discount. Bills to a particular insurance may also be presented at a particular discount.

Attorney module 25 may also include in some embodiments a comparison module 810 for comparing settlement offers or counteroffers received from insurance companies, for example. In some embodiments, the comparison module 810 may receive a particular settlement offer from an insurance company and compare that offer to a predetermined settlement amount stored in the system. The predetermined settlement amount may comprise a percentage of a particular bill from a particular client, for example. In some embodiments, if the offer received from an insurance company is less than the predetermined settlement amount the comparison module may associate with a counteroffer module 815 to present a counteroffer to the insurance. If, however, the offer is equal to or greater than a predetermined settlement amount, comparison module may associate or cooperate with document module 820 to automatically prepare the necessary acceptance documents, for example.

Attorney module 25 may also include a document module 820 for preparing and drafting documents necessary or relevant to any of the features in functionality described herein. For example, document module 820 may associate with files management 800 whenever incoming bills are coming from particular clients. Thus, whenever a client sends or uploads bills and documents to an attorney, document module 820 may automatically populate and draft the necessary corresponding documents. These documents may include coversheets to include with the bill and documents when the attorney presents for payment to an insurance company. In other embodiments, document module 820 may also associate with any of settlement module 805, comparison module 810 or counteroffer 815 in association with the presentation, reception and proposals of offers and counteroffers.

Attorney module 25 may also include a notification module 825 which allows an attorney to notify clients and opposing parties (e.g., insurance companies) of upcoming deadlines, dates, meetings, court dates, settlement conferences, etc. Notification module 25 may also interface or cooperate with a document module 820 to track documents being manually or automatically prepared or drafted. Notification may determine the document being drafted and immediately notify clients, other attorneys, and/or opposing parties, for example.

Attorney module 25 may also include a litigation module 830 which operates to automatically populate and draft litigation related documents, such as summons and complaints, for example, and to file the same with the appropriate court(s). In some embodiments, litigation module 830 may prepare and/or electronically file such litigation forms upon an insurance companies denial of particular bill(s) or claim(s), for example. In some embodiments, electronic document filing may be accomplished, by submitting documents to a third party “interface” that does the actual electronic filing, such as Lexis/Nexis File & Serve, for example. In other embodiments, a submission tool, for example, may be incorporated within the attorney module and simply by choosing the “third-party” and “court”, the document(s) will be transmitted to the third-party who actually files the document in court.

Attorney module 25 (or client and opposing modules) may also comprise a payment tool for the sending and receiving of electronic payments. The payment tool may function to interface with or transmit/receive payment data to or from a third-party Paypal™ or Verisign™ and process the information through the attorney, client and insurer module. For example, the third party would deposit the funds in a bank account and send you an email notice that you received the funds. The attorney module, for example, may simply take the electronic payment data received from the third-party and process it through the program. It would note the file, enter the payment on the clients account and automatically deduct the amounts due from the client invoice, and then automatically notify the attorney and client. Client and Opposing party modules would simply present an invoice to the parties collect the payment information from the parties and automatically submit it to the third-party. This feature is to be used to automate the attorney, client and opposing party modules to perform this function without manually repeating the entry and uploading of identical documents and information sent or received from a third-parties server.

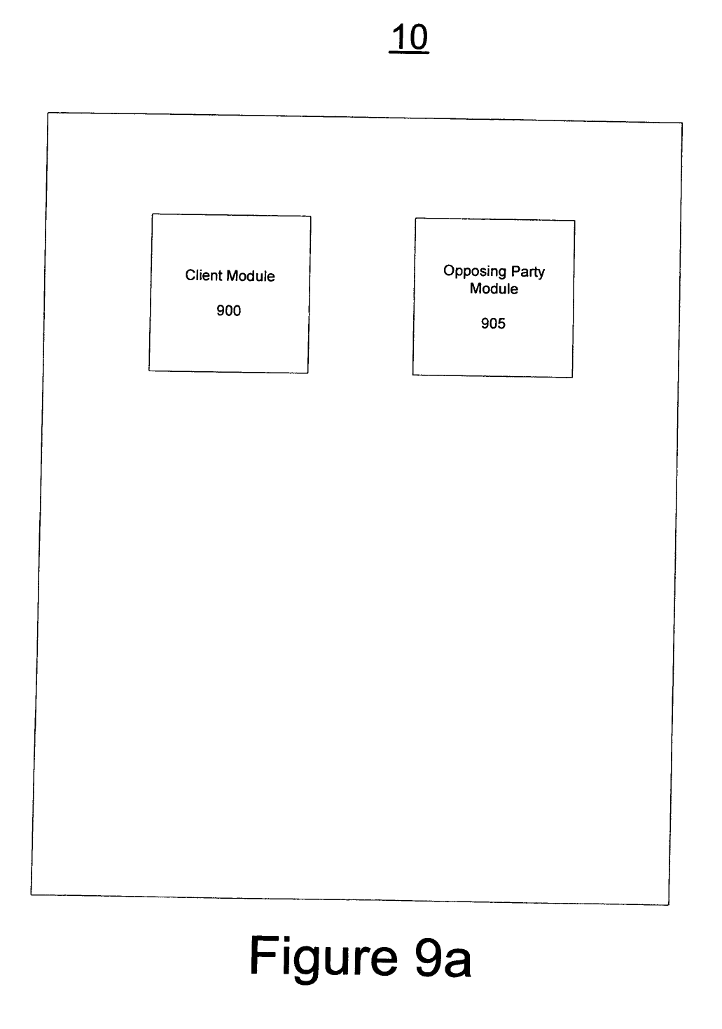

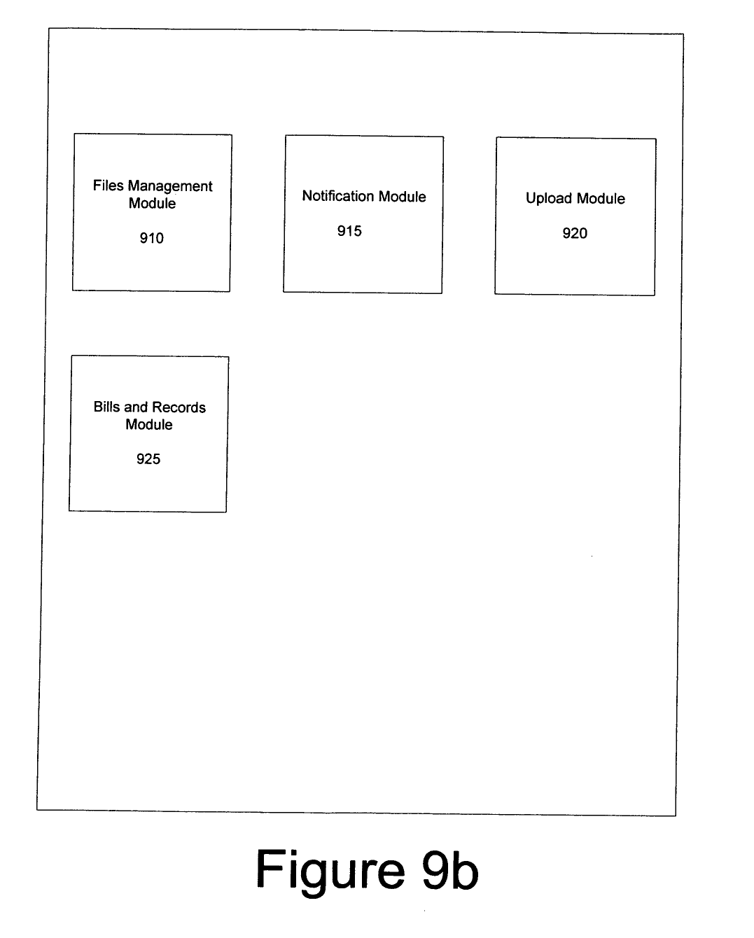

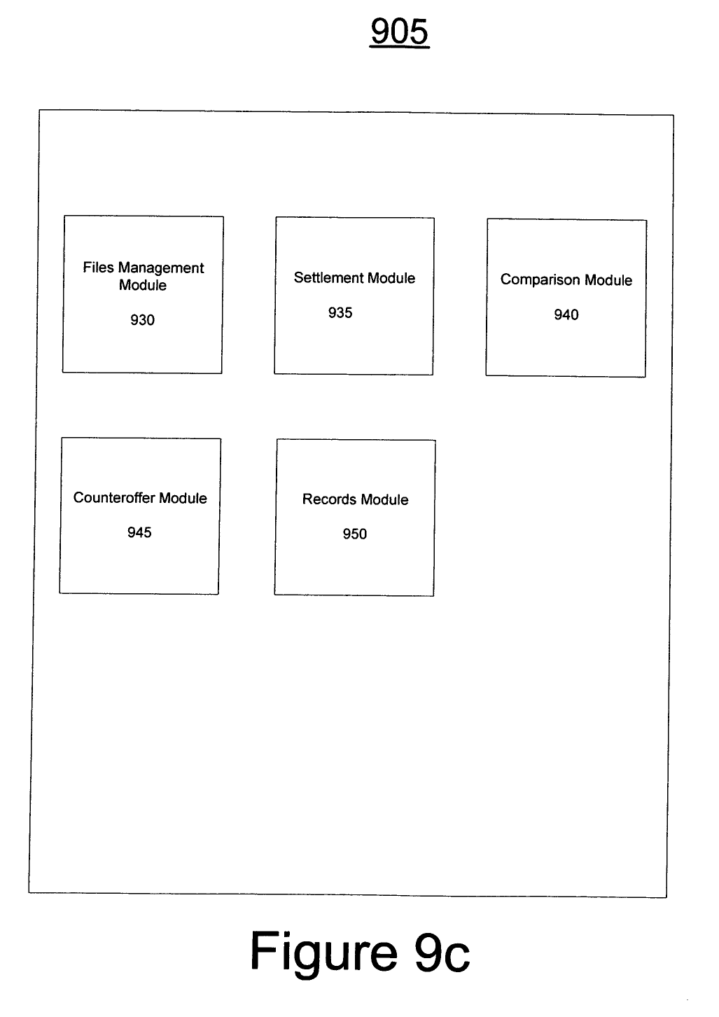

FIG. 9A illustrates one embodiment of a central server 10. Central server 10, as shown, may include a client module 900 and an opposing module 905. Each will be described below.

FIG. 9B illustrates one embodiment of a client module 900. In some embodiments client module 900 may include a file management module 910 for managing files associated with particular attorneys and insurance companies, for example. Files management module 910 may be used by a client, for example, to input information about itself during registration. The information entered may be used by the various modules of the systems described herein to enable the various automated features and functionality discussed. In other embodiments, file management module 900 may enable a client to provide particular information regarding the client's patients, medical reports, medical bills, treatment procedures, including the sending of payment information against attorney invoices, etc. All this information may be uploaded (as explained below) so that attorneys and perhaps insurance companies can access as necessary.

According to the various embodiments, client module 900 may also include a notification module 915 for receiving and providing notifications related to any case or pending dispute. For example, notification module 915 may provide pop-up windows to the client whenever a particular event or occurrence occurs or takes place during a case dispute. Such event or occurrence may include, for example, the reaching of settlement, the filing of a summons and complaint, the presentation of bills for payment, or any other date which a client should be notified of. Notification module 915 may be used to also notify other attorneys and opposing parties.

Client module 900 may also include an upload module 920 through which clients can upload documents and information relevant to particular bills or treatment rendered to its patients, for example. Upload module 920 may be used, for example, to upload photographs of facilities and equipment. Module 920 may also be used to upload medical records, medical bills, license and certifications of various doctors and providers as well as any other documents or information related to the collection of bills for treatment rendered to patients. Client module 900 may also include in some embodiments a bills and records module 925 for administering bills and records on the client side. Bills and records module 925 may associate or cooperate with upload module 920 to provide described functionality.

FIG. 9c illustrates an embodiment of an Opposing party module 905. According to some embodiments, opposing module 905 may include a file management module 930 for allowing an insurance company, for example, to manage client (e.g., medical provider) and attorney files. In other embodiments opposing module 905 may include a settlement module 935 for allowing the insurance company to receive and propose settlement offers to attorneys and clients. Including the sending of electronic payments. Opposing module 905 may also include a comparison module 940 for comparing received settlement offers and counteroffers to predetermined settlement amounts. A predetermined settlement amount may comprise a particular amount that an insurance company would be willing to pay to settle a particular set of bills or claims. A predetermined settlement amount may, in some embodiments, be based on a predetermined settlement percentage that the insurance company is willing to pay for particular bills or set of claims. For example, if an insurance company does not want to pay more than 75% of presented bills from medical provider A, for example, then a predetermined settled percentage may be applied to any bills from medical provider A. This way, an insurance company may automatically present a counteroffer to medical provider B for an amount equivalent to the proposed bill times the predetermined settlement percentage, for example. Opposing module 905 may also include a records module 950 for allowing an insurance company, for example, to present and access records related to its disposition of bills presented for payment by clients or attorneys.

Various systems performed by the above systems are described below.

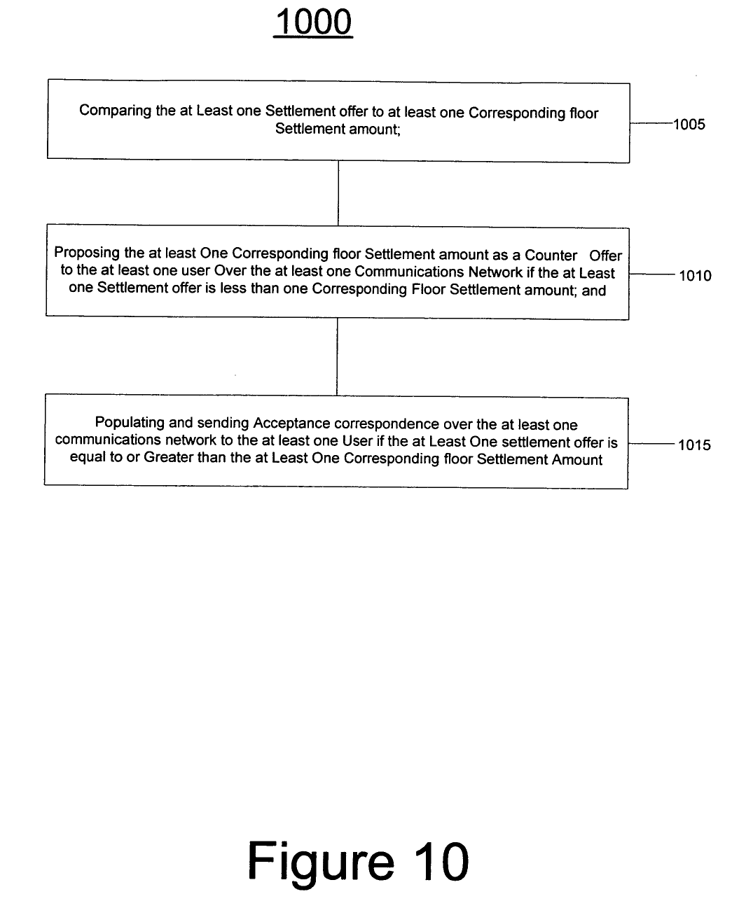

FIG. 10 illustrates a system 1000 for settling at least one dispute. An insurance company or attorney, for example, may receive and view at least one settlement offer over at least one communications network, as discussed above. In some embodiments, the offer may be received over the Internet or telecommunications network. At step 1005, the offer may be automatically compared to at least one corresponding floor settlement amount. In some embodiments, the floor settlement amount is predetermined. In various embodiments, the floor settlement amount may comprise the balance due under a particular bill or bills times a predetermined settlement percentage. The predetermined settlement percentage may be determined by the client, attorney or insurance company, and may apply as determined. At step 1010, the party receiving the offer may propose the corresponding floor settlement amount as a counter-offer if the at least one settlement offer is less than the corresponding floor settlement amount. If, however, the offer is equal to or greater than the corresponding floor settlement amount, an appropriate document may be populated and sent to the offeror. The document may comprise acceptance correspondence sent over at least one communications network.

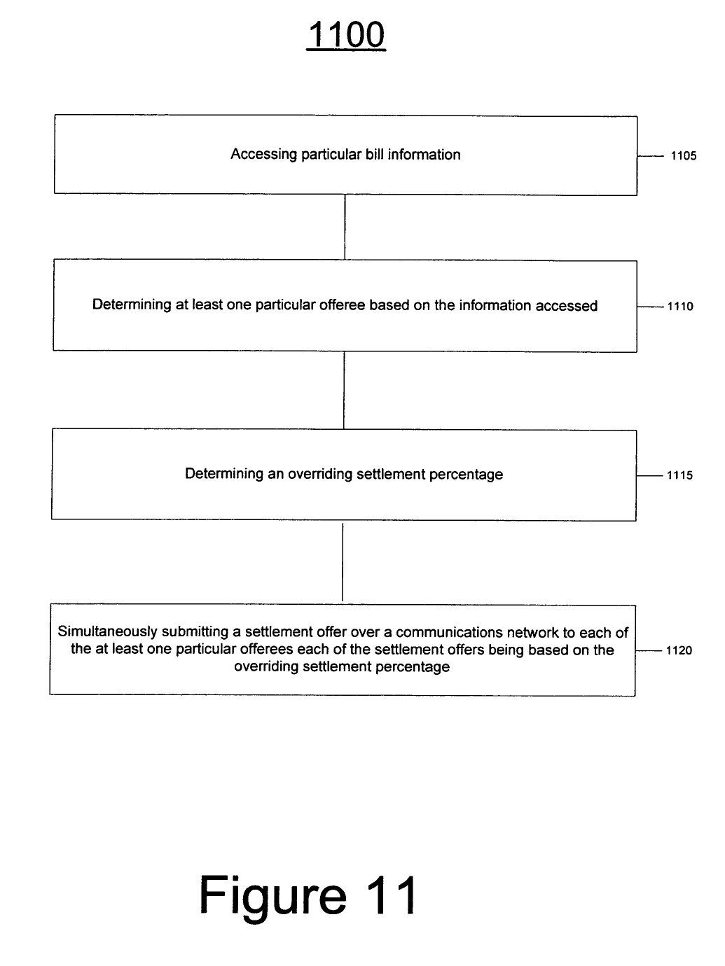

FIG. 11 illustrates a system 1100 for making bulk settlement offers. At step 1105, particular bill information is accessed. In some embodiments, information may comprise outstanding balances owed under particular bill(s), for example. In other embodiments, information may comprise pending settlement offers or counter-offers corresponding to particular bill(s). Once this information is accessed, at step 1110 particular offerees may be selected based on the bill information accessed. An offeree may comprise an attorney, client or insurance company. Thus, if the bill information accessed indicates various attorneys, for example, the insurance company may specify a particular attorney or attorneys it would like to present a settlement offer to. Likewise, if the bill information accessed indicates various insurance companies, for example, an attorney may select an insurance company or companies to present a settlement offer to. At step 1115, an overriding settlement percentage may be determined. At step 1120, the an attorney, for example, may simultaneously submit a settlement offer to each of the offerees selected. In some embodiments, each of the settlement offers presented may be based on the overriding settlement percentage. That is, each settlement offer being presented may comprise the product of the overriding settlement percentage and the particular amount due under a particular bill(s).

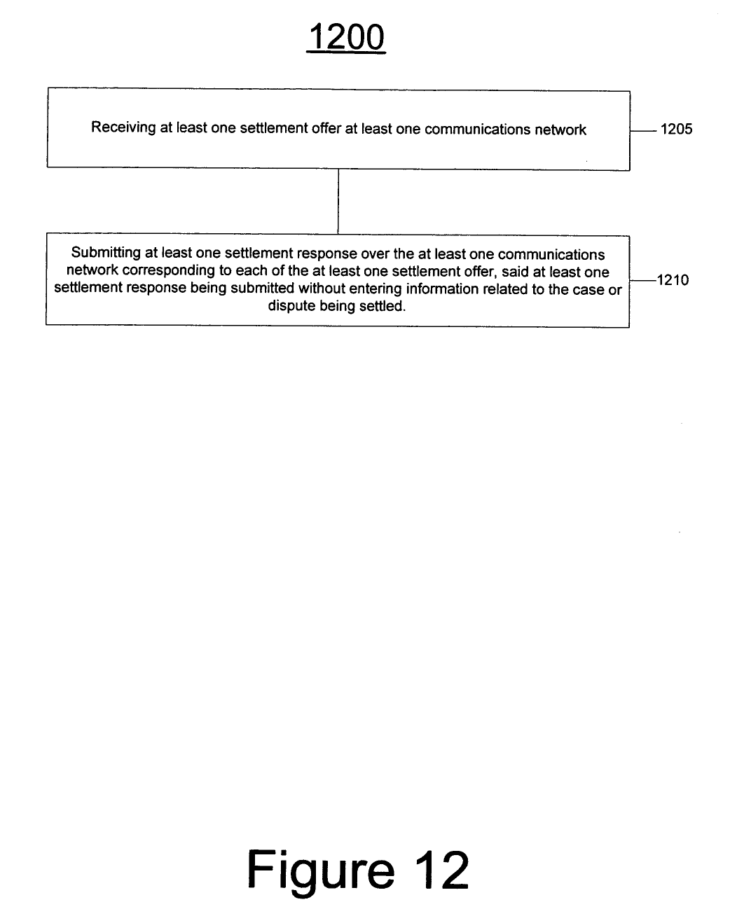

FIG. 12 illustrates a system 1200 for settling a dispute. At step 1205, an attorney or insurance company, for example, may receive at least one settlement offer over at least one communications network. At step 1210, the attorney or insurance company may submit at least one settlement response over the at least one communications network corresponding to each of the at least one settlement offer, said at least one settlement response being submitted without entering information related to the case or dispute being settled.

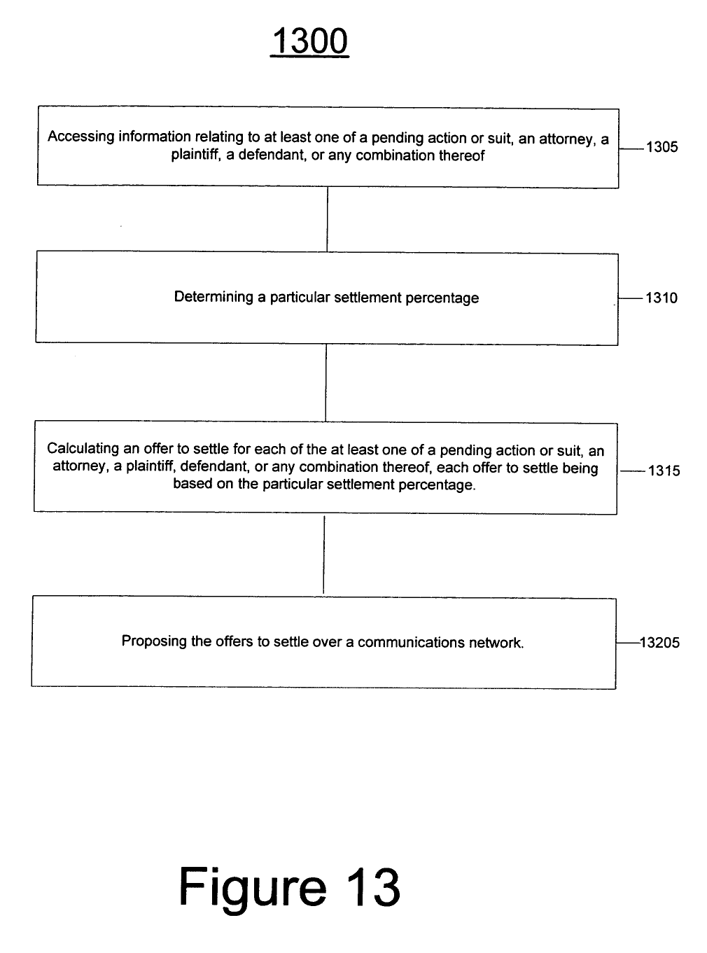

FIG. 13 illustrates a system 1300 for making a settlement offer. At step 1305, information relating to at least one of a pending action or suit, an attorney, a plaintiff, a defendant, or any combination thereof is accessed. At step 1310, a particular settlement percentage is determined. At step 1315, an offer to settle is calculated for each of the at least one of a pending action or suit, an attorney, a plaintiff, defendant, or any combination thereof, each offer to settle being based on the particular settlement percentage. At step 1320, the offers to settle are proposed over a communications network.

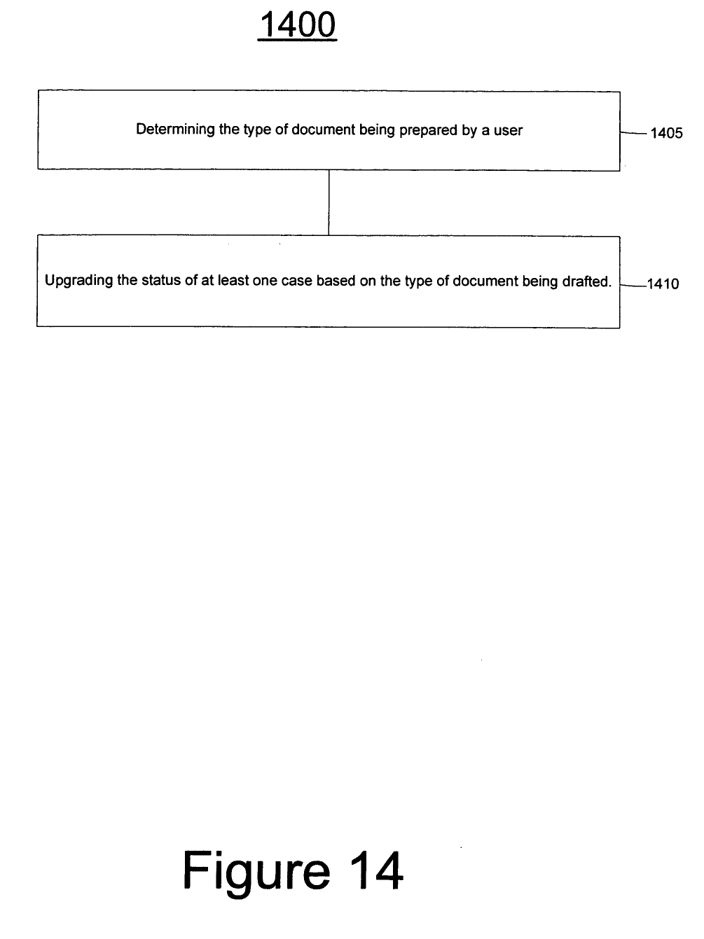

FIG. 14 illustrates a system 1400 for managing a case. At step 1405, the type of documented being prepared or drafted by an attorney is determined. At step 1410, the status of at least one case is upgraded based on the type of document being drafted.

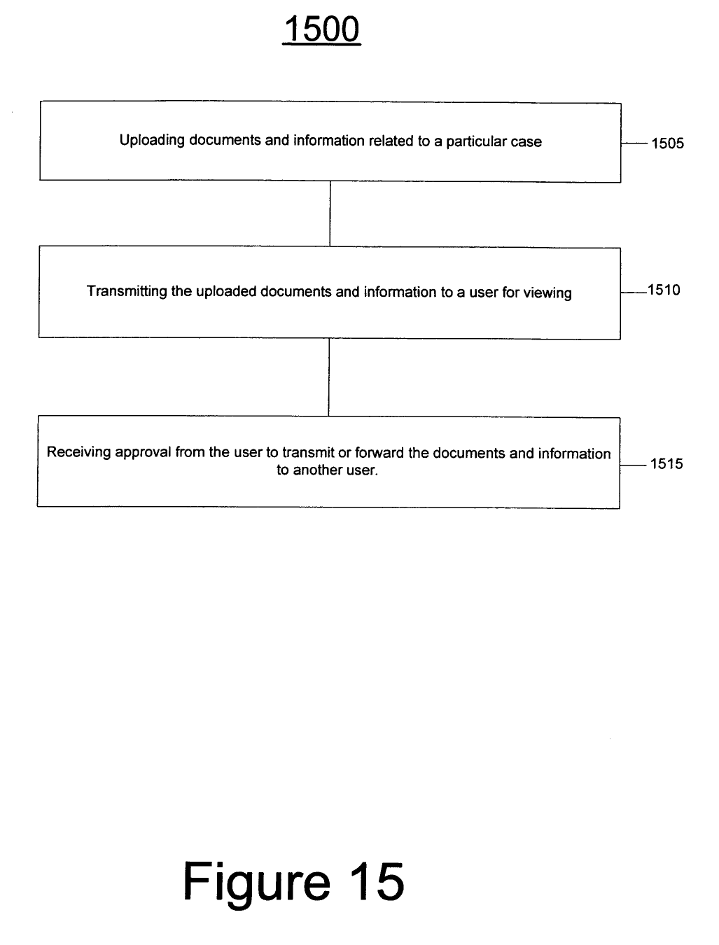

FIG. 15 illustrates a system 1500 for uploading and transmitting case documents and information. At step 1505, documents and information related to a particular case are uploaded. At step 1510, the uploaded documents and information are transmitted to a user for viewing. At step 1515, approval is received from the user to transmit or forward the documents and information to another user.

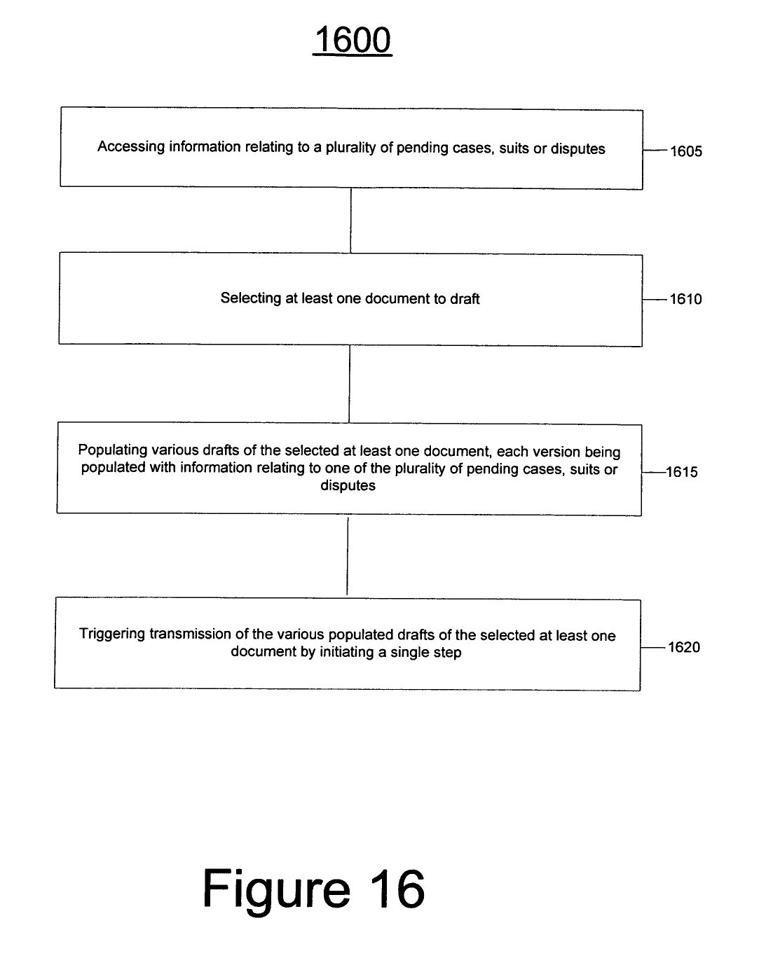

FIG. 16 illustrates a system 1600 for simultaneously drafting a plurality of documents. At step 1605, information relating to a plurality of pending cases, suits or disputes is accessed. At step 1610, at least one document to draft is selected. At step 1615, various drafts of the selected at least one document are populated, each version being populated with information relating to one of the plurality of pending cases, suits or disputes. At step 1620, transmission of the various populated drafts of the selected at least one document is triggered by initiating a single step.

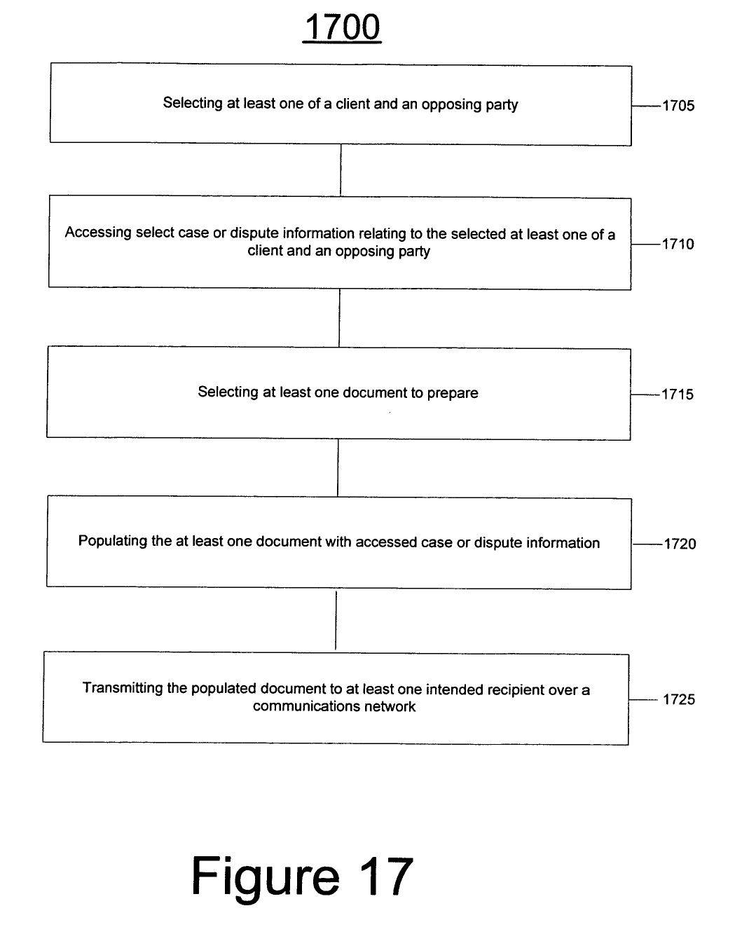

FIG. 17 illustrates a system 1700 for consolidating case information into a document. At step 1705, at least one of a client and an opposing party is selected. At step 1710, select case or dispute information relating to the selected at least one of a client and an opposing party is accessed. At step 1715, at least one document to prepare is selected. At step 1720, at least one document with accessed case or dispute information is populated. At step 1725 the populated document is transmitted to at least one intended recipient over a communications network.

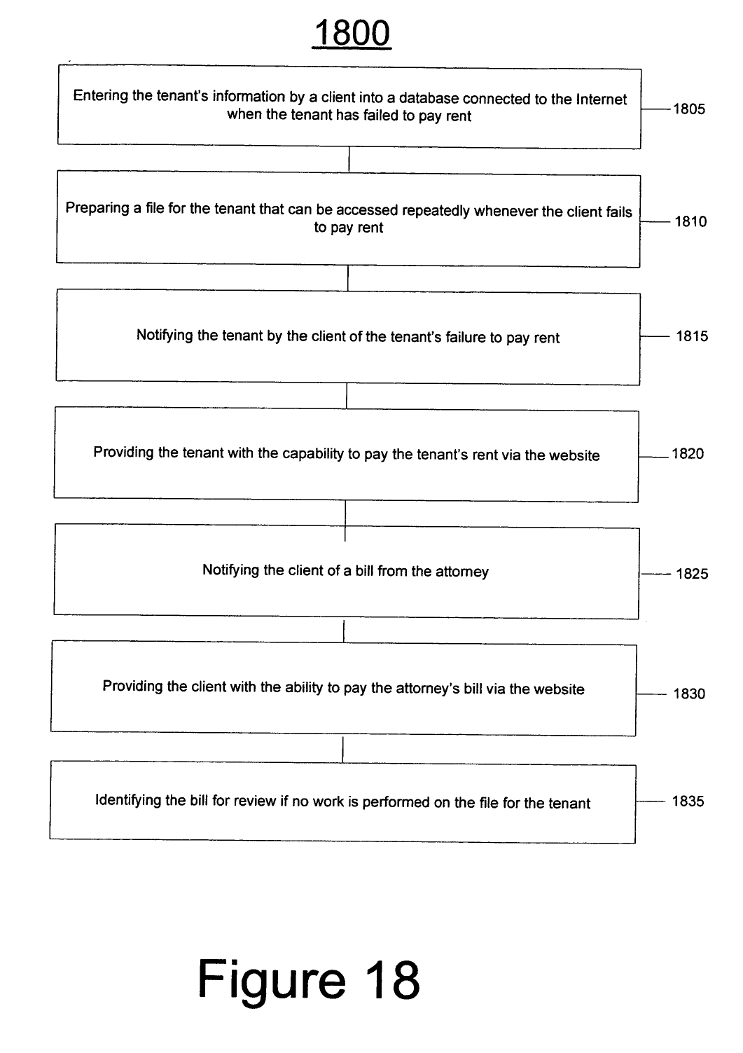

FIG. 18 illustrates a system 1800 of providing an attorney landlord and tenant management website. At step 1805, the tenant's information is entered by a client into a database connected to the Internet when the tenant has failed to pay rent. At step 1810, a file for the tenant is prepared that can be accessed repeatedly whenever the client fails to pay rent. At step 1815, the tenant is notified by the client of the tenant's failure to pay rent. At step 1820, the tenant is provided with the capability to pay the tenant's rent via the website. At step 1825, the client is notified of a bill from the attorney. At step 1830, the client is provided with the ability to pay the attorney's bill via the website. At step 1835, the bill for review is identified if no work is performed on the file for the tenant.

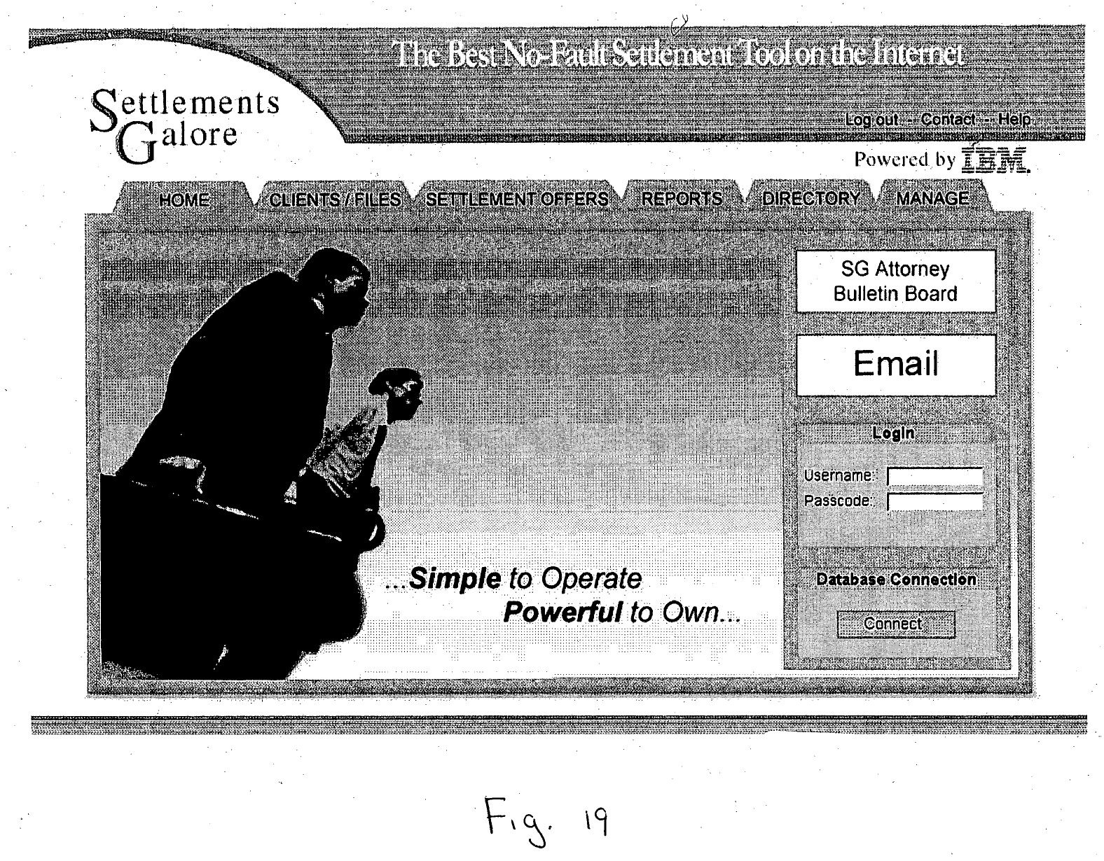

FIGS. 19-64 exemplify various screen shots (or graphical user interfaces (GUIs)) which may enable interaction between users—e.g., attorneys, clients, and insurance companies—and the various modules and features described above. Other screen shots and interfaces are of course possible.

FIGS. 19-45, for example, illustrate various interfaces that may be associated with attorney module 25 discussed above.

FIG. 19 illustrates an embodiment of an interface for logging into an attorney module 25 discussed above. Attorneys will typically have more viewing power than the clients in the system. When an attorney is logging on an online server database, the program will notice that it is not the client but one of the attorneys registered under the manage page and it will take that attorney to his/her pages containing only files for those clients he is representing.

FIGS. 19-70 exemplify various screen shots (or graphical user interfaces (GUIs)) which may enable interaction between users—e.g., attorneys, clients, and insurance companies—and the various modules and features described above. Other screen shots and interfaces are of course possible.

FIGS. 19-45, for example, illustrate various interfaces that may be associated with attorney module 25 discussed above.

FIG. 19 (S1) illustrates an embodiment of an interface for logging into an attorney module 25 discussed above. Attorneys will typically have more viewing power than the clients in the system. When an attorney is logging on an online server database, the program will notice that it is not the client but one of the attorneys registered under the manage page and it will take that attorney to his/her pages containing only files for those clients he is representing.

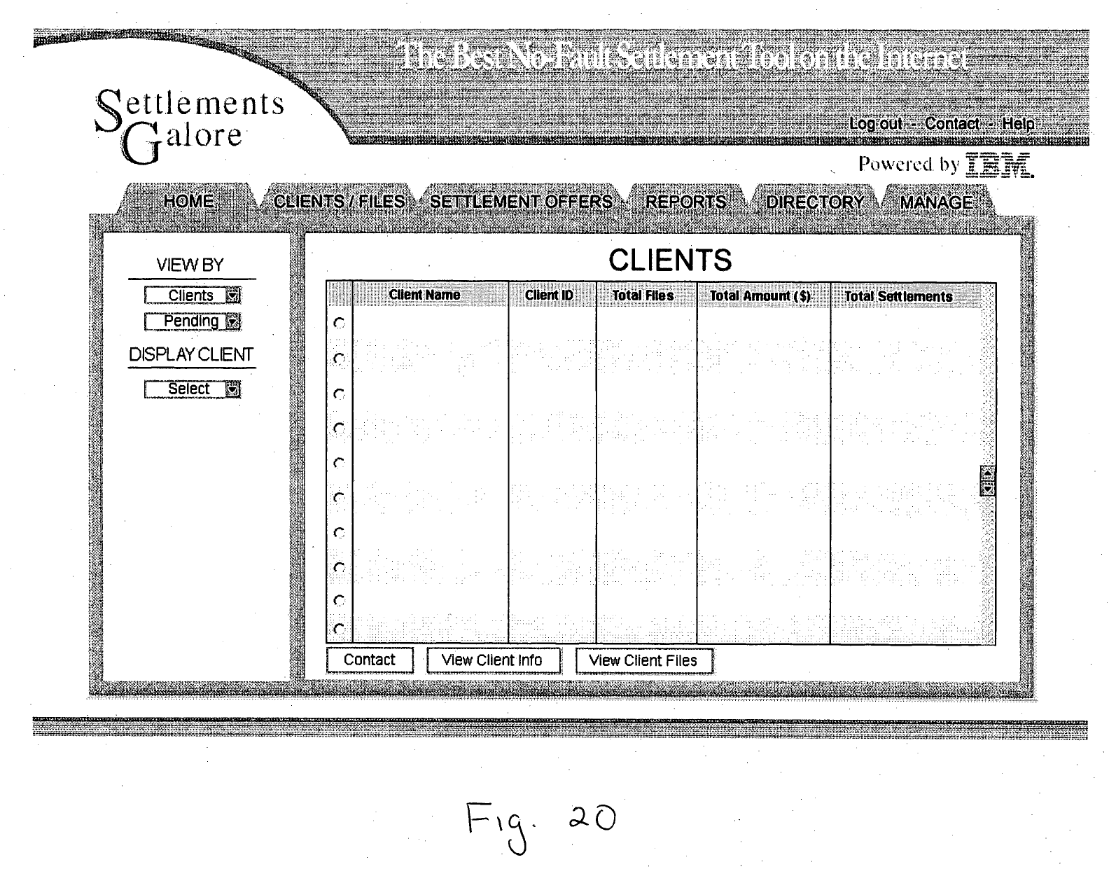

FIG. 20 (S2) illustrates an embodiment of an interface displaying a list of clients entered into in by the attorney or received from the client module.

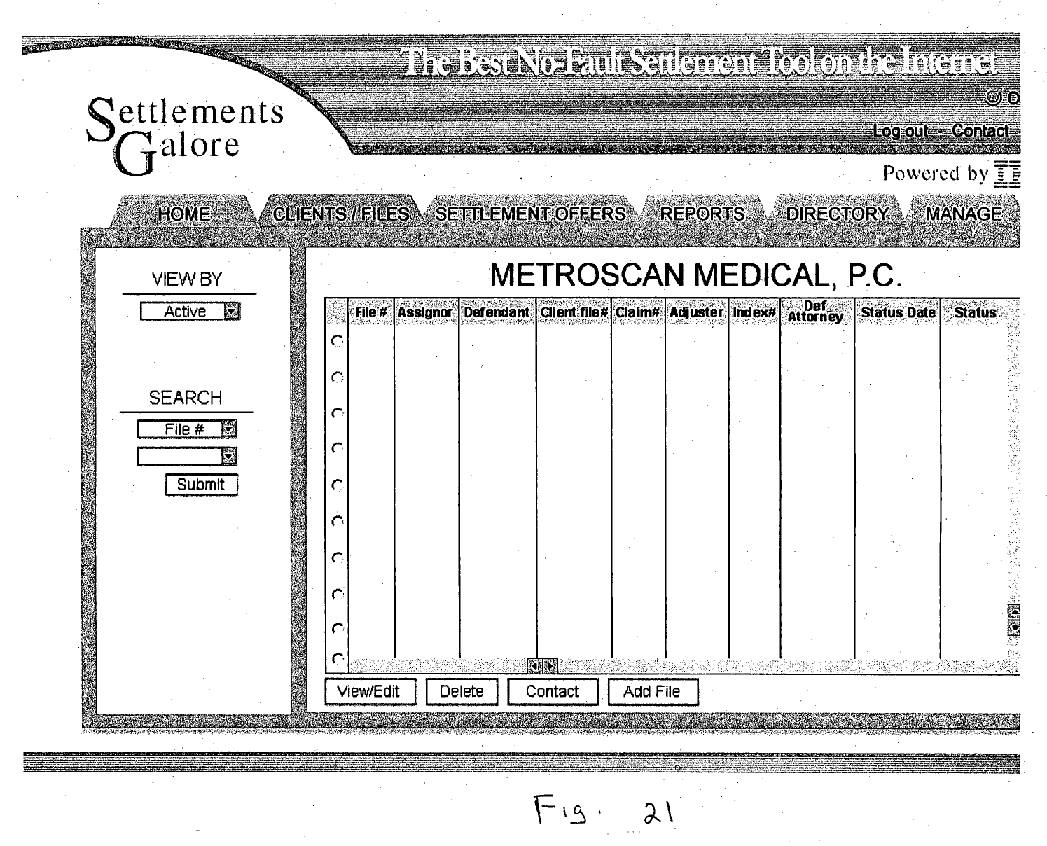

FIG. 21 (S3) illustrates an embodiment of an interface displaying case data entered into by the attorney or received from the client module.

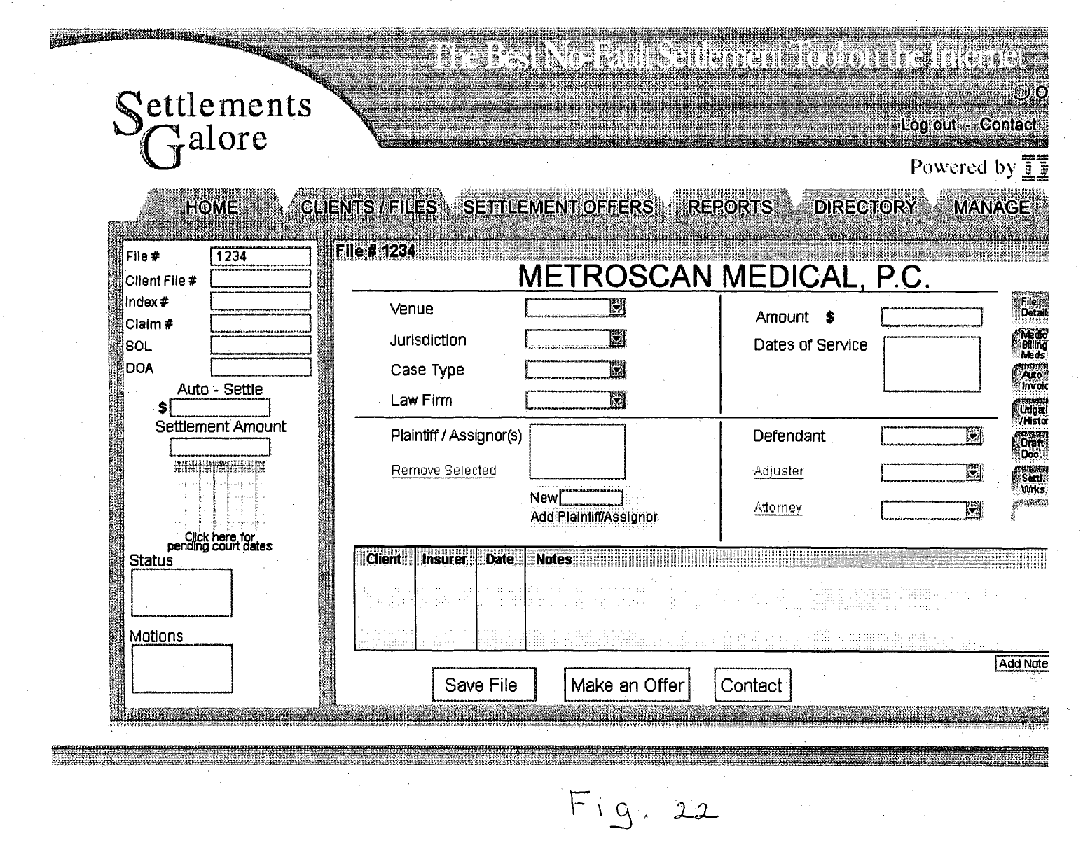

FIG. 22 (S4) illustrates an embodiment of an interface displaying case data received from the client module and allowing the entry of case data by the attorney.

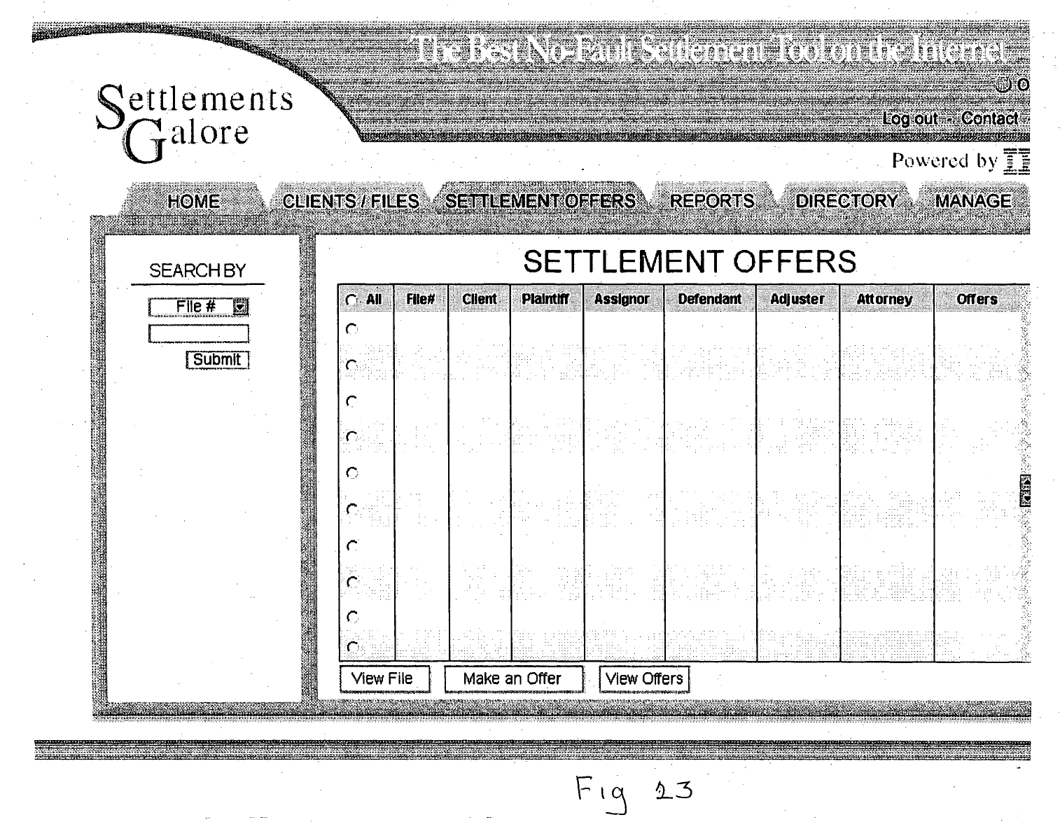

FIG. 23 (S5) illustrates an embodiment of an interface allowing the attorney to submit one or multiple settlement offer to opposing parties and to review the status of submitted offers.

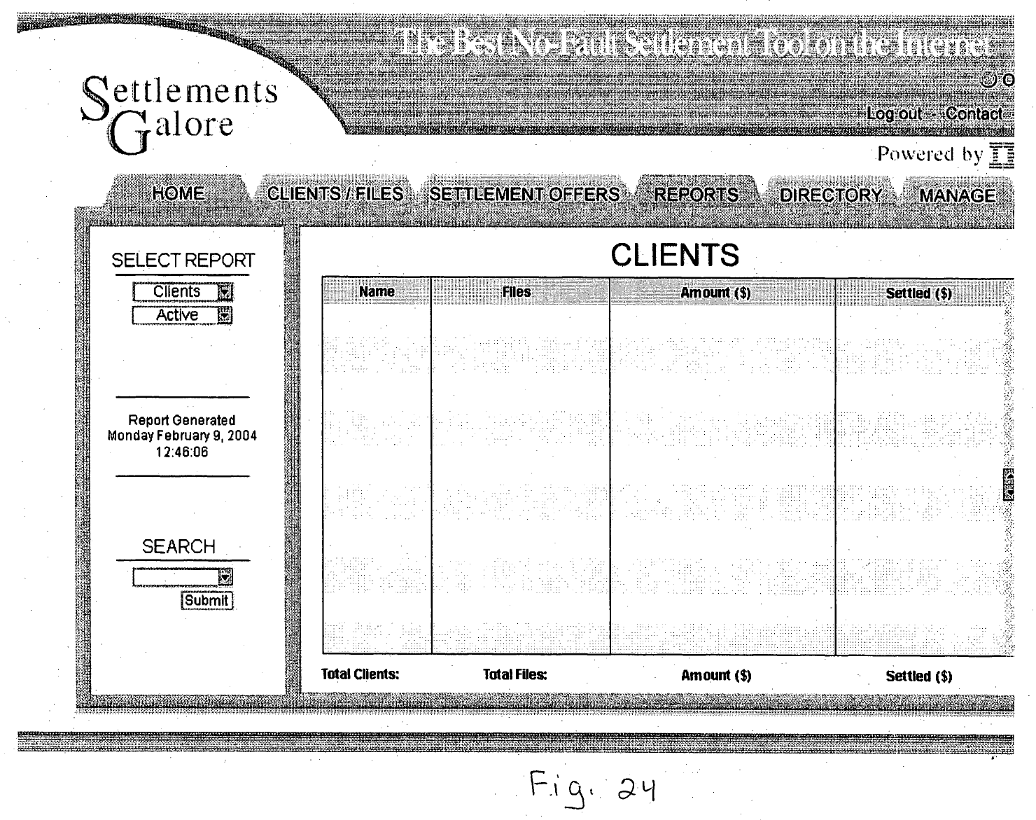

FIG. 24 (S6) illustrates an embodiment of an interface that allows attorneys to view and print-up reports on clients and case data entered by the attorney or received from the client module.

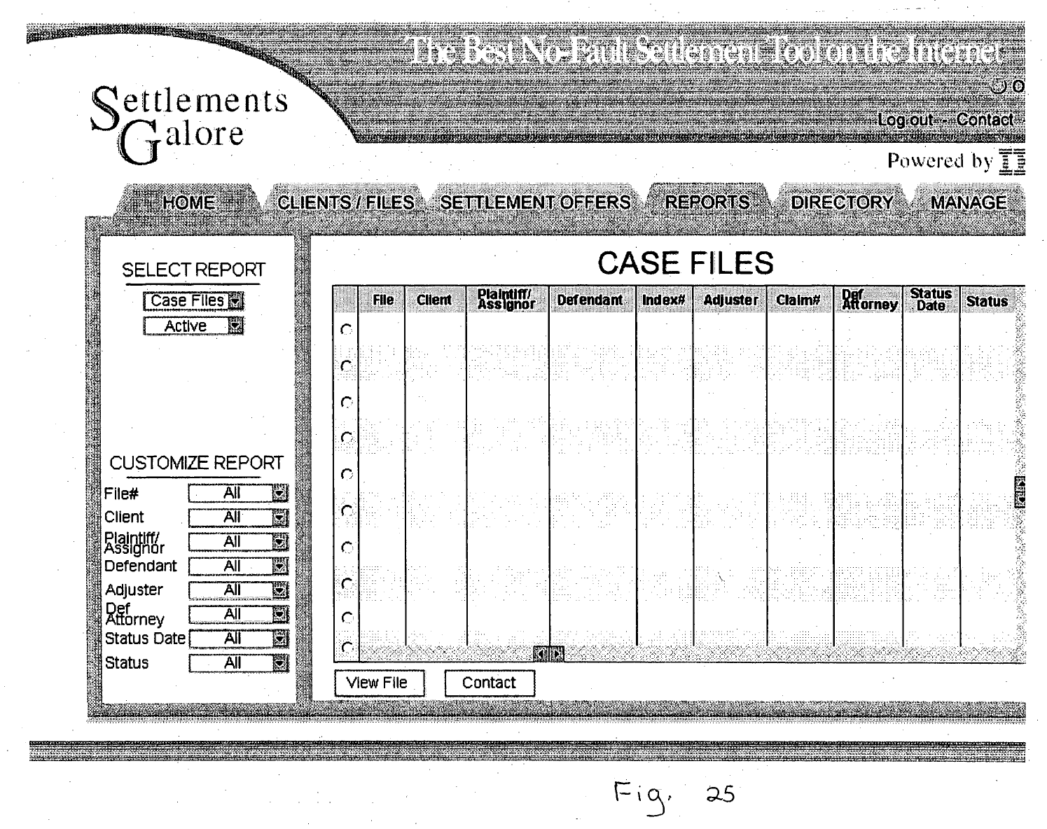

FIG. 25 (S7) illustrates an embodiment of an interface that allows attorneys to view and print-up reports on case files entered by the attorney or received from the client module.

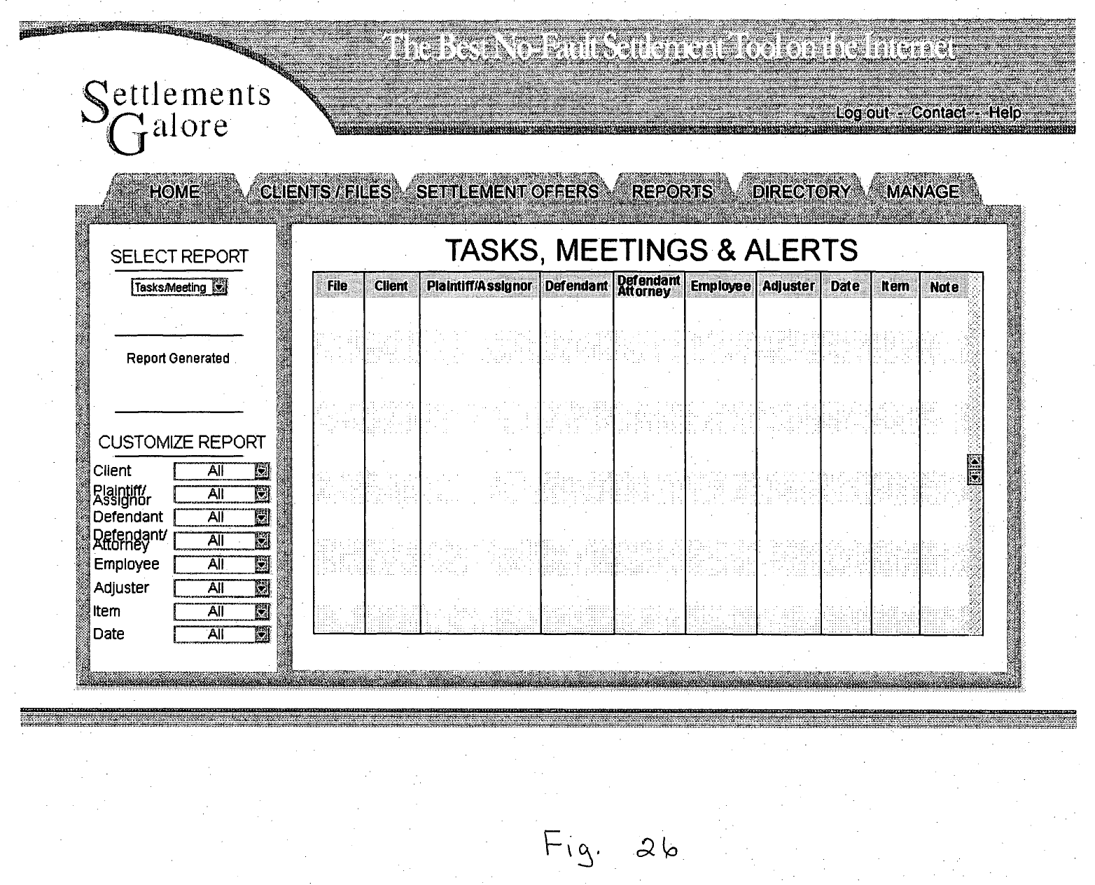

FIG. 26 (S8) illustrates an embodiment of an interface that allows attorneys to view and print-up reports on tasks, meetings & alerts entered by the attorney.

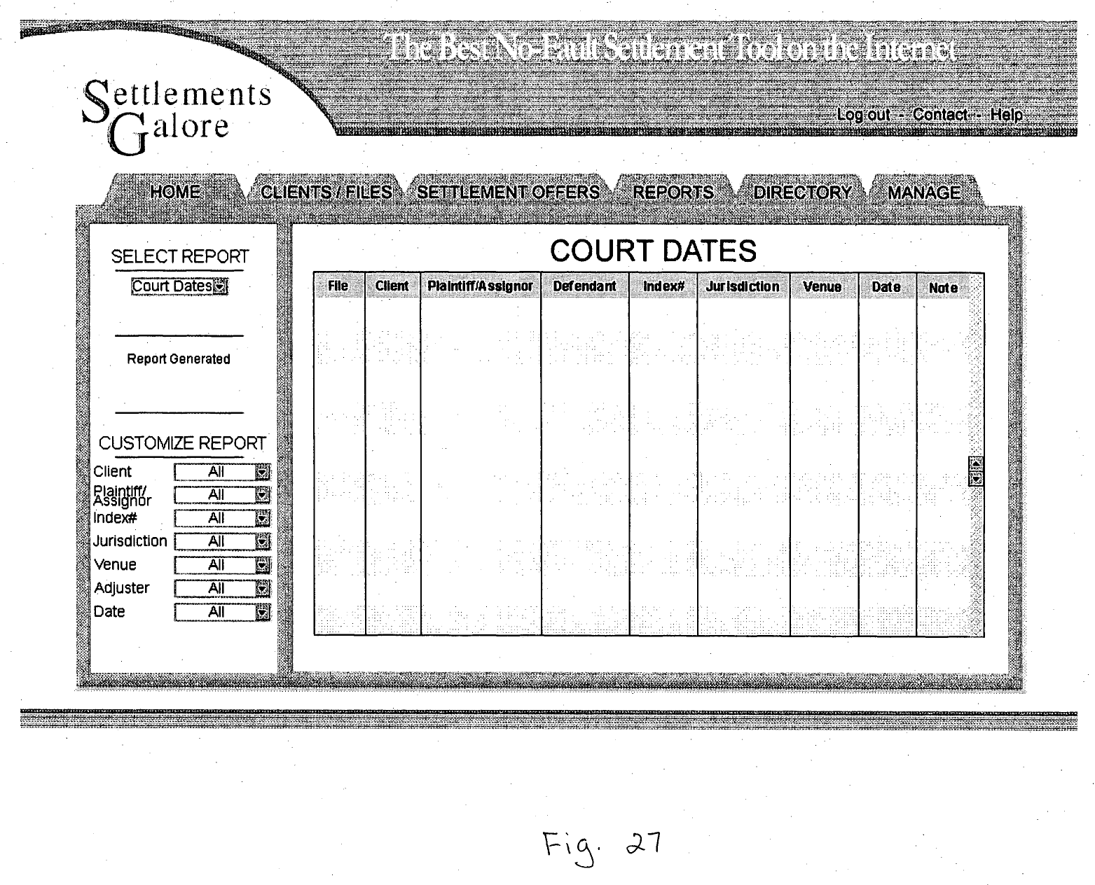

FIG. 27 (S9) illustrates an embodiment of an interface that allows attorneys to view and print-up reports on court dates entered by the attorney or received from a third-party provider maintaining an index number database.

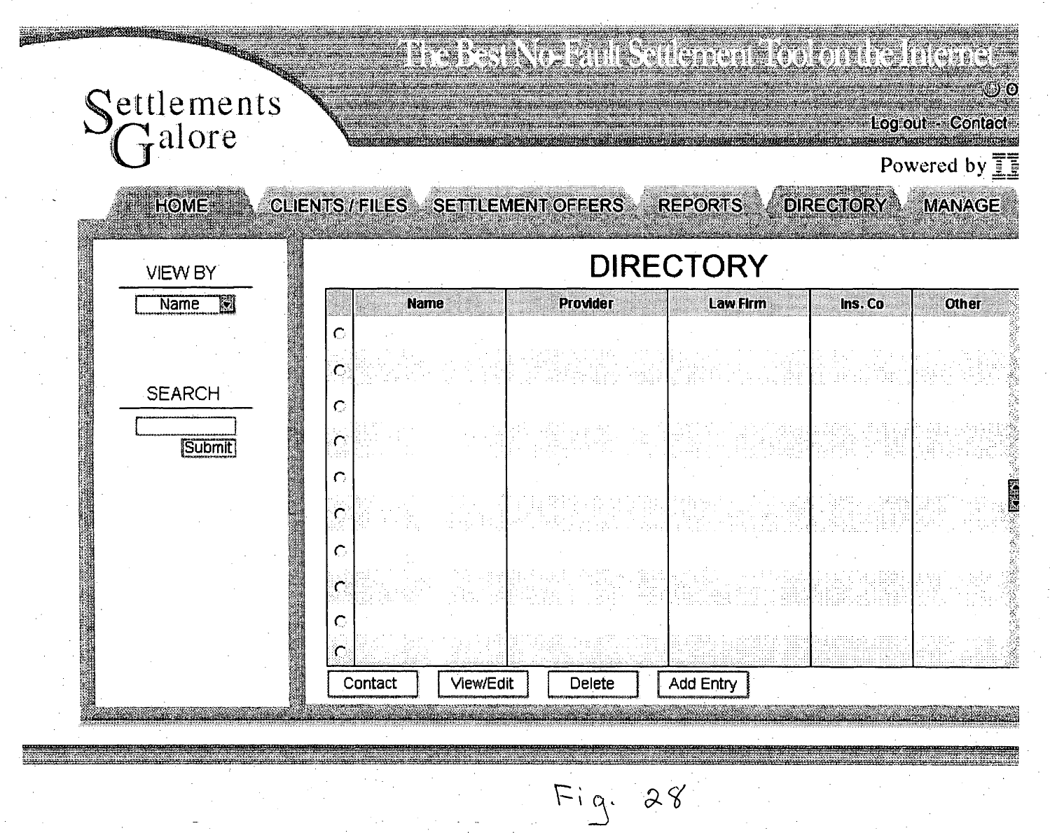

FIG. 28 (S10) illustrates an embodiment of an interface that receives contact information of attorneys and Insurers from multiples attorney modules, consolidates the information and displays it as a directory entry. Also, transmits contact information of attorneys and Insurers to multiple attorney modules.

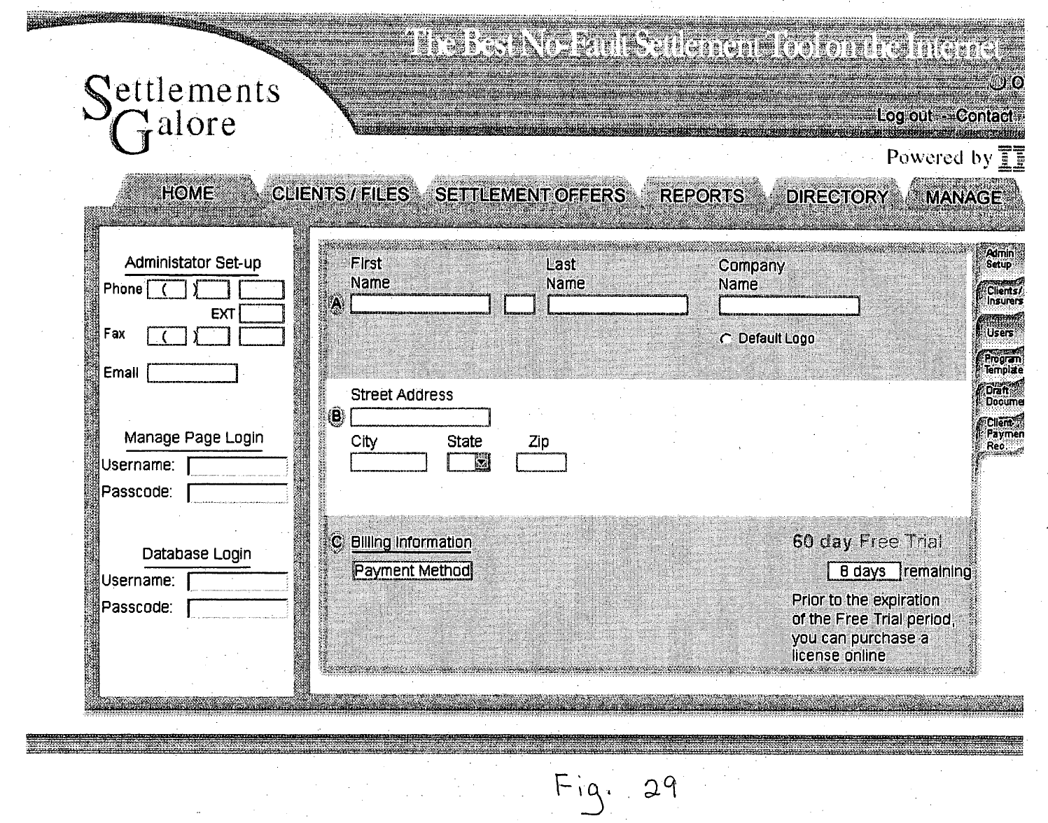

FIG. 29 (S11) illustrates an embodiment of an interface that allows the entry of Administrator information, username and passcodes to access the attorney module and to gain access to the Manage page, which controls the administration functions of the program. Including allowing attorneys to send payment for licensing, web hosting and maintenance services pertaining to the system.

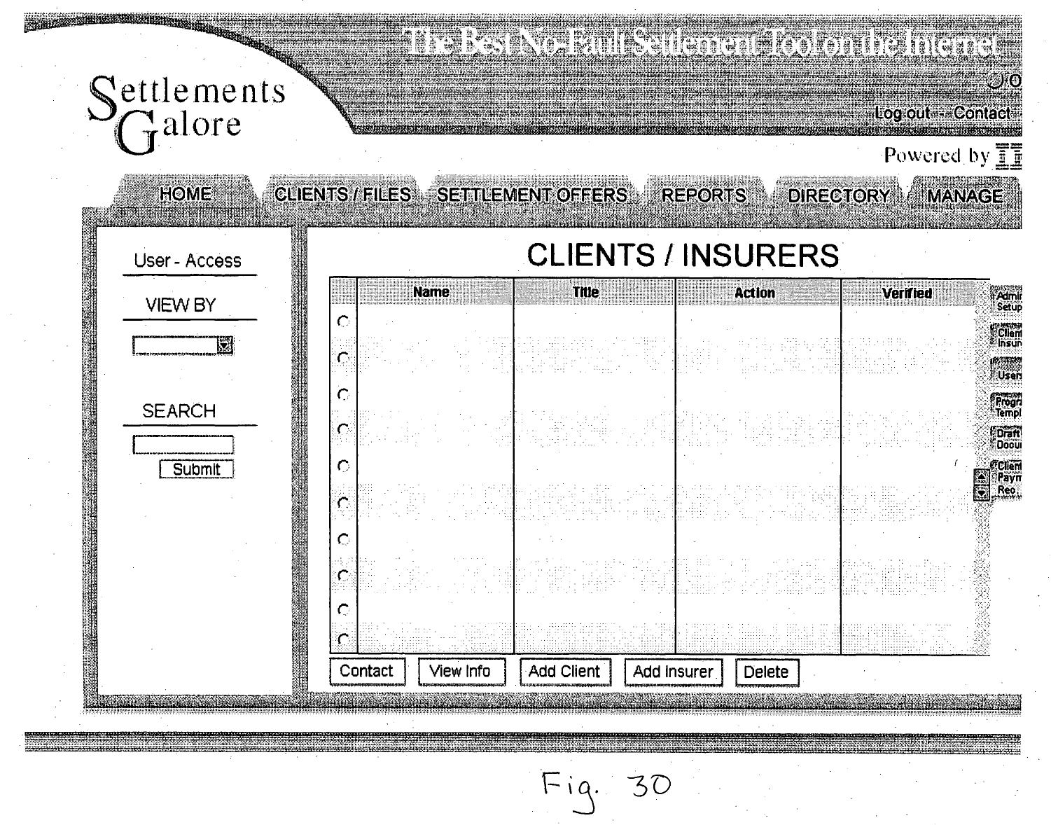

FIG. 30 (S12) illustrates an embodiment of an interface that allows the entry of information of Insurers and clients, which the attorney module utilizes in drafting documents and creating a client username and passcode to allow the client to gain access to the client module.

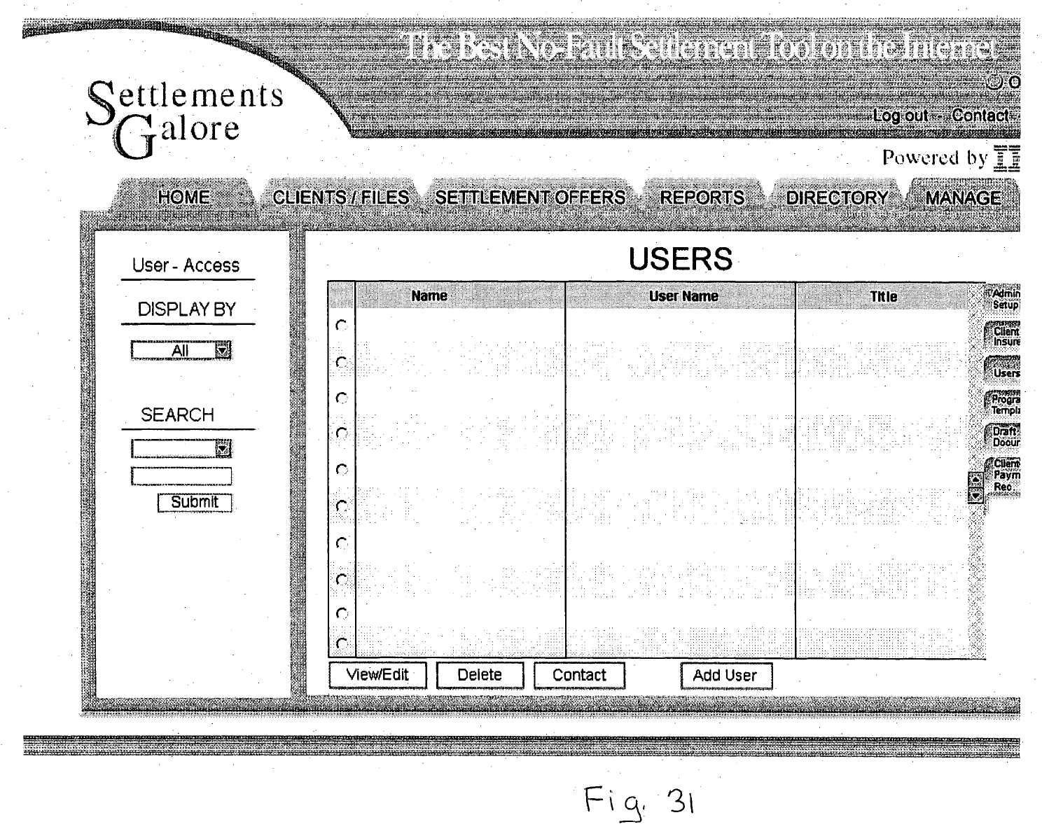

FIG. 31 (S13) illustrates an embodiment of an interface that allows the entry of users to access the attorney module. For example, attorneys, paralegals, clerks, third-parties, administrator, etc.

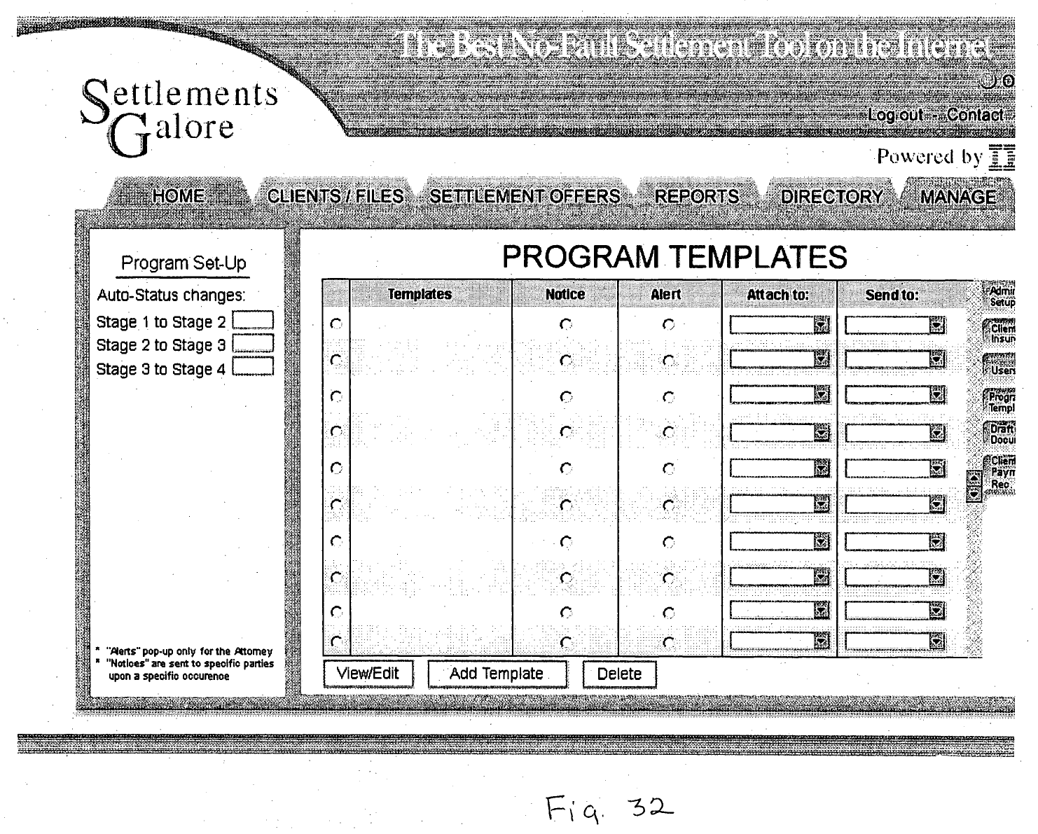

FIG. 32 (S14) illustrates an embodiment of an interface that allows the entry templates, which are utilized by the attorney module for drafting documents, and to schedule the automation of drafting document.

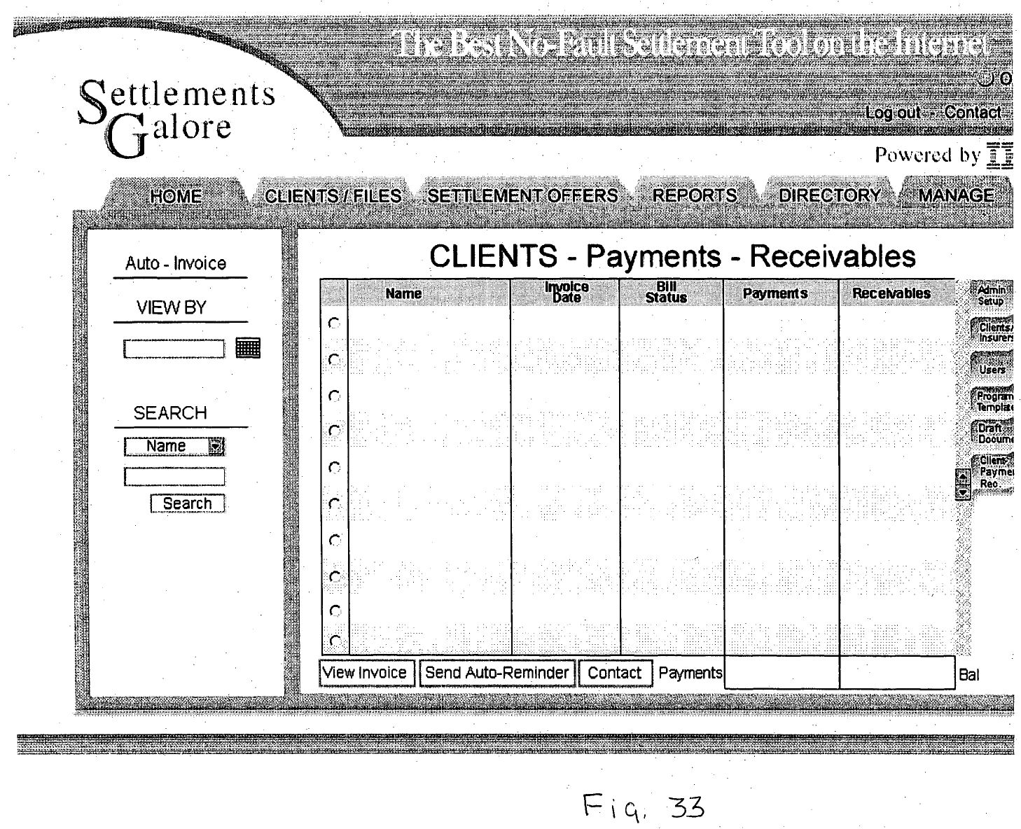

FIG. 33 (S15) illustrates an embodiment of an interface that allows the entry of client bills and receiving of electronic payments.

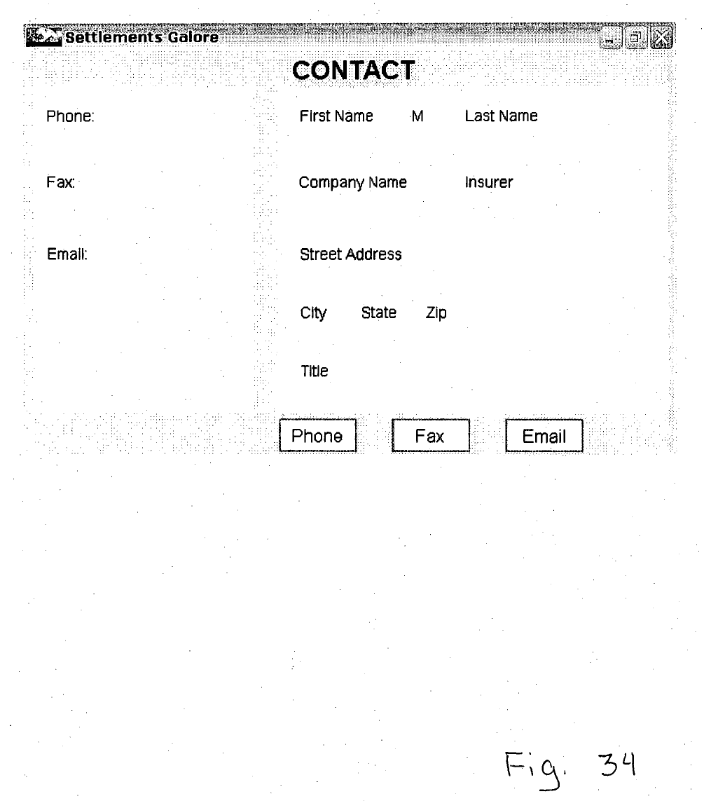

FIG. 34 (S16) illustrates an embodiment of an interface that allows attorneys to utilize phone, fax or email to contact a client or opposing party.

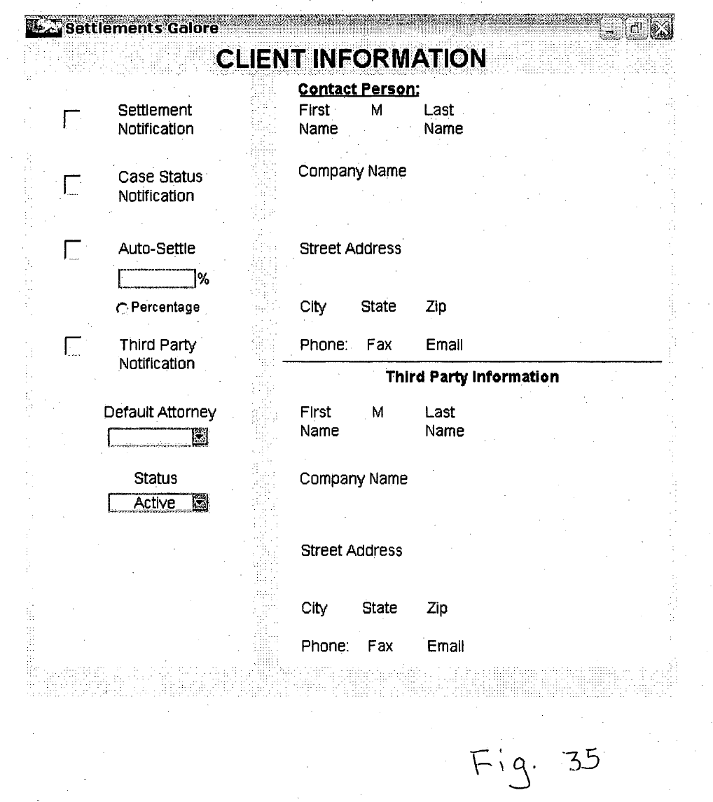

FIG. 35 (S17) illustrates an embodiment of an interface that displays client information and preferences.

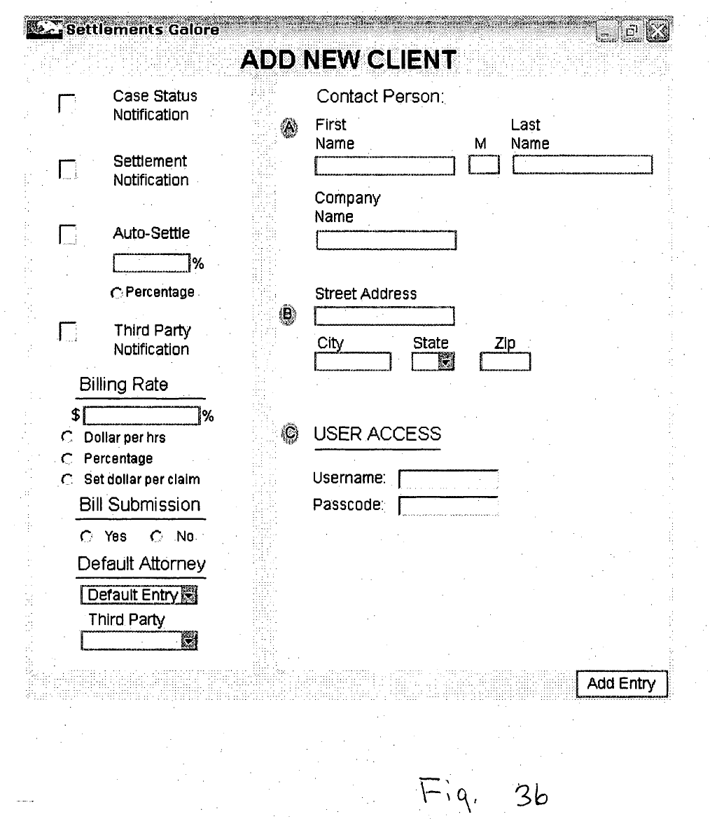

FIG. 36 (S18) illustrates an embodiment of an interface that allows the entry of client and third-party information and preferences as to automated notices and the lowest acceptable percentage on settlements, which the attorney module utilizes to accept, decline or submit a counter-offer on received settlement offers from the central module.

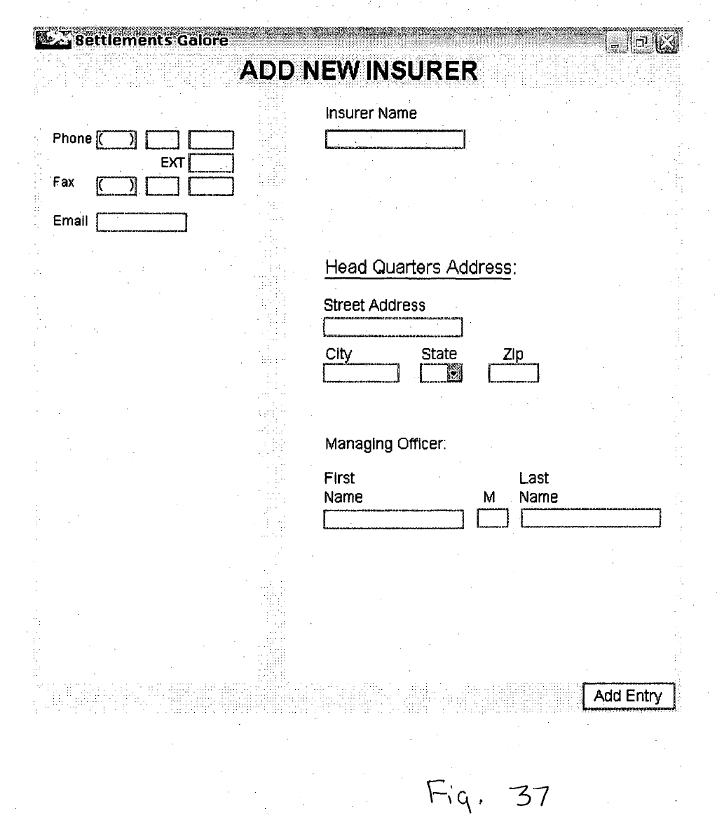

FIG. 37 (S19) illustrates an embodiment of an interface that allows the entry of contact information pertaining to Insurance companies.

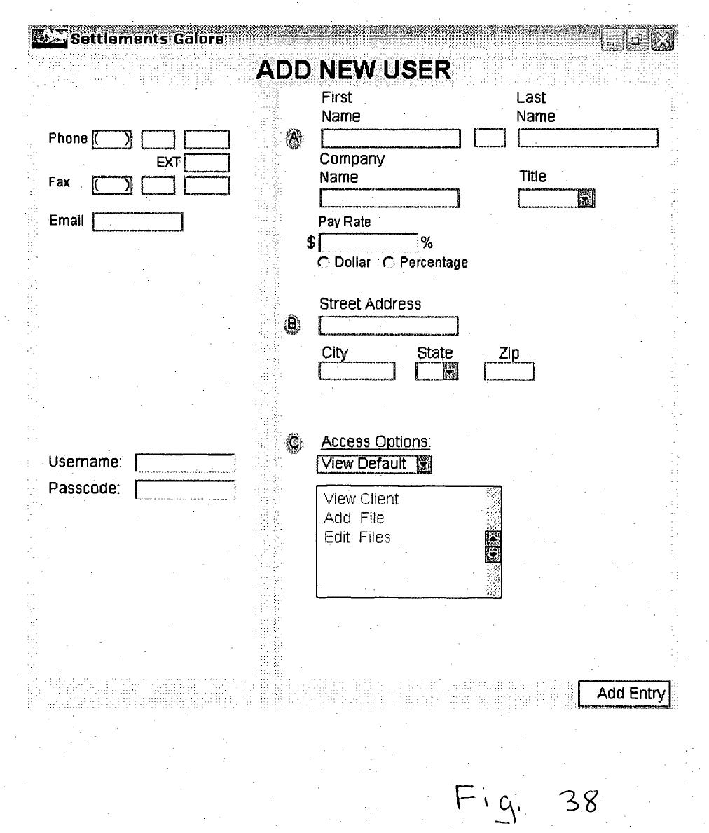

FIG. 38 (S20) illustrates an embodiment of an interface that allows the entry of new users and provides the ability to customize user access.

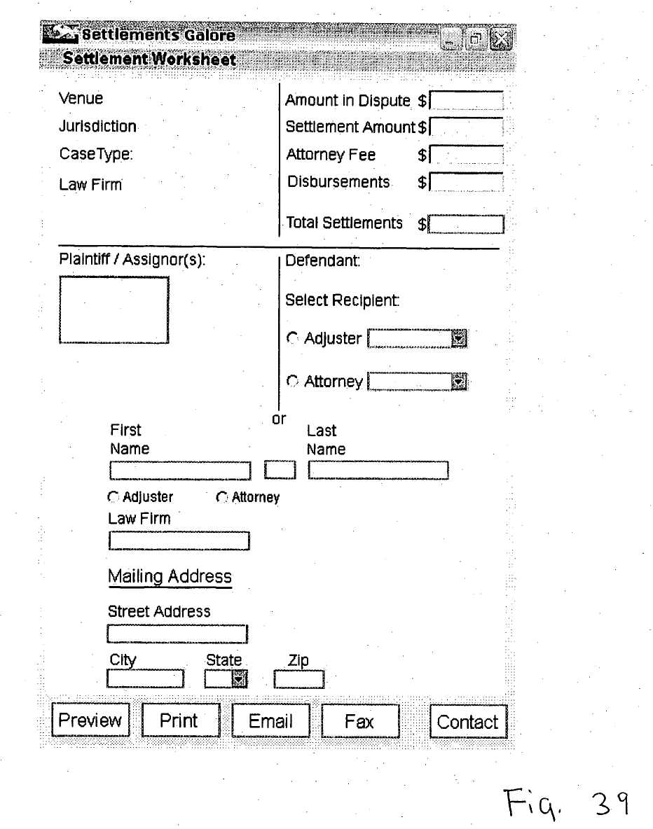

FIG. 39 (S21) illustrates an embodiment of an interface that allows attorneys to manually draft settlement agreements, which can be printed, emailed or faxed to opposing parties from the attorney module.

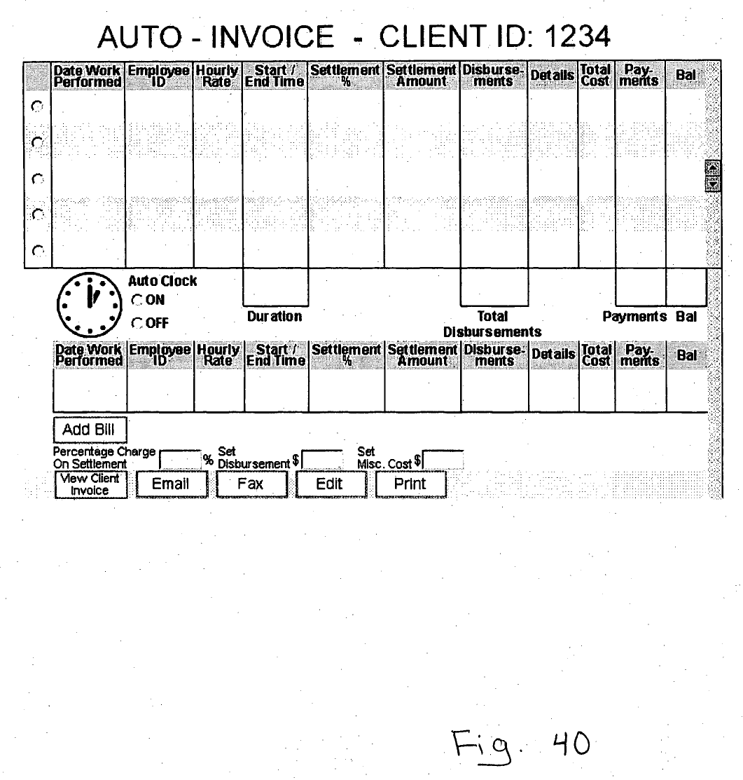

FIG. 40 (S22) illustrates an embodiment of an interface that allows the automated and manual entry of attorney fees, and the subsequent submission of invoices to clients from the attorney module.

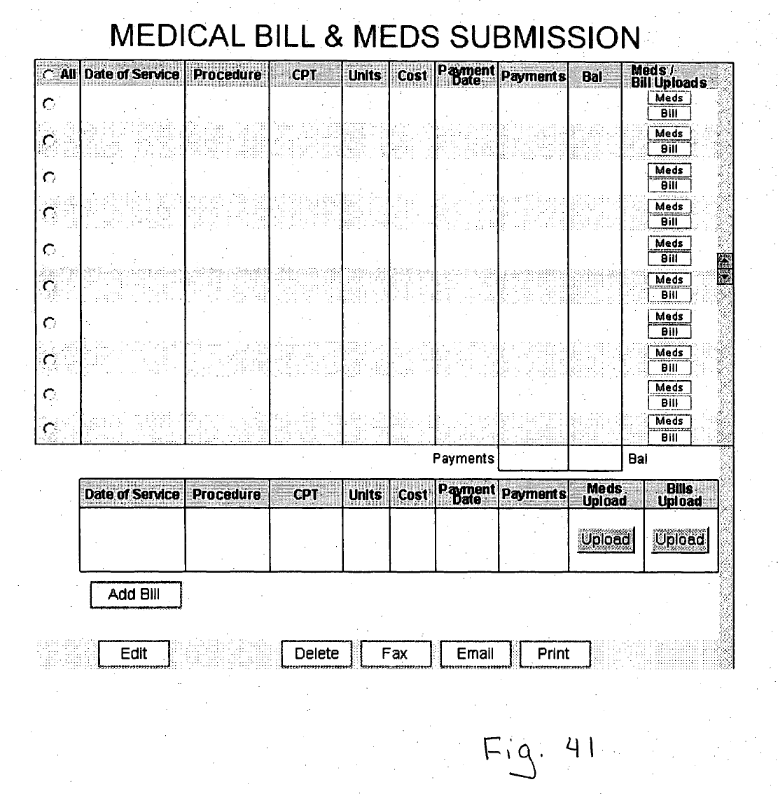

FIG. 41 (S23) illustrates an embodiment of an interface that allows the entry and uploading of medical records and bills and the subsequent submission to opposing parties from the attorney module.

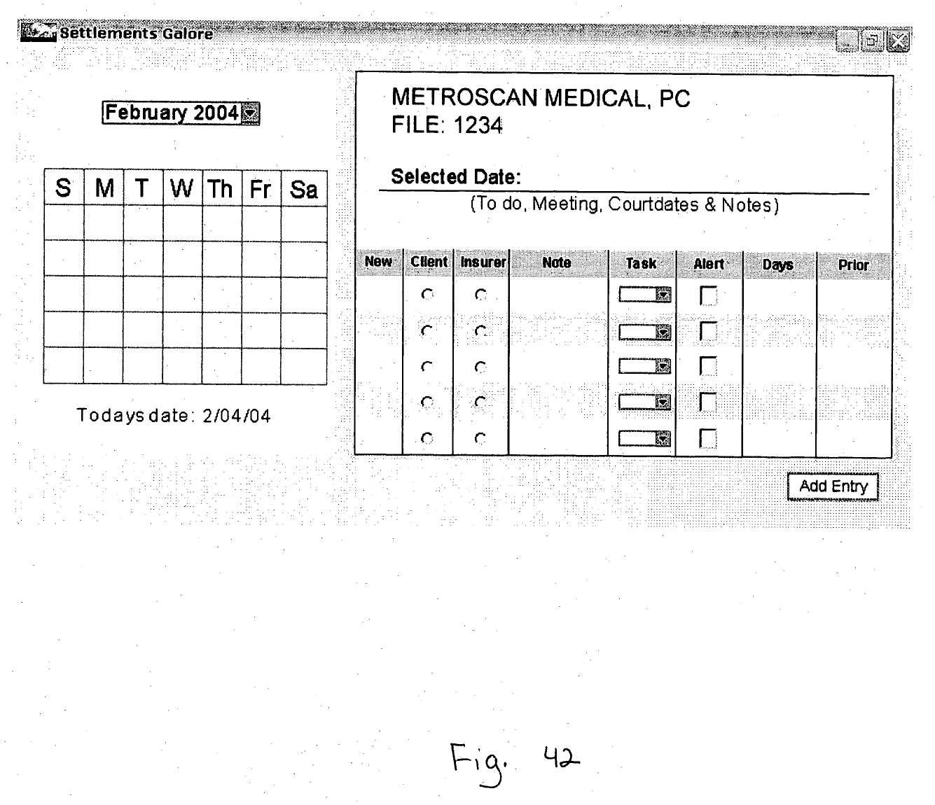

FIG. 42 (S24) illustrates an embodiment of an interface that allows the entry of tasks, meetings and court dates with alerts on the calendar of the attorney module.

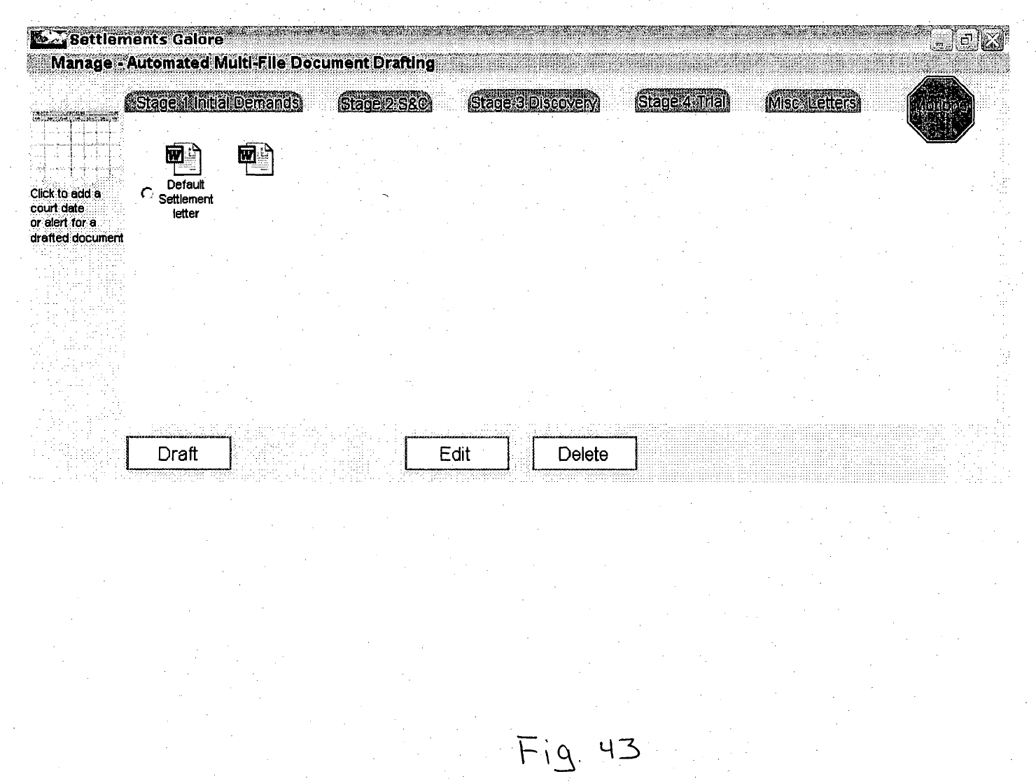

FIG. 43 (S25) illustrates an embodiment of an interface that allows the manual and automated drafting of documents on the attorney module.

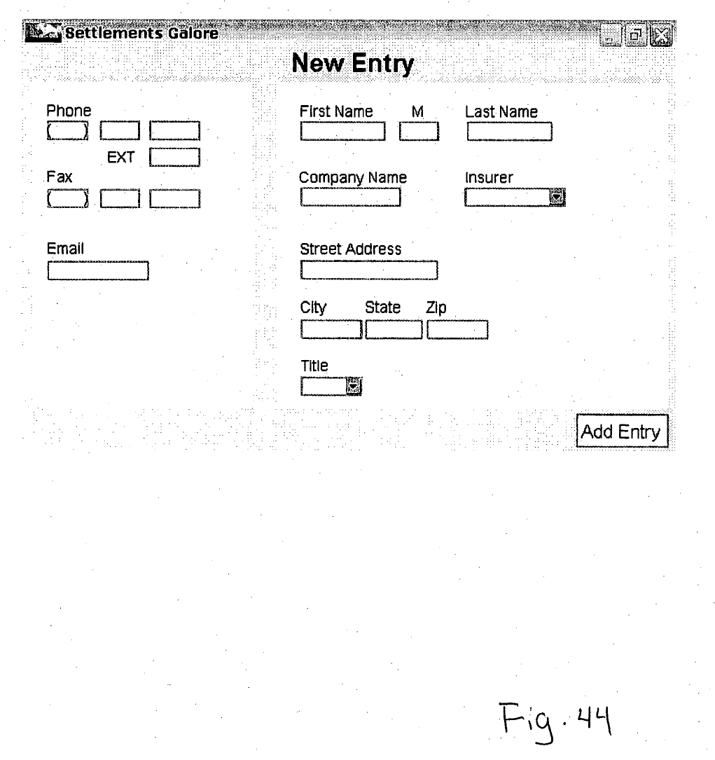

FIG. 44 (S26) illustrates an embodiment of an interface that allows the entry of contact information on the directory of the attorney module.

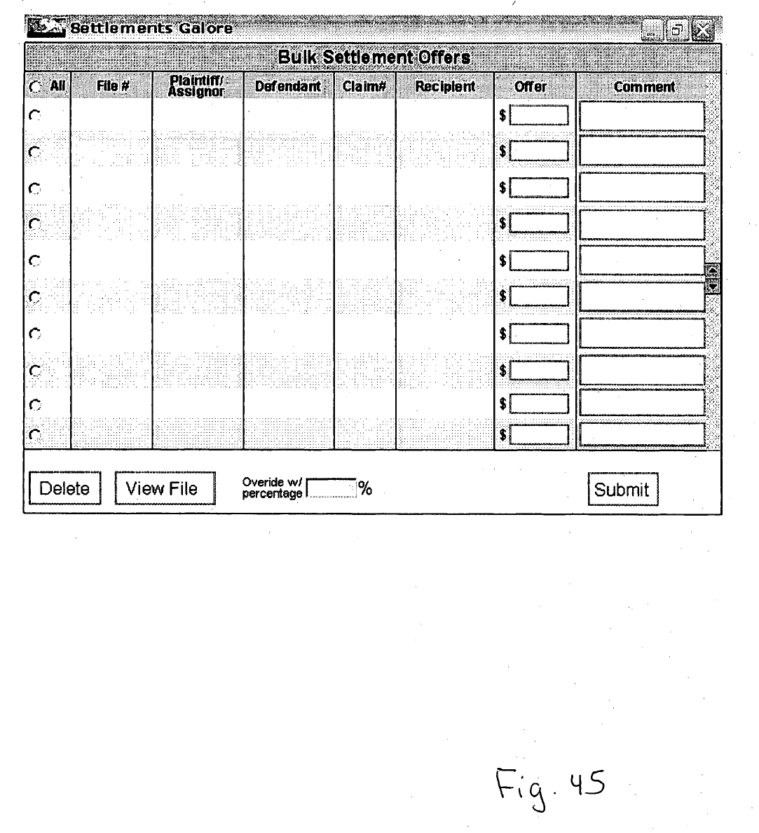

FIG. 45 (S27) illustrates an embodiment of an interface that allows the entry of multiple cases and the subsequent submission of bulk settlement offers to opposing parties from the attorney and central module.

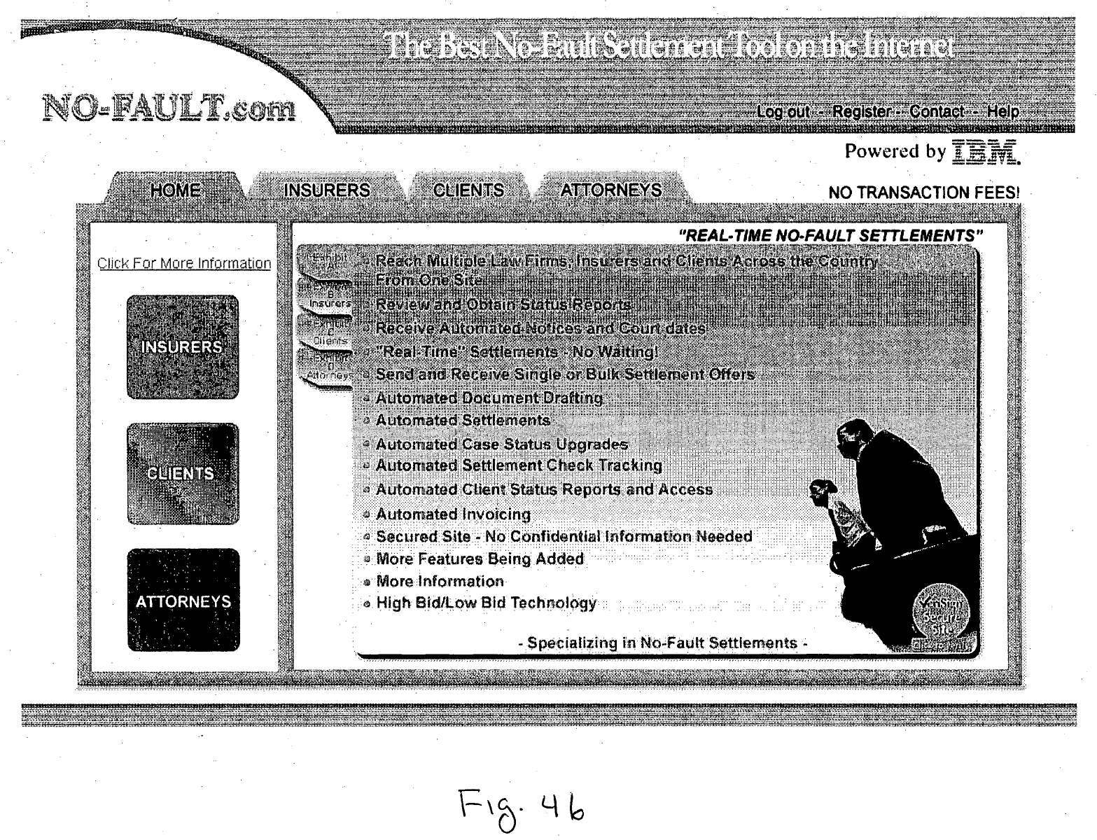

FIGS. 46-70 illustrates various interfaces associated with the client and opposing party modules discussed above.

FIG. 46. (W1) illustrates an embodiment of an interface informing attorneys, clients and opposing parties of the services provided by the system and allows for the login of attorneys, clients and Insurers.

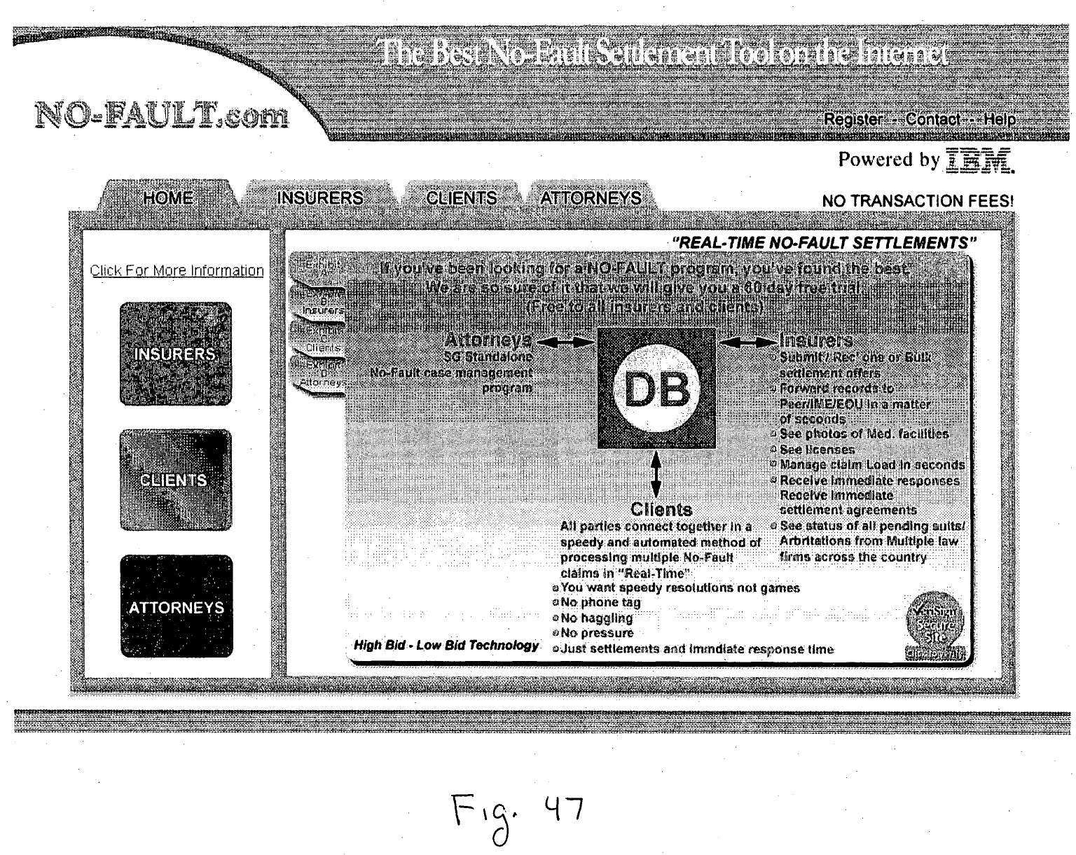

FIG. 47 (W2) illustrates an embodiment of an interface informing attorneys, clients and opposing parties of the services provided by the system.

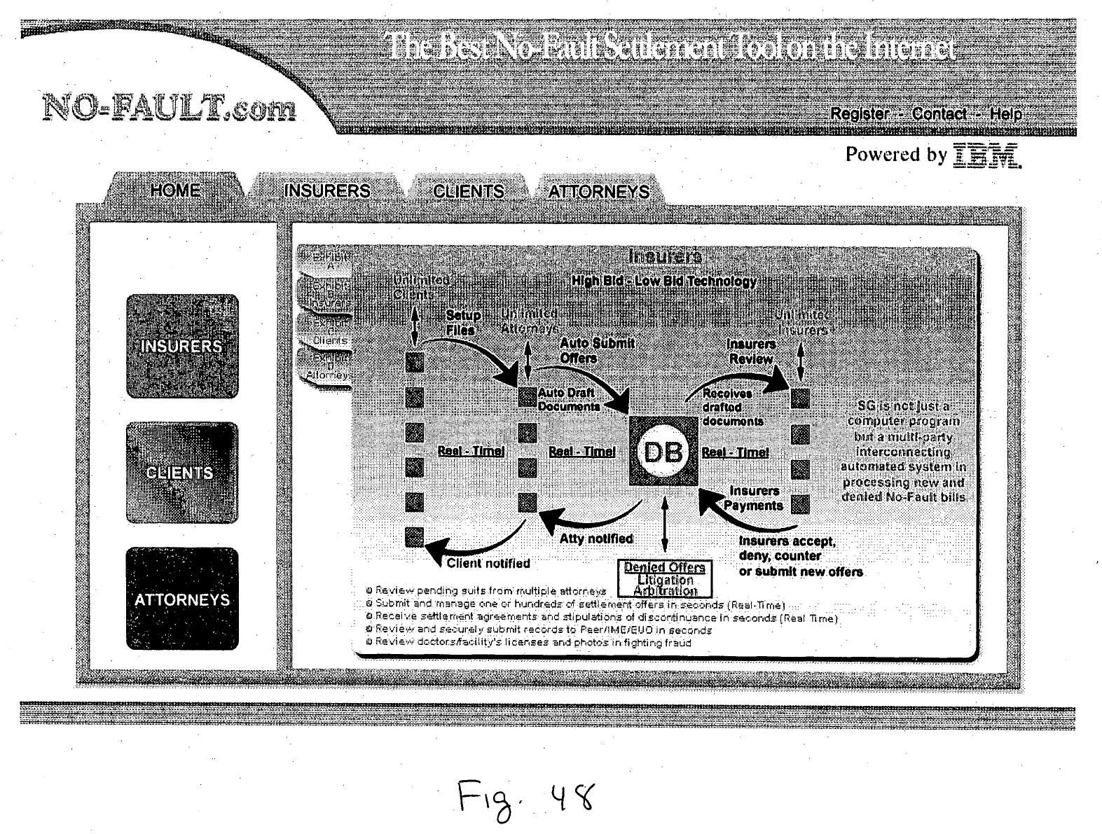

FIG. 48 (W3) illustrates an embodiment of an interface further informing Insurers of the services provided by the system.

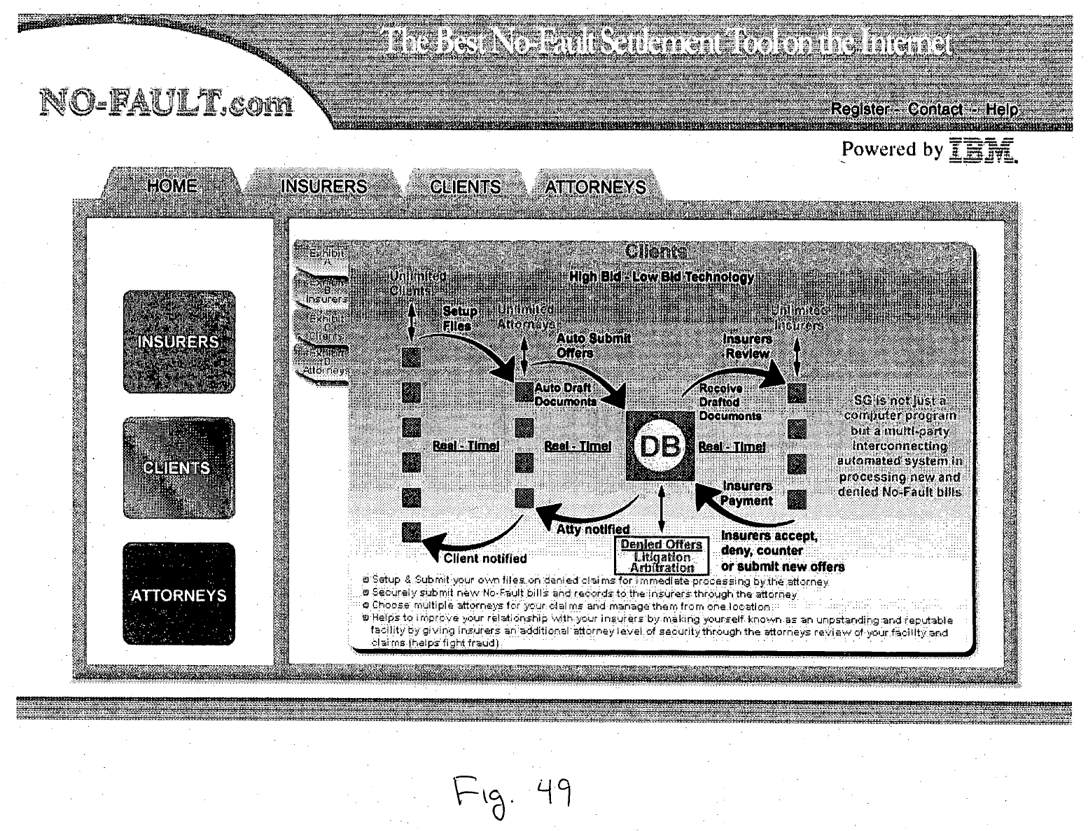

FIG. 49 (W4) illustrates an embodiment of an interface further informing Clients of the services provided by the system.

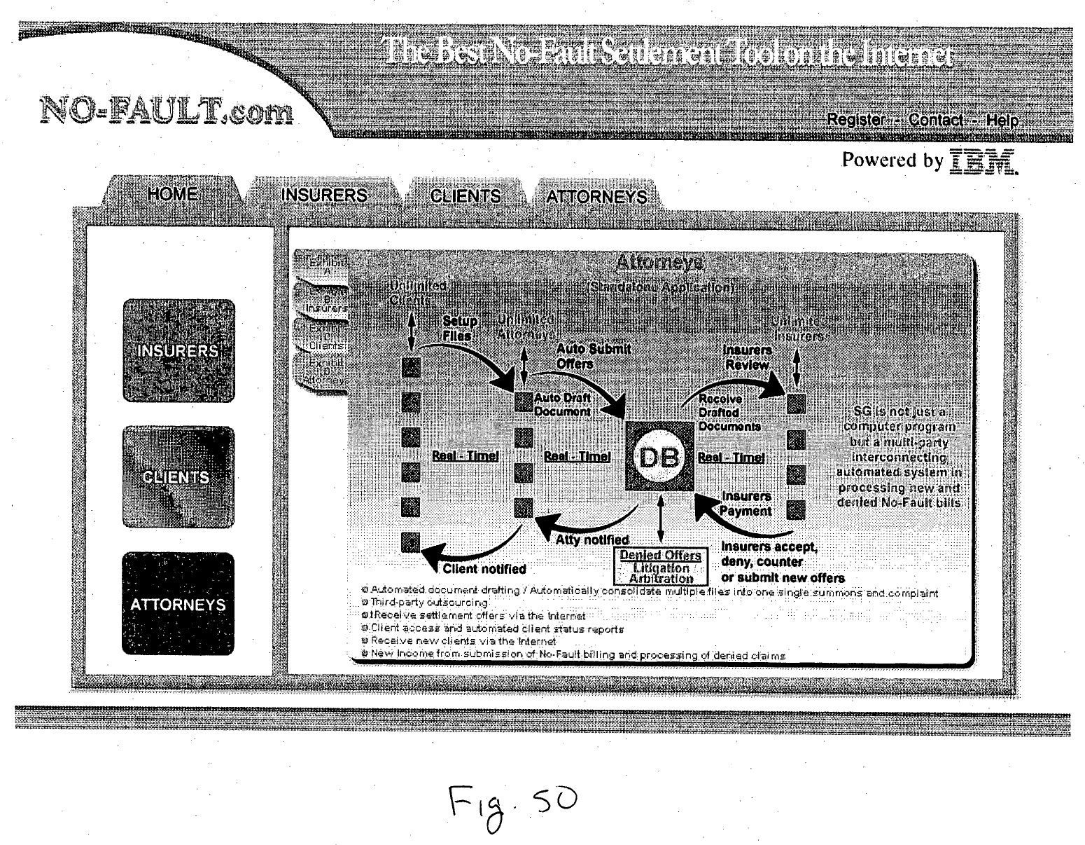

FIG. 50 (W5) illustrates an embodiment of an interface further informing attorneys of the services provided by the system.

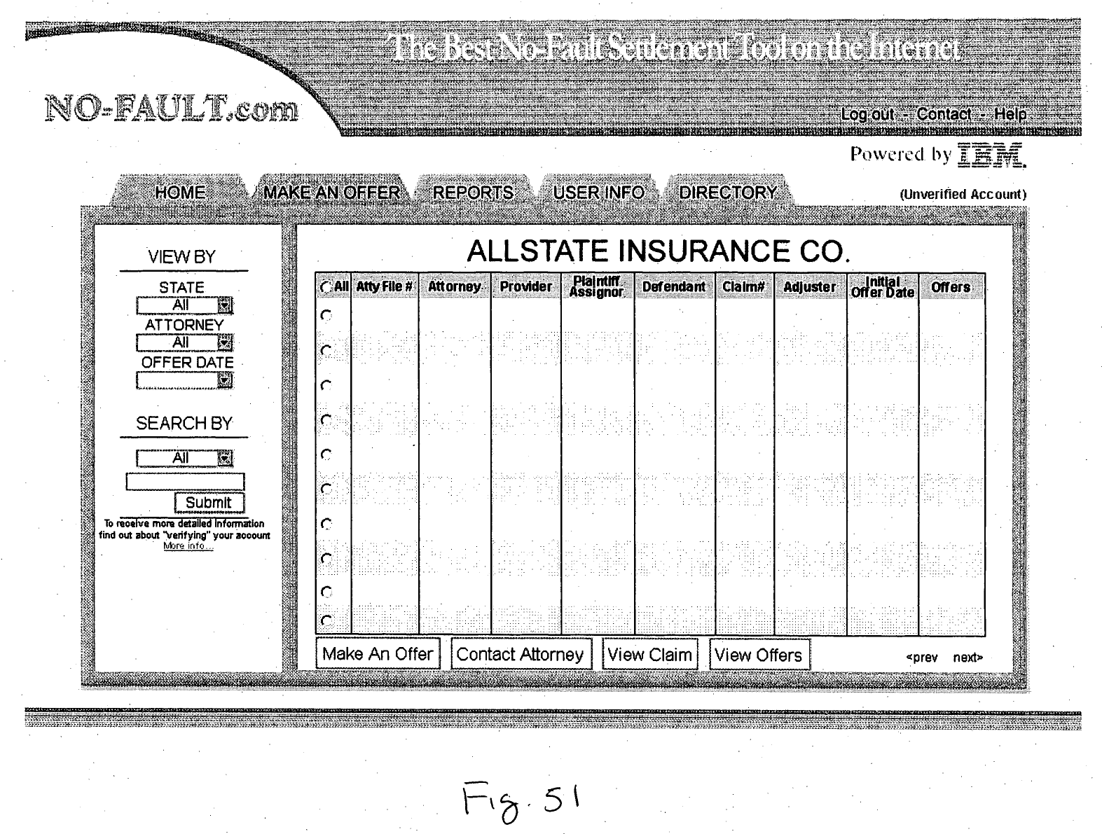

FIG. 51 (W6) illustrates an embodiment of an interface for receiving file data pertaining to pending cases uploaded from multiple attorney and client modules, consolidating the data and displaying it to an opposing Insurer.

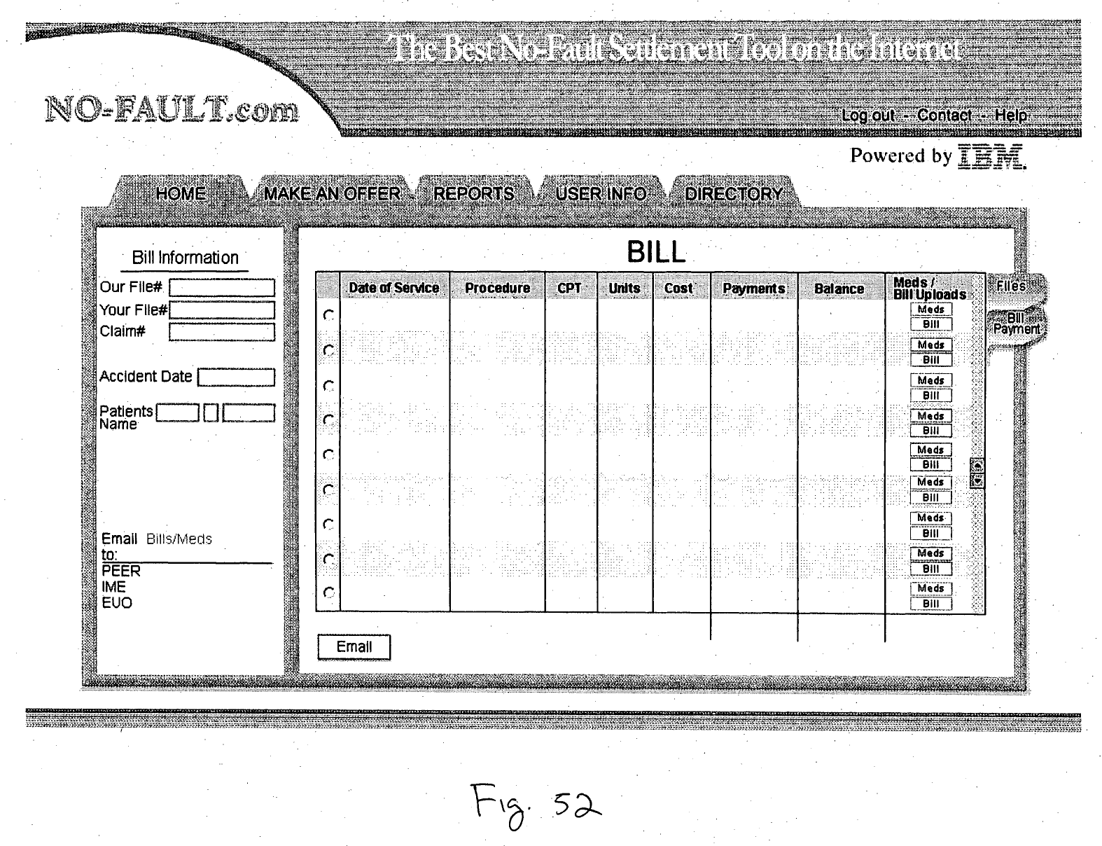

FIG. 52 (W7) illustrates an embodiment of an interface for receiving bill and medical documents uploaded from a client and attorney module.

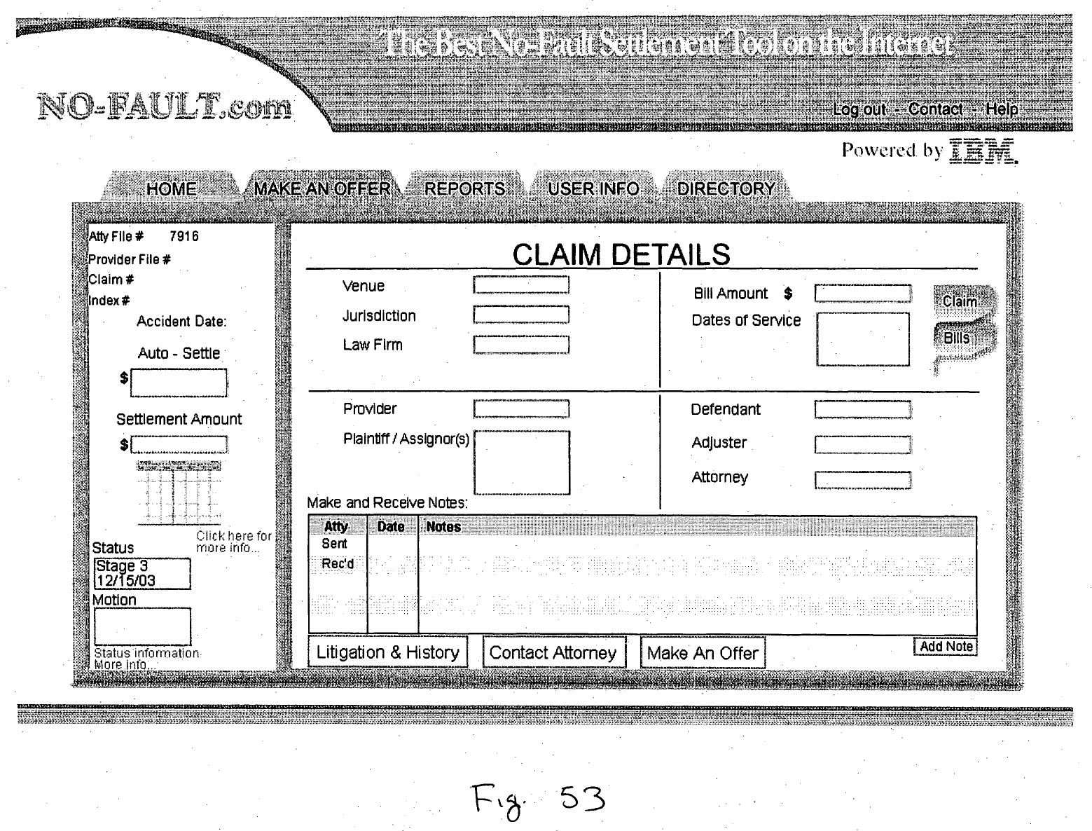

FIG. 53 (W8) illustrates an embodiment of an interface displaying specific case data uploaded from a client and attorney module. Including the displaying of notes entered by the attorneys and Insurers on the file.

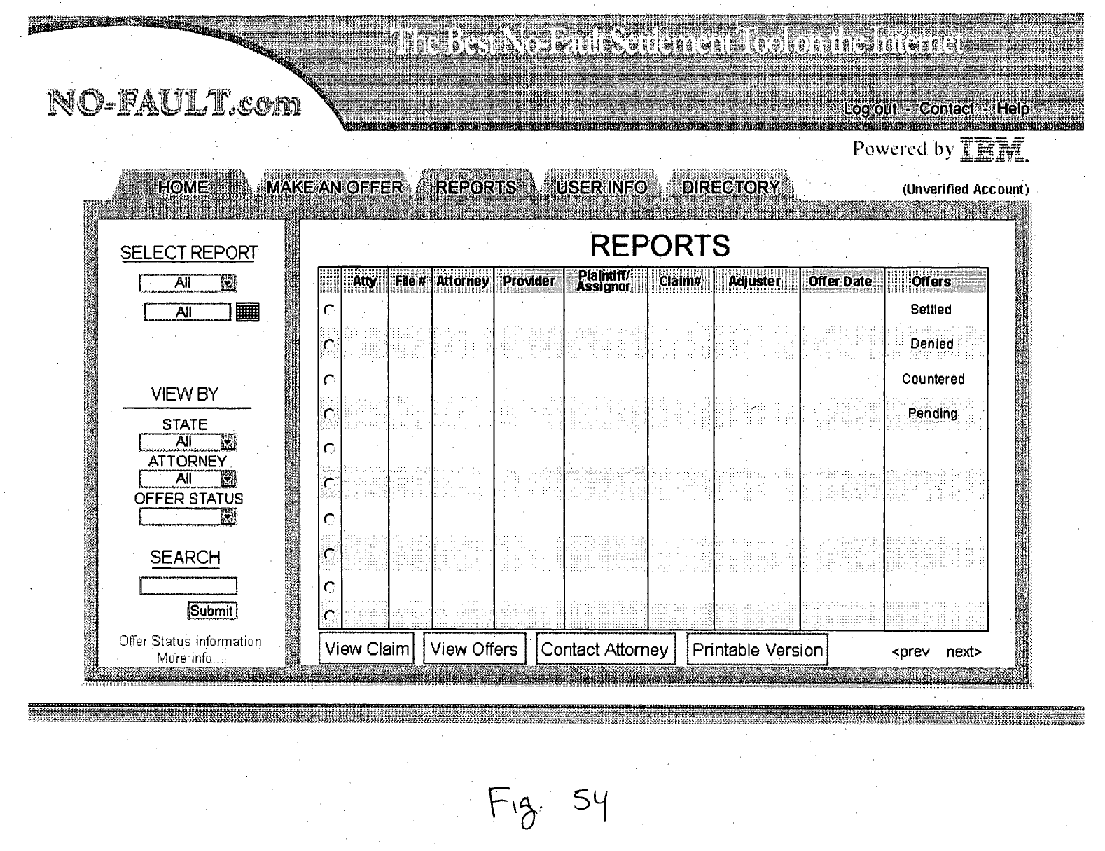

FIG. 54 (W9) illustrates an embodiment of an interface that allows Insurers to customize and print-up reports on cases uploaded from multiple client and attorney modules.

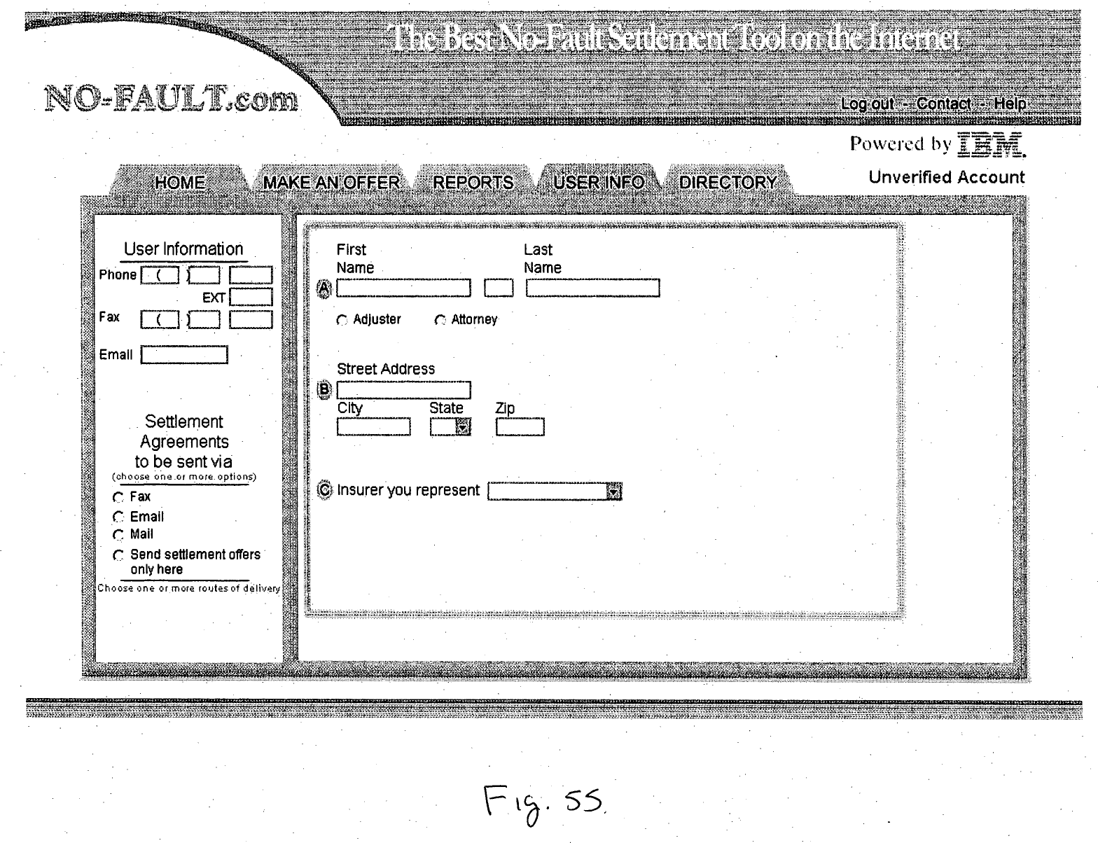

FIG. 55 (W10) illustrates an embodiment of an interface for entering user information and choosing preferences in the delivery route of the settlement agreement.

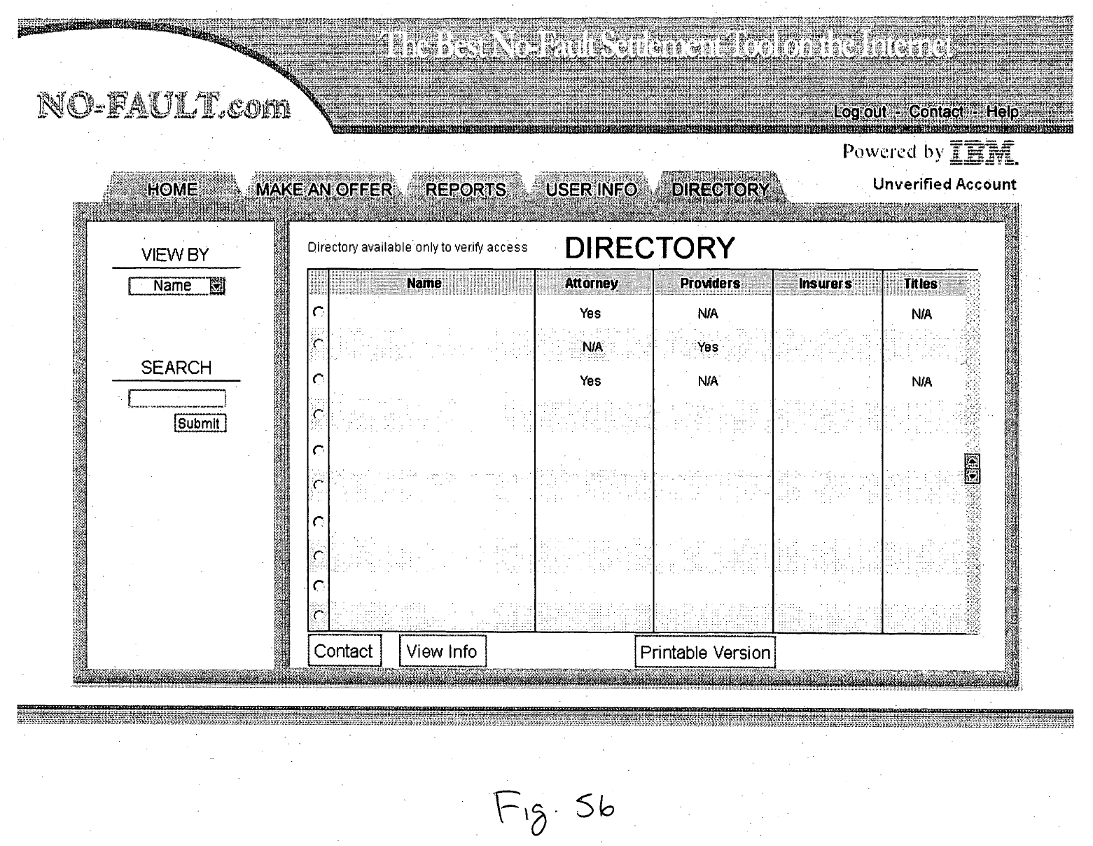

FIG. 56 (W11) illustrates an embodiment of an interface for receiving data uploaded and consolidated from multiple attorney modules in the creation of a comprehensive directory displaying Providers, Insurers and Attorneys contact information to Insurers.

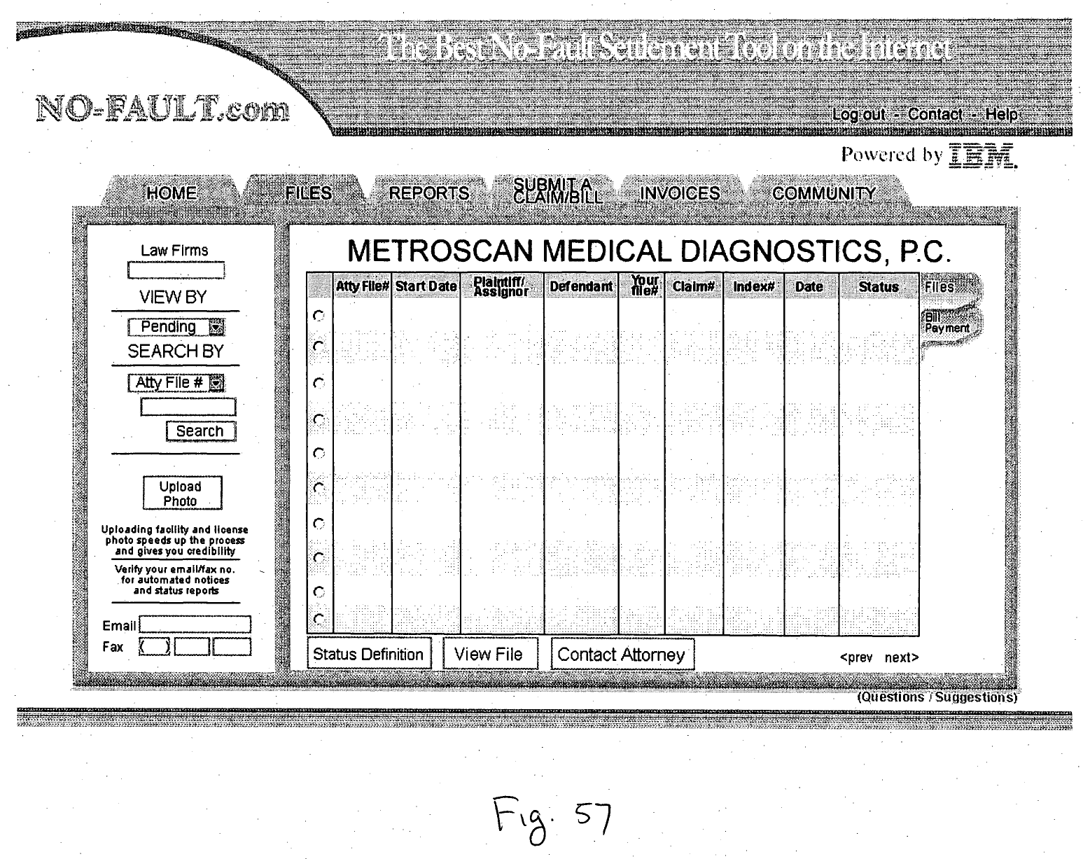

FIG. 57 (W12) illustrates an embodiment of an interface for receiving file data pertaining to a case from an attorney module and displaying it to a client.

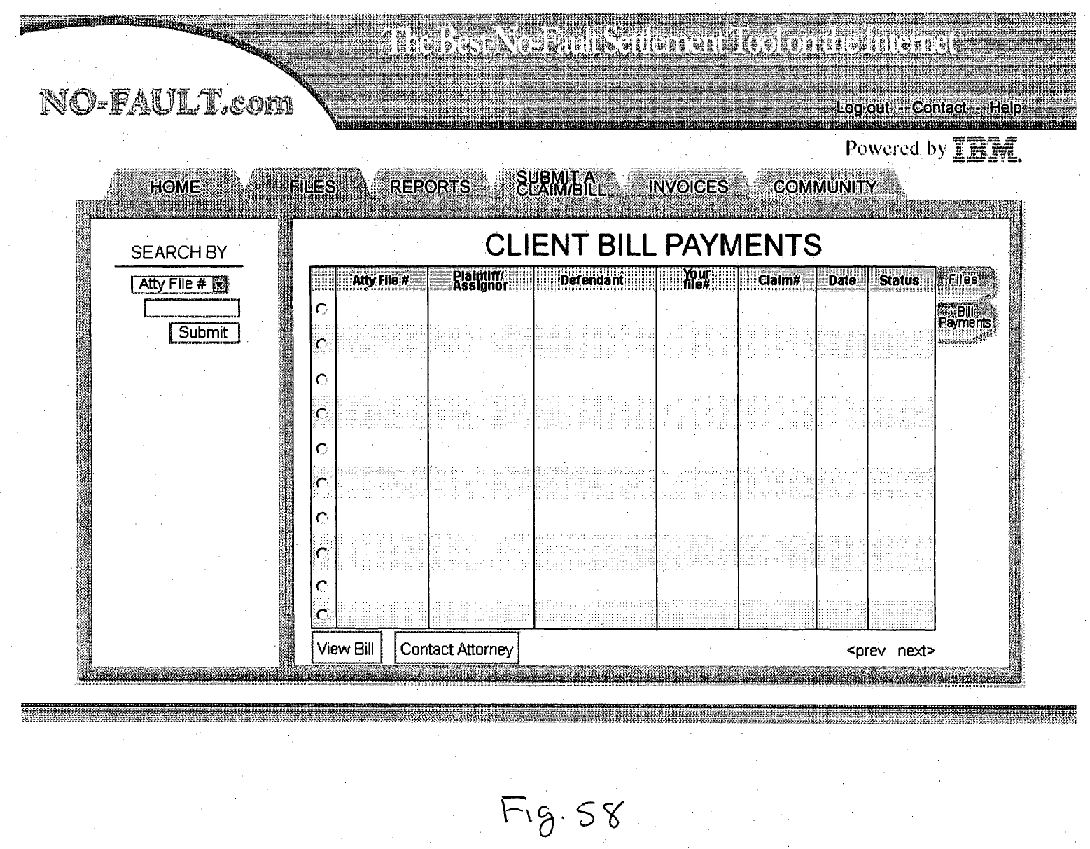

FIG. 58 (W13) illustrates an embodiment of an interface for displaying Insurance claim amounts outstanding and recording receipt of Insurers payments on such claims.

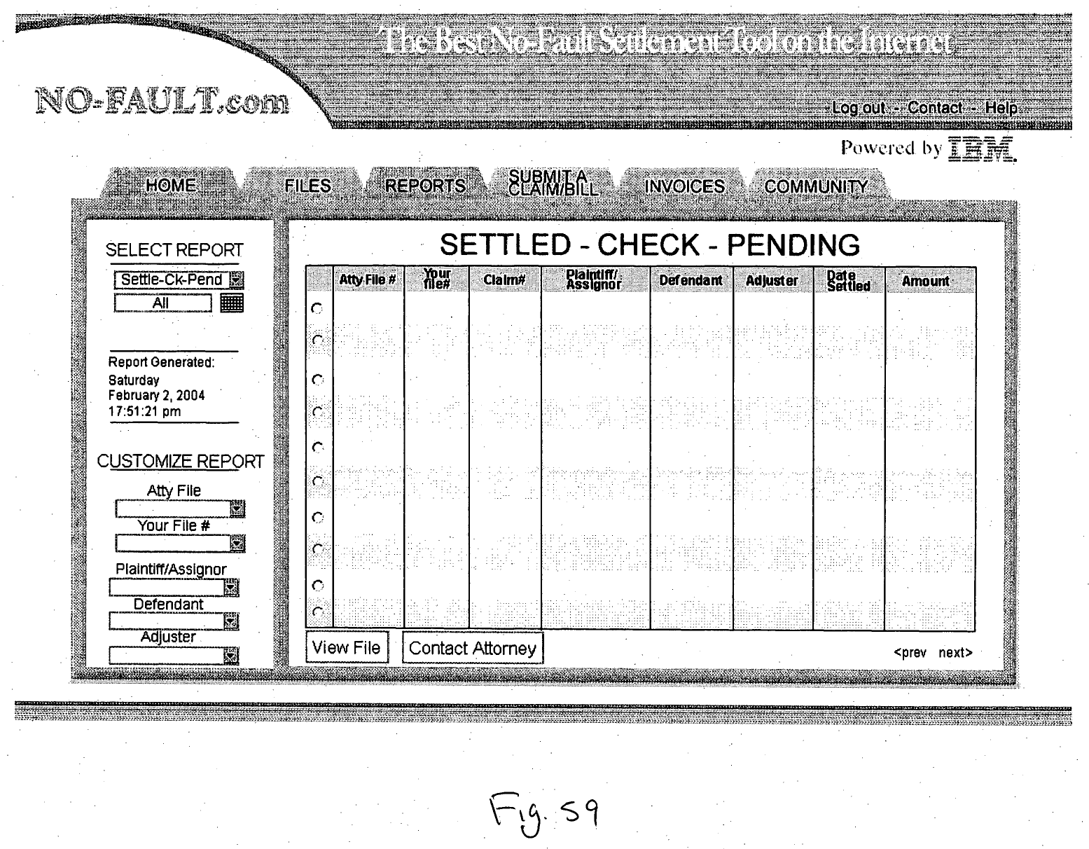

FIG. 59 (W14) illustrates an embodiment of an interface that allows the client to customize and print-up reports on cases uploaded by the client and attorney modules.

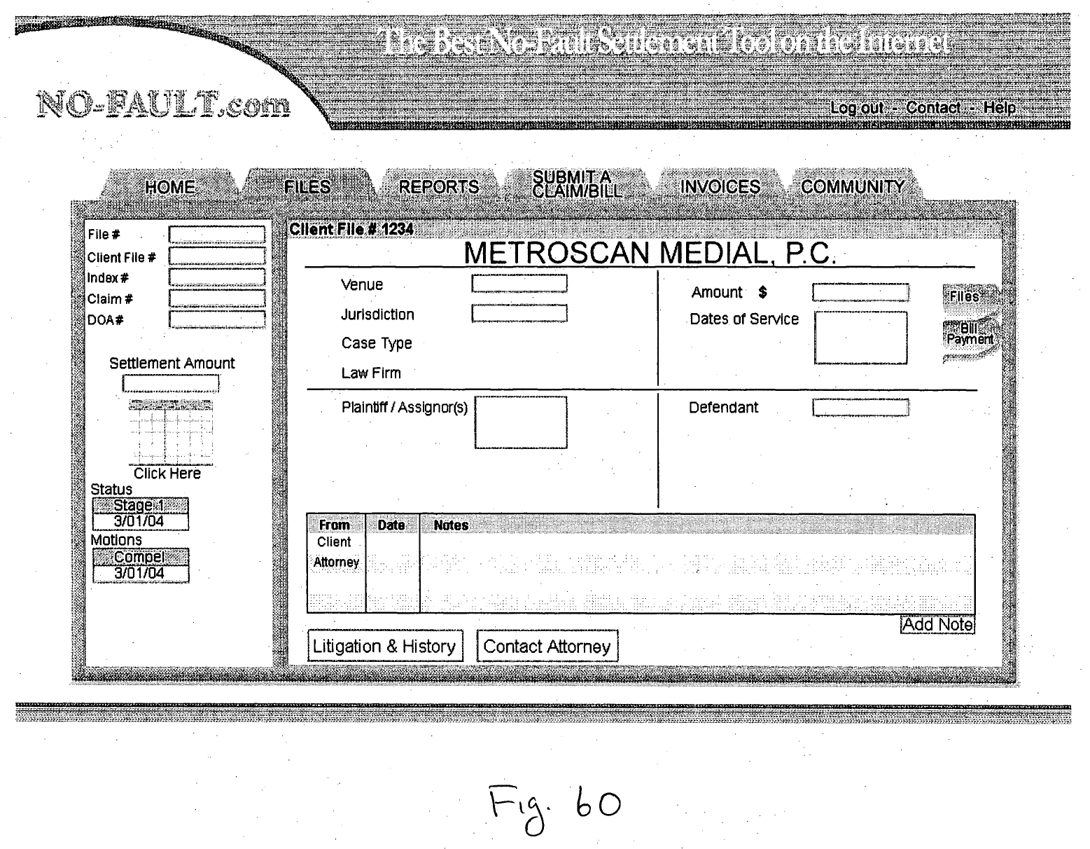

FIG. 60 (W15) illustrates an embodiment of an interface displaying specific case data uploaded from a client and attorney module. Including the displaying of notes entered on the file by attorneys, clients and Insurers.

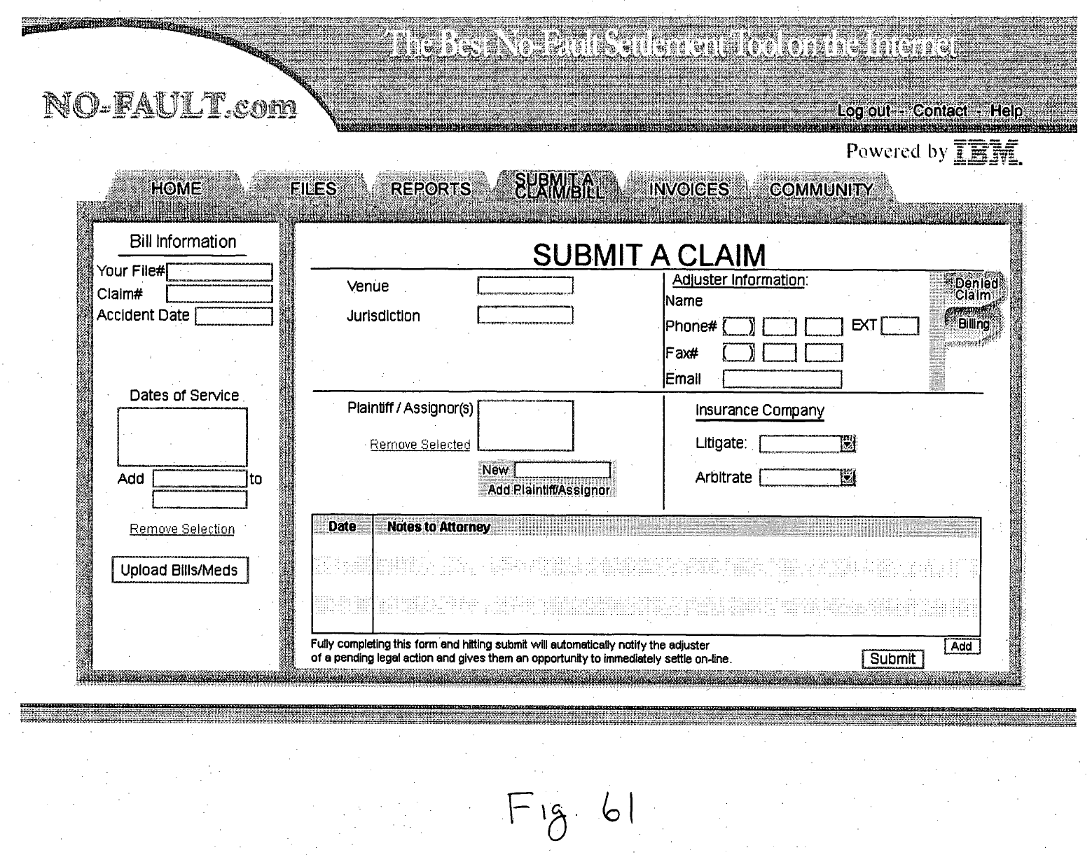

FIG. 61 (W16) illustrates an embodiment of an interface allowing specific case data and documents to be uploaded from a client's module.

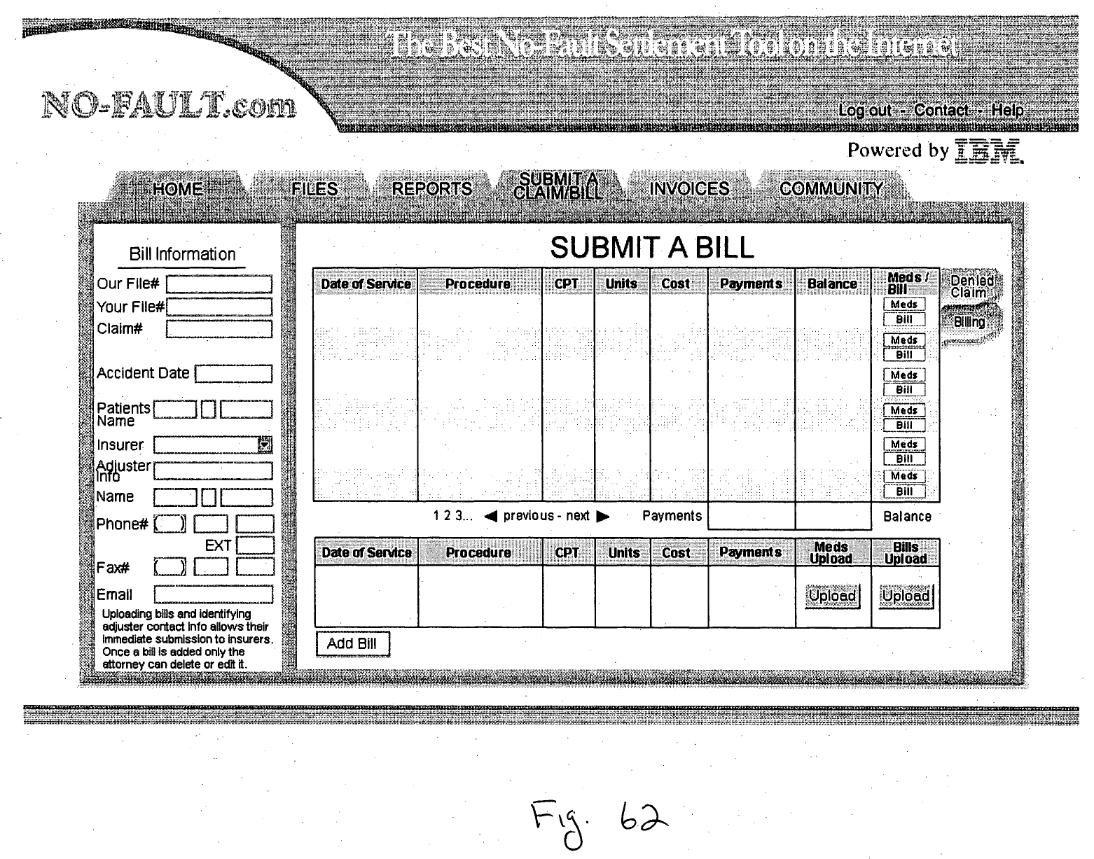

FIG. 62 (W17) illustrates an embodiment of an interface allowing specific case data, medical records and bills to be uploaded from a client's module.

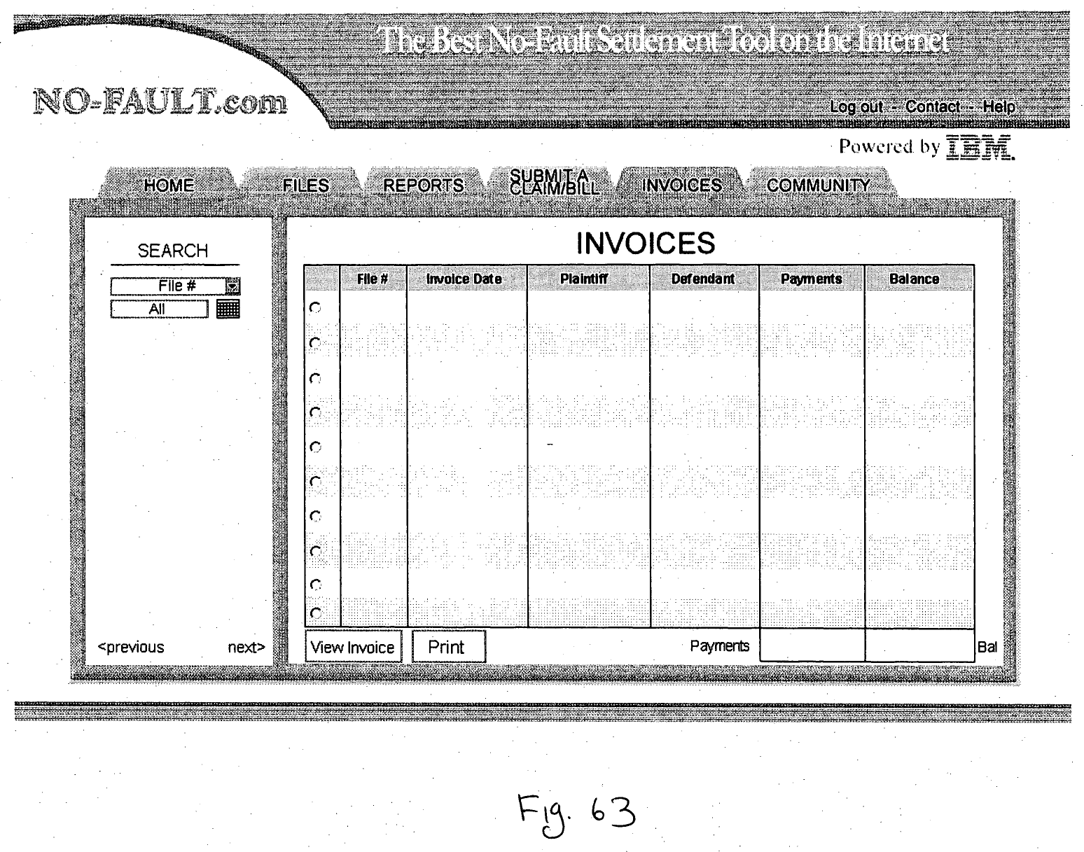

FIG. 63 (W18) illustrates an embodiment of an interface for receiving, displaying and sending electronic payments on attorney invoices from a client's module.

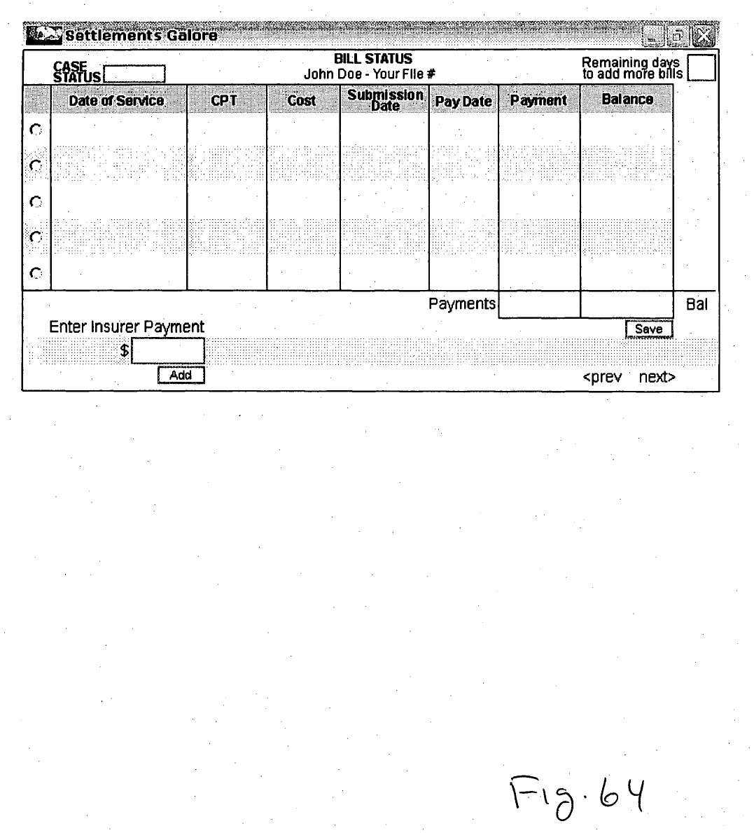

FIG. 64 (W19) illustrates an embodiment of an interface for the displaying of medical bills and entry of insurance payments.

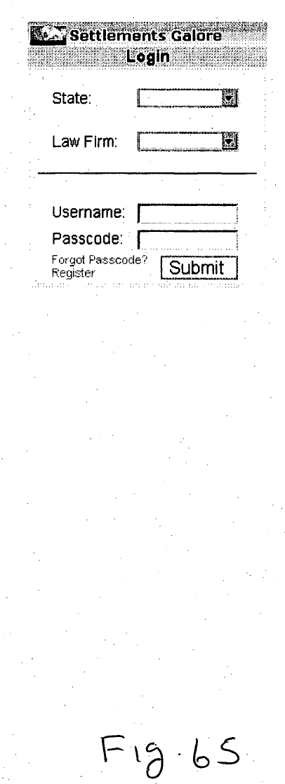

FIG. 65 (W20) illustrates an embodiment of an interface for logging into the client and attorney modules.

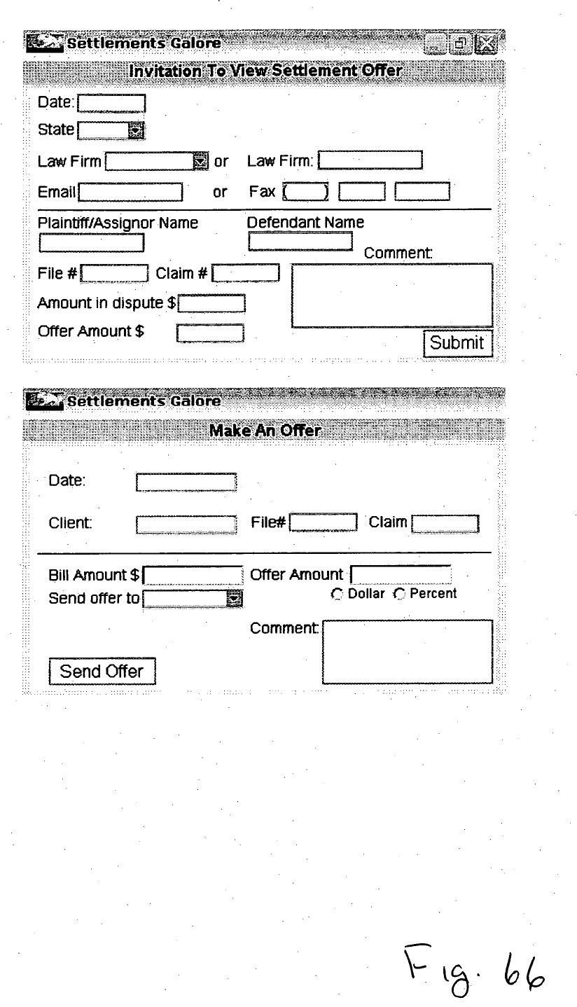

FIG. 66 (W21) illustrates an embodiment of an interface for sending single settlement offers to opposing parties from the attorney and opposing party module.

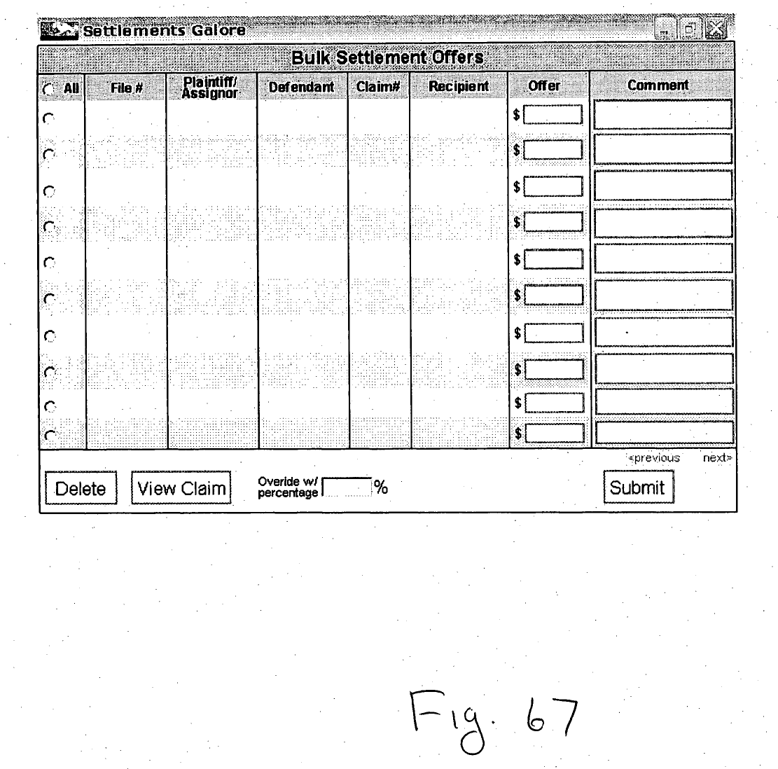

FIG. 67 (W22) illustrates an embodiment of an interface for the sending of bulk settlement offers to opposing parties from the attorney and opposing party modules.

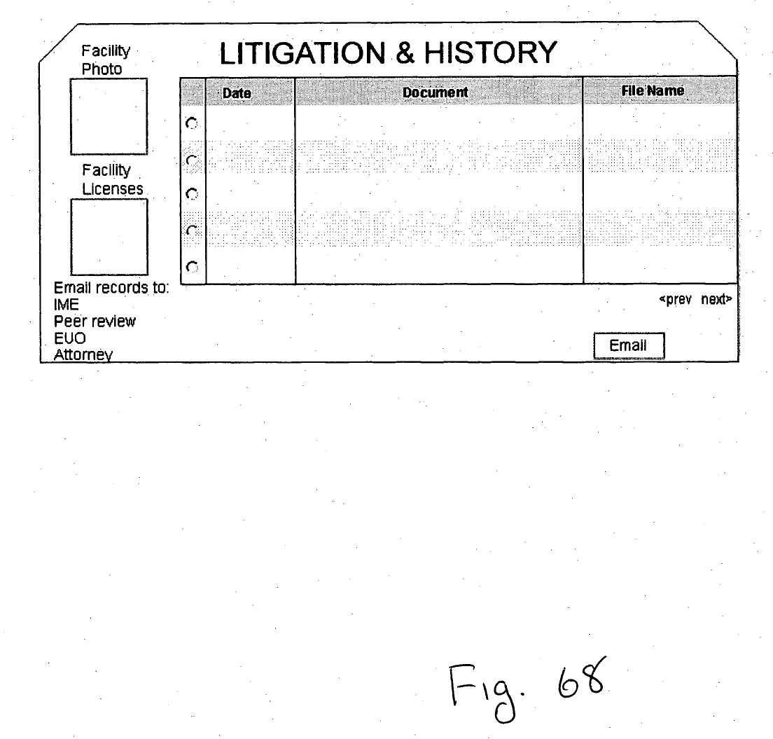

FIG. 68 (W23) illustrates an embodiment of an interface for storing and displaying drafted and uploaded documents from the attorney and client modules.

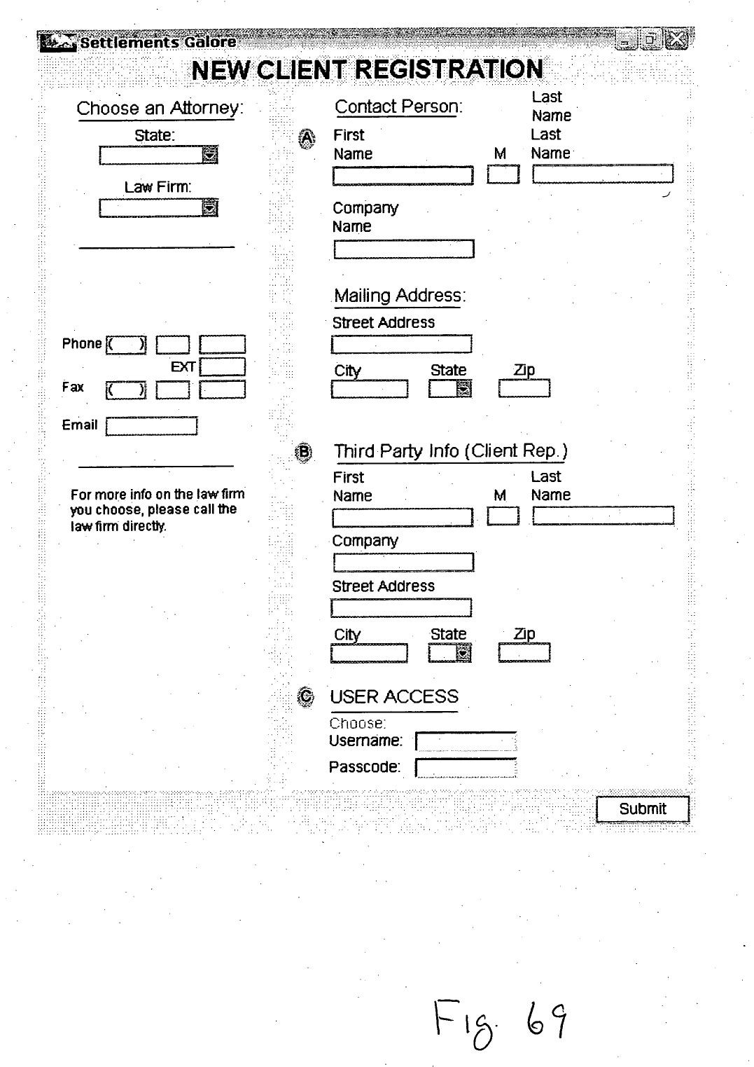

FIG. 69 (W24) illustrates an embodiment of an interface for registering new clients and assigning username and passcode over the Internet.

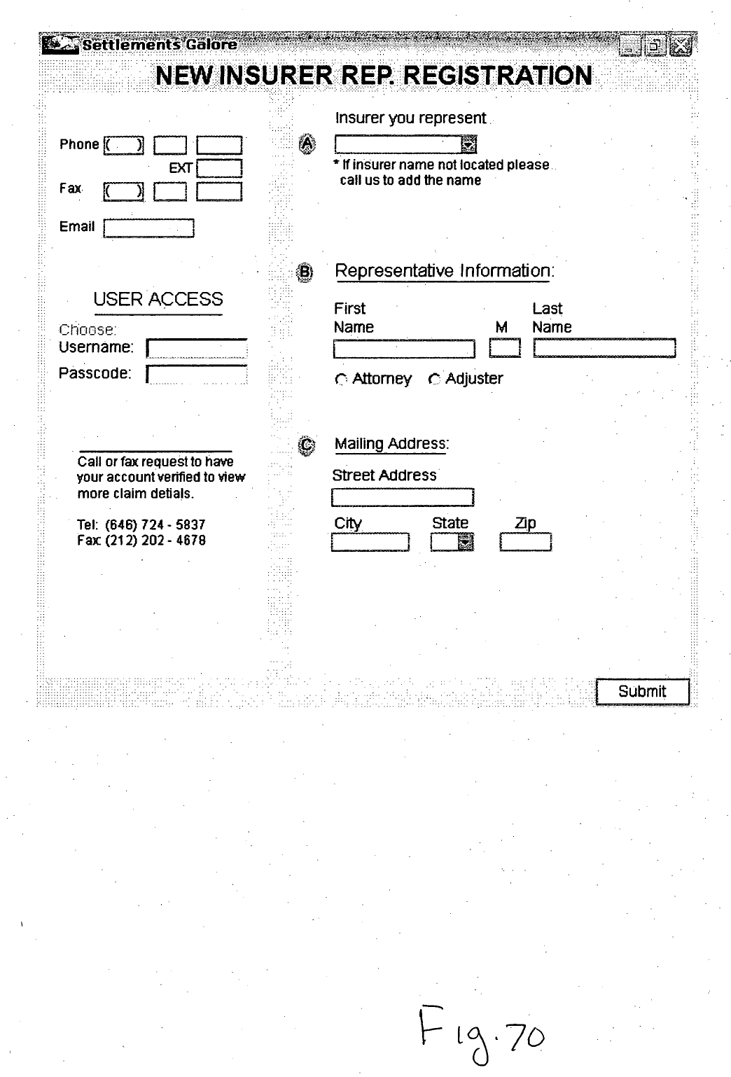

FIG. 70 (W25) illustrates an embodiment of an interface for registering insurance adjusters and assigning username and passcode over the Internet.

The present invention suggests a wide variety of modifications and applications. A further embodiment of the present invention is a landlord/tenant management system. In this embodiment, a landlord/real estate management company (clients) can enter the names and addresses of the tenants who have failed to pay rent. The clients only have to submit the tenant's name and information once.

The program sets up a file for the tenant that can be visited repeatedly whenever the tenant fails to pay rent and a “Notice” needs to be sent out. A client will never have to enter identical tenant information into the program twice. The client simply picks one or multiple tenants already listed on the program and hits “Send Notice.” The clients can utilize the program to setup new tenant accounts and bill the tenants via your program. If the payments are not entered into the program manually or by the tenant visiting the website and making payment by credit card/debit card or on-line check, the program can automatically send out Notices to the tenants. The program further does “Automated Client Invoicing”.

Each time the program creates a Notice or Petition, it will add the bill on the client's invoice, which can be printed out automatically on a designated date and be made available to the client on the website. The clients will be able to pay bills via the website as well. The program will be able to handle hourly billing also. It can calculate the hourly billing by having an internal clock, which starts running when you enter a client's file. It records the work performed on the file and calculates the correct fees. If no work is performed on the file, it can identify the billing as “Reviewed.”

The website can transmits this information to the stand alone case management program. When a client submits a non-paying tenant's information via the website to the attorney's stand alone program, it automatically sets up a file and assigns a file number and then automatically prints out a dated “Notice” on the attorney's letterhead.

The Notice will include a “username” and “passcode” for the tenant or tenant's attorney to log into the website and make the rent payment or just review the case details. All clients submit non-paying tenant information through the website. The program will send this information to the stand alone program, which will automatically printout the Notices on a “standby” printer designated for Notices.

The tenant then pays the attorney or enters the payment into the program via the website, which transmits this information to the stand alone program. This will then stop the “automated” feature of the program from automatically drafting a petition.

If the tenant fails to pay the rent on the requested date noted on the Notice, after the program automatically identifies the passing of such date, the program will automatically draft a petition. The attorney will review, sign, serve and file it in court. There will be a second standby printer designated for Petitions. The printer will automatically print out Petitions when the program identifies every file in which the Notice date has past.

At any time, the tenant or the tenant's attorney can utilize the “username” and “passcode” on the Notice to access their account on a website and make payment (this website address would be noted on Notices with the username and passcode). The system can be set up to accept payment plans, e.g. 1, 2, 3 or 6 month payment plans, etc. for past due rents. Tenants can then simply log in each month and make the minimum payments on the past due rent. Besides paying the current rent. They can even send in the payments, which have to then be manually entered either by you on your standalone program or on the website.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Other embodiments, uses and advantages of the present invention will be apparent to those skilled in the art from consideration of the specification and practice of the invention disclosed herein. The specification and examples should be considered exemplary only.

1. A multi-party interconnecting system for managing and resolving cases, comprising:
an attorney module comprising an attorney files management tool for managing client and opposing party files, a settlement tool for receiving and transmitting settlement offers and counter-offers, and a documents tool for drafting, receiving and transmitting documents and correspondence, a document submission tool for the electronic filing of drafted documents with the courts, a payment tool for the receiving of electronic payments on attorney invoices and insurance claims; and
a central module communicating with the attorney module over at least one communications network, the central module comprising (1) a client module comprising a client files management tool, managing attorney and opposing party files for, and a client payment tool for electronic payments of attorney invoices, and (2) an opposing party module comprising an opposing party files management tool for the identification and consolidation of multiple attorneys and consolidating and managing attorney and client files, and an opposing party settlement tool for receiving and transmitting settlement offers and counter-offers, and an opposing party payment tool for electronic payments of insurance claims.

2. The system of claim 1 wherein the attorney and opposing party settlement tools further comprise corresponding settlement modules for preparing and receiving settlement offers, corresponding comparison modules for comparing received settlement offers to predetermined floor settlement amounts, and corresponding counter-offer modules for proposing a counter-offer if a particular settlement offer received is less than a predetermined floor settlement amount.

3. The system of claim 1 wherein the documents tool further comprises a document drafting module for populating and drafting documents, correspondence, pleadings, summons, and other documents related to a particular case(s).

4. The system of claim 3 wherein the document drafting module populates and drafts particular documents, correspondence, pleadings, summons, complaints, and other documents related to a particular case(s) upon the occurrence of a predetermined event.

5. The system of claim 4 wherein the predetermined event comprises at least one of the filing of a complaint or answer, the acceptance of settlement, the passage of a predetermined number of days or time, and the payment of an amount.

6. The system of claim 1 wherein the client module further comprises a client records management module for uploading and transmitting documents.

7. The system of claim 1 wherein the client module further comprises a client case module for accessing pending suits or actions.

8. The system of claim 1 wherein the opposing party module further comprises a records tool for receiving and transmitting documents and correspondence.

9. The system of claim 1 wherein the opposing party module further comprises an opposing party case module for viewing pending suits or actions.

10. A system for settling at least one dispute, comprising:
receiving and viewing at least one settlement offer from at least one user over at least one communications network;
comparing the at least one settlement offer to at least one corresponding floor settlement amount;
proposing the at least one corresponding floor settlement amount as a counter offer to the at least one user over the at least one communications network if the at least one settlement offer is less than the at least one corresponding floor settlement amount; and
populating and sending acceptance correspondence over the at least one communications network to the at least one user if the at least one settlement offer is equal to or greater than the at least one corresponding floor settlement amount.

11. The system of claim 10 wherein the settlement amount comprises the product of a predetermined percentage and a disputed amount.

12. The system of claim 10 wherein the acceptance correspondence comprises a settlement agreement.

13. The system of claim 10 further comprising the step of docketing a reminder to pay notice at a later predetermined time or date upon transmission of the acceptance correspondence.

14. The system of claim 13 further comprising the step of populating and sending reminder correspondence if the predetermined time or date expires and payment has not been received.

15. The system of claim 10 further comprising informing a client of settlement.

16. The system of claim 10 further comprising the step of storing particulars of the settlement.

17. The system of claim 16 wherein the particulars of the settlement comprise at least one of an initial settlement offer, counter-offer, and final settlement amount.

18. The system of claim 10 wherein the at least one corresponding floor settlement amount is calculated prior to the receipt of the at least one settlement offer.

19. A system for settling a dispute, comprising:
a settlement reception module for receiving and viewing at least one settlement offer from at least one user over at least one communications network;
a comparison module for comparing the at least one settlement offer to at least one corresponding floor settlement amount;
a counter-offer module for proposing the at least one corresponding floor settlement amount as a counter offer to the at least one user over the at least one communications network if the at least one settlement offer is less than the at least one corresponding floor settlement amount; and
a documents module for populating and sending acceptance correspondence over the at least one communications network to the at least one user if the at least one settlement offer is equal to or greater than the at least one corresponding floor settlement amount.

20. The system of claim 19 wherein the settlement amount comprises the product of a predetermined percentage and a disputed amount.

21. The system of claim 19 wherein the acceptance correspondence comprises a settlement agreement.

22. The system of claim 19 further comprising the step up of docketing a reminder to pay notice at a later predetermined time or date.

23. The system of claim 19 further comprising the step of populating and sending reminder correspondence if the predetermined time or date expires and payment is not received.

24. The system of claim 23 wherein the reminder is sent via at least one of fax, email, or standard mail or overnight delivery.

25. A system for making bulk settlement offers, comprising:
accessing particular bill information;
determining at least one particular offeree based on the information accessed;
determining an overriding settlement percentage;
simultaneously submitting a settlement offer over a communications network to each of the at least one particular offerees, each of the settlement offers being based on the overriding settlement percentage.

26. The system of claim 25 further comprising receiving and viewing at least one of an acceptance, rejection and counter-offer from any number of the plurality of offerees.

27. The system of claim 25 wherein the plurality of settlement offerees comprises at least one of an adjuster, an attorney, a plaintiff, a defendant, or any combination thereof.

28. The system of claim 25 wherein each of the plurality of offerees can access the corresponding settlement offer prior to accepting, rejecting, or proposing a counter-offer.

29. The system of claim 25 wherein each of the plurality of offerees can initiate acceptance, rejection or presentation of a counter-offer without providing case or dispute information.

30. A system for consolidating multiple attorney names and client file data for submission to opposing parties, comprising:
a central module communicating with at least one attorney module over at least one communications network through which multiple attorneys utilizing the at least one attorney module and clients utilizing the central module may submit client file data to opposing parties utilizing the central module, and wherein such multiple attorney names and client file data are consolidated and displayed to the opposing party.

31. The system of claim 30 the attorney, client and/or opposing party accesses attorney names and client file data through the central module by the utilization of a username and passcode.

32. The system of claim 30 wherein the attorney, client and/or opposing party accesses attorney names and client file data through the central module by Insurance company or defendant name.

33. The system of claim 30 wherein the attorney, client and/or opposing party accesses attorney names and client file data through the central module by attorney or Plaintiff name.

34. The system of claim 30 wherein the attorney, client and/or opposing party accesses attorney names and client file data through the central module by client or Plaintiff name.

35. The system of claim 30 central module serves to receive and view attorney name and client file data.

36. The system of claim 30 further comprising a database for storing particulars of the attorney name and client file data.

37. The system of claim 30 further comprising a client records management module for uploading, transmitting documents and client file data.

38. The system of claim 30 further comprising a client case module for accessing pending suits or actions.

39. The system of claim 30 further comprising an attorney records management module for uploading, transmitting documents and client file data.

40. The system of claim 30 further comprising an attorney case module for accessing pending suits or actions.

41. The system of claim 30 further comprising an opposing party records management module for uploading, transmitting documents and client file data.

42. The system of claim 30 further comprising an opposing party case module for accessing pending suits and actions.

43. The system of claim 30 wherein the central module provides customizable reports on pending suits, actions and client file data.

44. The system of claim 30 further comprising a document drafting module for populating and drafting documents, correspondence, pleadings, summons, and other documents related to a particular case(s).

45. A system for electronic document filing of court records, comprising:
an attorney document submission module communicating over at least one communications network through which the attorney electronically files drafted documents with the Courts.

46. The system of claim 45 further comprising an attorney module for entering client file data.

47. The system of claim 45 further comprising an attorney module for receiving and reviewing client file data submitted through a central module communicating through the at least one communications network.

48. The system of claim 45 further comprising a database storing the particulars of client file data.

49. The system of claim 45 further comprising an attorney records management module for uploading, transmitting documents and client file data.

50. The system of claim 45 further comprising an attorney case module for accessing pending suits or actions.

51. The system of claim 45 further comprising customizable status reports on pending suits, actions and client file data.

52. The system of claim 45 further comprising a document drafting module for populating and drafting documents, correspondence, pleadings, summons, and other documents related to a particular case(s).

53. A system for multiple file consolidation in document drafting, comprising:
an attorney document-drafting module for the consolidation of particulars of multiple client files into a single drafted document, correspondence, pleading, summons, and other documents related to a particular case(s).

54. The system of claim 53 wherein the particulars of the multiple client files comprise file numbers, client and opposing parties names, details of the suit or action taken, amounts due or claimed, and attorney's name.

55. The system of claim 54 wherein the attorney document-drafting module presents at least one of a clients menu, files menu and document templates menu.

56. The system of claim 53 further comprising an attorney module for the entering of client file data.

57. The system of claim 53 further comprising an attorney module, for receiving and reviewing of client file data submitted through a central module communicating through at least one communications network.

58. The system of claim 53 further comprising a database for storing the particulars of client file data.

59. The system of claim 53 further comprising an attorney records management module for uploading, transmitting documents and client file data.

60. The system of claim 53 further comprising an attorney case module for accessing pending suits or actions.

61. The system of claim 53 further comprising customizable reports on pending suits, actions and client file data.

62. The method of claim 53 further comprising a document drafting module for populating and drafting documents, correspondence, pleadings, summons, and other documents related to a particular case(s).

63. A method of providing an attorney landlord and tenant management website, comprising the steps of:
entering the tenant's information by a client into a database connected to the Internet when the tenant has failed to pay rent:
preparing a file for the tenant that can be accessed repeatedly whenever the client fails to pay rent;
notifying the tenant by the client of the tenant's failure to pay rent;
providing the tenant with the capability to pay the tenant's rent via the website;
notifying the client of a bill from the attorney;
providing the client with the ability to pay the attorney's bill via the website; and
identifying the bill for review if no work is performed on the file for the tenant.

64. The method of claim 60, further comprising the step of transmitting the information stored in the database of the website to a standalone computer maintained by the attorney via the Internet.

65. The method of claim 60, further comprising the step of automatically selling up a file and assigning a file number when the client enters the tenant's information of the tenant who has failed to pay rent.

66. The method of claim 67, further comprising the step of generating a dated notice to the tenant for review by the attorney.

67. The method of claim 68, further comprising generating a username and password on the notice for the tenant or a tenant's attorney to review the tenant's information on the website.

68. The method of claim 68, further comprising the step of generating a petition for the attorney to review, sign, serve and file if the tenant does not pay after receiving the notice.
